(19) United States
(12) Patent Application Publication
(10) Pub. No.: US 2025/0270352 A1
(43) Pub. Date: Aug. 28, 2025

(54) METHODS OF REVERSIBLE-ADDITION FRAGMENTATION CHAIN TRANSFER STEP-GROWTH POLYMERIZATION AND POLYMERS THEREFROM

(71) Applicant: THE UNIVERSITY OF NORTH CAROLINA AT CHAPEL HILL, Chapel Hill, NC (US)

(72) Inventors: Wei YOU, Chapel Hill, NC (US); Joji TANAKA, Chapel Hill, NC (US)

(21) Appl. No.: 18/687,782

(22) PCT Filed: Aug. 30, 2022
(86) PCT No.: PCT/US2022/042087

§ 371 Date: Feb. 28, 2024

Related U.S. Application Data
(60) Provisional application No. 63/238,676, filed on Aug. 30, 2021.

(51) Int. Cl. C08F 120/38; C08F 122/40

(52) U.S. Cl. CPC C08F 120/38; C08F 122/40; C08F 2438/03

(57) ABSTRACT

The subject matter described herein is directed to methods of preparing linear and brush polymers with functional backbones and the polymers prepared therefrom. The methods are termed RAFT step-growth polymerizations and can prepare unique polymers by using a step-growth mechanism to insert multiple functionalities into the polymer backbone. The methods include facile syntheses to obtain tunable polymers, including a two-step process to obtain tunable bottlebrush polymers.

### STATEMENT OF GOVERNMENT SUPPORT

This invention was made with government support under Grant Nos. CHE-1808055 and CHE-2108670 awarded by the National Science Foundation. The government has certain rights in the invention.

### FIELD

The subject matter described herein is directed to methods of preparing linear and brush polymers with functional backbones and the polymers prepared therefrom.

### BACKGROUND

Reversible-Addition Fragmentation chain Transfer (RAFT) polymerization, is a polymerization technique that exhibits characteristics associated with living polymerization. Living polymerization is generally considered in the art to be a form of chain polymerization in which irreversible chain termination is substantially absent. An important feature of living polymerization is that polymer chains will continue to grow while monomer is provided and the reaction conditions to support polymerization are favorable. Polymers prepared by RAFT polymerisation can advantageously exhibit a well defined molecular architecture, a predetermined molecular weight and a narrow molecular weight distribution or low polydispersity.

RAFT controlled radical polymerization is one of the most widely exploited platforms for controlled chain-growth polymerization of various free radical monomers, featured by its versatility and practical ease in implementation (J. Chiefari et al., Living Free-Radical Polymerization by Reversible Addition-Fragmentation Chain Transfer: The RAFT Process. Macromolecules 31, 5559-5562 (1998); S. Perrier, 50th Anniversary Perspective: RAFT Polymerization—A User Guide. Macromolecules 50, 7433-7447 (2017). The RAFT process is mediated by Chain Transfer Agents (CTA, or RAFT agents) which seed the polymerization and govern the chain transfer exchange via an intermediate (J. Chiefari et al., Thiocarbonylthio Compounds (SC(Z)S-R) in Free Radical Polymerization with Reversible Addition-Fragmentation Chain Transfer (RAFT Polymerization). Effect of the Activating Group Z. Macromolecules 36, 2273-2283 (2003); Y. K. Chong et al., Thiocarbonylthio Compounds [SC(Ph)S—R] in Free Radical Polymerization with Reversible Addition-Fragmentation Chain Transfer (RAFT Polymerization). Role of the Free-Radical Leaving Group (R). Macromolecules 36, 2256-2272 (2003)). Traditionally, this method allows users to prepare well-defined structures with a wide scope of functionalities appended on the side chain (G. Moad, RAFT polymerization to form stimuli-responsive polymers. Polym. Chem, 8, 177-219 (2017)), yet typically the backbone is limited to inert carbon-carbon bonds, which is inherent to the chain growth nature of free radical monomers. However, while RAFT controlled radical polymerization has been widely explored since its discovery, applications are generally limited by the lack of tunability of the polymer backbone, which is inherent to its chain-growth mechanism.

To date, numerous synthetic strategies of designing polymer brush architectures have emerged, due to their often superior properties over linear polymer structures (G. Xie, M. R. Martinez, M. Olszewski, S. S. Sheiko, K. Matyjaszewski, Molecular Bottlebrushes as Novel Materials. Biomacromolecules 20, 27-54 (2019)); however, there are limited methods for introducing specific functionality along the main chain backbone, which is a highly desirable feature particularly for biomedical applications (P. Shieh, H. V. T. Nguyen, J. A. Johnson, Tailored silyl ether monomers enable backbone-degradable polynorbornene-based linear, bottlebrush and star copolymers through ROMP. Nature Chemistry 11, 1124-1132 (2019); V. Delplace, J. Nicolas, Degradable vinyl polymers for biomedical applications. Nature Chemistry 7, 771-784 (2015)). What is therefore needed and not addressed in the art are methodologies that can be widely exploited to address these challenges, and usher in a new generation of materials that were previously unattainable. The present disclosure addresses these shortcomings in the art.

### BRIEF SUMMARY

In certain embodiments, the subject matter described herein is directed to a synergistic RAFT step-growth polymerization process, comprising allowing a RAFT step-growth adduct to polymerize in a step-growth process in the presence of a solvent, and one of the following: an initiator, visible light or a photocatalyst; wherein a RAFT step-growth polymer comprising one or more inserted backbone functional units and a RAFT residue in each repeat unit is prepared.

In certain embodiments, the RAFT step-growth adduct is a Monomer-Chain Transfer Agent (M_{A}-CTA).

In certain embodiments, the RAFT step-growth adduct is a Bifunctional-Chain Transfer Agent (CTA1-G-CTA2), and the process further comprises contacting the CTA1-G-CTA2 with a bifunctional monomer pair M₁-L_{Y}-M₂, wherein L_{Y} is a linker covalently bound to M₁ and to M₂, and each of M₁ and M₂ is a monomer.

In certain embodiments, the RAFT step-growth polymerization process further comprises functionalizing a group on the backbone to prepare a brush polymer.

In certain embodiments, the subject matter described herein is directed to a polymer comprising a functional backbone, wherein the backbone comprises the structure:
wherein,
   M, in each instance, is independently a residue of a monomer;
   R, in each instance, is independently a residue of a first backbone unit;
   [symbol] , in each instance, is independently a residue of a second backbone unit;
   Z, in each instance, is independently selected from the group consisting of —S—C₁₋₂₀ alkyl, —O—C₁₋₂₀ alkyl, phenyl, —O-phenyl, pyrrolyl and NR^{x}R^{y};
   wherein, R^{x} and R^{y} are each independently selected from the group consisting of C₁₋₂₀ alkyl and pyridinyl.

In certain embodiments, the subject matter described herein is directed to a polymer comprising a functional backbone, wherein the backbone comprises the structure:
wherein,
   M, in each instance, is independently a residue of a monomer;
   R, in each instance, is independently a residue of a first backbone unit;
   [symbol] , in each instance, is independently L;
   [symbol] , in each instance, is independently a residue of a second backbone unit;
   Z, in each instance, is independently selected from the group consisting of —S—C₁₋₂₀ alkyl, —O—C₁₋₂₀ alkyl, phenyl, —O-phenyl, pyrrolyl and NR^{x}R^{y};
   wherein, R^{x} and R^{y} are each independently selected from the group consisting of C₁₋₂₀ alkyl and pyridinyl.

Other embodiments are also described.

### BRIEF DESCRIPTION OF THE FIGURES

FIGS. 1A-B depict a comparison of traditional RAFT polymerization process and products that can be obtained therefrom versus the RAFT step-growth polymerizations described herein and new types of polymers obtained therefrom and described herein.

FIGS. 2A-D depict: A-C) Illustration of AB and A₂+B₂ RAFT step-growth polymerization and reaction mechanism of the RAFT-step growth cycle: The polymerization proceeds through the addition (kᵢ) of the monomer (i-a) and R• (ii-b) end group species, forming the polymer backbone as an intermediate mid-chain radical (iii), followed by chain transfer with chain-end CTA (i-b) via an intermediate (iv) to reform R• (ii-b) and yield polymer backbone (v). The forward direction of the equilibrium to and from the chain transfer intermediate (k_{add}, k_{frag}) is color coded; D) Various CTA's (CTA_{1A-E}) were screened using N-ethyl maleimide (M₁) under the same reaction conditions: [M]₀=1 M, [CTA]₀=1 M, [AIBN]₀=50 mM in dioxane at 70° C. for 4 hours (See, FIG. 2D).

FIGS. 3A-D depict: AB RAFT step-growth polymerization of MCTA ([MCTA]₀=1 M, [AIBN]₀=50 mM in dioxane at 70° C. for 4 hours). A) ¹H-NMR of initial monomer species and the polymer backbone at t=0, 4 h, after precipitation and filtrate. B) Experimental Mₙ, Mw and M (from conventional SEC analysis, relative to polystyrene calibration in THF) versus monomer conversion, plotted together with expected values without considering imbalanced stoichiometry from initiation. SEC-dRI chromatograms of: C) Polymerization carried out with different initial concentrations ([MCTA]₀=2 to 0.25 M) with the same initiator concentration ([AIBN]₀=50 mM); D) Polymerization carried out in toluene, DMF and DMSO.

FIGS. 4A-C depict: A₂+B₂ RAFT-step growth of M₂ and CTA2 ([M₂]₀+[CTA2]₀=1.0 M, [AIBN]₀=50 mM) in dioxane at 70° C. for 4 hours (r=[M₂]₀/[CTA2]₀). Experimental Mₙ, M_{w} and M_{z} versus monomer conversion plotted together with expected values using; A) equivalent (r=1) and B) non-equivalent stoichiometry (r=0.98) of the two bifunctional reagents. C) Comparison of SEC-dRI chromatograms of the polymerizations (r=1, 0.98, 0.94, 0.81) with approximately equal monomer conversion (p≈0.98).

FIGS. 5A-D depict: A) Mark-Houwink plot of poly(M₂-alt-CTA₂) and poly(MCTA). B) The degradation of isolated poly(M₂-alt-CTA₂) after 2 weeks under open atmospheric conditions. C) SEC-dRI chromatograms of poly(MCTA-g-PBA₁₅) and its precursor backbone with molecular weight determined by light scattering (LS). D) SEC-dRI chromatograms of poly(M₂-alt-CTA₂-g-PBA₃₅) (red trace) and its precursor backbone (blue trace). Black trace shows SEC analysis measured within 40 minutes after introducing 1:1 TBAF/AcOH (4 mM, 5 eq w.r.t to Si-O bonds).

FIGS. 6A-C depict AB RAFT step-growth polymerization with acrylic monomer. A) SEC (dRI, THF) chromatogram of the new AB RAFT step growth polymerization B) Mw,SEC versus monomer conversion. C) ¹H-NMR evolution of polymerization highlighting the disappearance of vinyl protons and emergence of new peaks corresponding with backbone RAFT agents formed along the step growth backbone.

FIG. 7 depicts kinetics analysis of AB RAFT step growth polymerization and molecular weight evolution for MCTA using general procedure 1 ([MCTA]₀=1 M, [AIBN]₀=50 mM in dioxane at 70° C. for 4 hours). The top row reveals evolution of weight-averages: M_{z}, M_{w}, Mₙ (from left to right) obtained from conventional SEC analysis (FIG. 8) plotted together with theoretical line without taking imbalanced stoichiometry from initiation into account. The bottom row on the left and in the middle reveals M_{z}/M_{w} and M_{w}/Mₙ. Significant deviation in Mₙ and M_{w}/Mₙ from theoretical values are caused by non-growing irreversible formation of cyclic species that accounts towards more by number than by weight. Bottom right panel shows kinetic analysis revealing better agreement of linear fit with first-order kinetics (filled squares) than second order kinetics (empty squares) during the initial stages of the reaction. It's noteworthy, regular step growth polymerization proceeds through second order kinetics as the concentration of both reactive end groups are simultaneously depleted. However, linear pseudo-first order kinetics observed, which is consistent with our proposed mechanism, assuming 1) the chain-transfer step is not rate limiting; 2) presence of relatively low concentration of radical species that remains approximately constant. In our proposed mechanism, the rate of polymerization follows bimolecular reaction between the monomer and the R• species (kᵢ, Scheme 2). The R• species are regenerated upon chain transfer in the main RAFT step-growth cycle (Scheme 2). Here R• species introduced into the cycle through chain transfer step with initiator-monomer radical adduct formed from the initiation. Due to termination events radical species lost in the cycle and can be approximated to occur at steady state with generation of radicals from initiator. Assuming initiator radical addition to the monomer is not rate limiting at high monomer concentration, the formation of the initiator-monomer radical adduct is dependent on the initiator concentration, the decomposition rate of initiator (k_{d}) and initiation efficiency (f). As the monomer conversion occurs much faster than the initiator decomposition, the concentration of initiator remains relatively constant where linear trend is observed. Deviation from linear trend is observed at high monomer conversion, which is also typically observed using free radical initiators when the initiation step becomes rate limiting.

FIG. 8 depicts THF-SEC (normalized dRI) chromatograms of MCTA polymerization in dioxane using general procedure 1 ([MCTA]₀=1M, [AIBN]₀=50 mM), shown as a stack plot on the left and same chromatograms superimposed on the right.

FIG. 9 depicts ¹H-NMR (CDCl₃, 400 MHz) of MCTA polymerization in dioxane using general procedure 1 ([MCTA]₀=1 M, [AIBN]₀=50 mM). The numbers correspond to relative integral value of the two monomer peaks (green, left), polymer backbone forming (purple, middle) with respect to Z-group CH₃ as 3 (grey, right).

FIG. 10 depicts ¹H-NMR (CDCl₃, 400 MHz) of precipitated PolyMCTA.

FIG. 11 depicts ¹³C-NMR (CDCl₃, 400 MHz) of precipitated PolyMCTA,

FIG. 12 depicts typical ¹H-NMR (CDCl₃, 400 MHz) analysis of M₂+CTA₂ copolymerization ([M₂]₀/[CTA₂]₀=1), to determine monomer conversion. The numbers correspond to relative integral value of monomer peak (green, left) with respect to Z-group CH₃ as 3 (grey, right).

FIG. 13 depicts THF-SEC (normalized dRI) chromatograms of M₂ and CTA₂ polymerization with balanced stoichiometric ratio, r=[M₂]₀/[CTA₂]₀=1.

FIG. 14 depicts THF-SEC (normalized dRI) chromatograms of M₂ and CTA₂ polymerization with imbalanced stoichiometric ratio, r=[M₂]₀/[CTA₂]₀=0.98

FIG. 15 depicts THF-SEC (normalized dRI) chromatograms of M₂ and CTA₂ polymerization with imbalanced stoichiometric ratio, r=[M₂]₀/[CTA₂]₀=0.96.

FIG. 16 depicts kinetics analysis of AB RAFT step growth polymerization and molecular weight evolution for MCTA varying the reaction conditions: polymerizing in dioxane with [MCTA]₀=2 M, 0.5 M, and 0.25 M, using the same initiator equivalence ([MCTA]₀/[AIBN]₀=20, top row) or the same initiator concentration ([AIBN]₀=50 mM, bottom row). Evolution of M_{w} and M_{z} with monomer conversion is plotted together with theoretical line expected for step-growth polymerization of linear polymers without considering imbalance in stoichiometry from initiation.

FIG. 17 depicts THF-SEC (normalized dRI) chromatograms of MCTA polymerization varying the concentration in dioxane: Columns left to right: [MCTA]₀=2 M, 0.5 M, 0.25 M with the same initiator equivalence (top row, [MCTA]₀/[AIBN]₀=0.05) or concentration (bottom row, [AIBN]₀=50 mM).

FIG. 18 depicts polymerizing in DMSO, DMF and Toluene. Evolution of M_{w} and M_{z} with monomer conversion is plotted together with theoretical line expected for step-growth polymerization of linear polymers without considering imbalance in stoichiometry from initiation.

FIG. 19 depicts THF-SEC (normalized dRI) chromatograms of MCTA polymerization in DMSO, DMF, Toluene with ([MCTA]₀=1M, [AIBN]₀=50 mM).

FIG. 20 depicts a general scheme for A₂-B₂ RAFT step-growth polymerization.

FIG. 21A-C depicts: A) conventional THF-SEC analysis using polystyrene calibration of RAFT step-growth polymerization of M_{2A} and CTA₂; B) evolution of the molecular weight averages (Mₙ, M_{w} and M_{z}) determined by SEC analysis and conversion from ¹H-NMR, plotted together with theoretical molecular weight averages predicted for step-growth polymerization, which does not consider cyclization; C) conventional THF-SEC analysis of poly(M_{2A}-alt-CTA₂) made in toluene, DMF or DMSO.

FIG. 22A-D depicts: A) RAFT step-growth polymerization of various diacrylate monomers. The graphs showing evolution of molecular weight averages with conversion of A) tripropylene glycol diacrylate (M_{2B}); B) neopentyl glycol diacrylate (M_{2C}); C) tricyclo[5.2.1.02,6]decanedimethanol diacrylate (M_{2D}), all of which polymerized with CTA₂; and D) 1,6-hexanediol diacrylate (M_{2A}) polymerized with disulfide tethered CTA (CTA_{2SS}).

FIG. 23A-C depicts: A) Mark-Houwink plot of all linear polymers; B) LS-SEC analysis of p(M_{2A}-alt-CTA_{2SS}) and p(M_{2A}-alt-CTA_{2SS})-g-PBA. The M_{n,LS} of the linear backbone is used to calculate the expected M_{n,th} of the graft copolymer; C) conventional SEC analysis of p(M_{2A}-alt-CTA_{2SS})-g-PBA before and after degradation with PBu₃.

FIG. 24 depicts molecular weight distribution of A₂+B₂ RAFT Step-growth polymerization M_{A-D} and CTA₂ as followed by THF-SEC.

FIG. 25 depicts Molecular weight distribution of A₂+B₂ RAFT Step-growth polymerization M_{A-D} and CTA_{2A}, shown with the theoretical lines predicted by Flory for step-growth polymerization.

### DETAILED DESCRIPTION

The synergy of RAFT mechanism and step-growth polymerization offers unprecedented opportunities to create a wide range of new materials and structures. By way of example, in certain embodiments, the methods described herein can prepare backbone functional molecular brush polymers, in two non-demanding facile polymerization steps with readily accessible building blocks. These features allow preparation of brush polymers with highly tunable backbone from readily accessible starting materials, such as the periodic incorporation of silyl ether and/or disulfide for stimuli triggered degradation of brush polymer backbone. The results disclosed herein show the ability of the processes described herein to design polymer brush architectures with unique backbone properties that were previously synthetically challenging.

While Reversible-Addition Fragmentation chain Transfer (RAFT) controlled radical polymerization has been widely explored since its discovery, its robustness and versatility are generally limited by the lack of tunability of the polymer backbone, which is inherent to its chain-growth mechanism. Described herein is a highly selective insertion process of functional unit(s) with a RAFT agent to allow step-growth polymerization of AB and A₂+B₂ type comonomers. This RAFT step-growth mechanism whereby each repeat unit of the polymer backbone bears RAFT agents that can graft polymeric side chains in a second polymerization step. The synergy of RAFT and step-growth mechanisms offers a general strategy to synthesize molecular brush polymer architectures with unique main chain backbone properties from readily accessible building blocks. This polymerization approach allows facile synthesis of molecular brush polymers with design flexibility of the backbone owing to the robust synergy of RAFT polymerization and step-growth mechanism.

Disclosed herein are unique approaches to achieve RAFT step-growth polymerization. Our results have shown several unique features to this unprecedented polymerization strategy, including: High functional group tolerance of RAFT allows functionalities to be introduced along the polymer backbone, thus allowing facile synthesis of degradable polymer backbone; New RAFT agents are formed along the backbone during the RAFT step-growth polymerization, offering a means to readily synthesize molecular brush polymers with full grafting density via second polymerization step by traditional chain growth RAFT polymerization. The RAFT step-growth polymerization described herein represents a significant breakthrough in polymer chemistry by synergistically combining RAFT mechanism with step-growth polymerization, offering unprecedented opportunities to a wide range of materials and structures, for example, degradable molecular polymer brushes, in just two non-demanding facile polymerization steps with readily accessible building blocks.

In polymer chemistry, ‘free radical’ centered polymerizations are almost synonymous to the chain-growth mechanism. As one of the most important controlled free-radical polymerizations, Reversible-Addition Fragmentation chain Transfer (RAFT) polymerization has been widely adopted due to its simplicity and versatility of controlling the degree of polymerization (DP) of free radical polymers, enabled by the addition of chain transfer agents (CTAs) known as the RAFT agents. However, like with all controlled radical polymerization strategies, the backbone of polymers prepared via RAFT has been essentially limited to the ‘ethylene’ backbone. The lack of tunability of polymer backbones via RAFT chain-growth polymerizations limits their applications where specific backbone functionality is desired, such as degradability for biomedical applications.

On the other hand, step-growth polymerization, where the reaction proceeds by joining two functional chain ends, allows greater freedom in the backbone designs. In the literature, Single Unit Monomer Inserted (SUMI) CTA adducts are known to selectively form when kinetically promoted and driven by the chain transfer exchange (J. B. McLeary et al., Beyond Inhibition: A ¹H-NMR Investigation of the Early Kinetics of RAFT-Mediated Polymerization with the Same Initiating and Leaving Groups. Macromolecules 37, 2383-2394 (2004); S. Houshyar et al., The scope for synthesis of macro-RAFT agents by sequential insertion of single monomer units. Polym. Chem, 3, 1879-1889 (2012); J. J. Haven et al., in Reversible Deactivation Radical Polymerization: Mechanisms and Synthetic Methodologies. (American Chemical Society, 2018), vol. 1284, chap. 4, pp. 77-103).

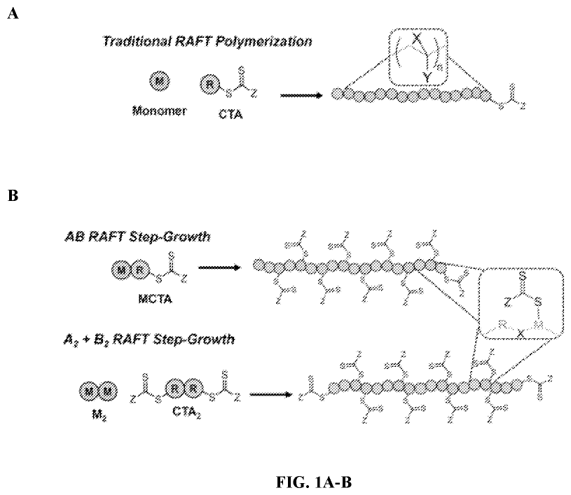

However, until now, it was not possible to allow step-growth polymerization using bifunctional reagents (FIG. 1A, 1B). As described herein, such general expansion of RAFT process to mediate step-growth polymerization could significantly increase the scope of accessible polymer backbones (FIG. 1C). Furthermore, retaining the functionality of the CTA to graft a second polymerization from each backbone repeat unit (S. Shanmugam, J. Cuthbert, T. Kowalewski, C. Boyer, K. Matyjaszewski, Catalyst-Free Selective Photoactivation of RAFT Polymerization: A Facile Route for Preparation of Comblike and Bottlebrush Polymers. Macromolecules 51, 7776-7784 (2018); J. Tanaka et al., Orthogonal Cationic and Radical RAFT Polymerizations to Prepare Bottlebrush Polymers. Angew. Chem. Int. Ed. 59, 7203-7208 (2020)), allows a highly divergent and efficient synthesis of molecular brush polymers (K. L. Beers, S. G. Gaynor, K. Matyjaszewski, S. S. Sheiko, M. Moller, The Synthesis of Densely Grafted Copolymers by Atom Transfer Radical Polymerization. Macromolecules 31, 9413-9415 (1998); G. Xie, et al. (2019)). As described herein, step-growth polymerization allows the design of tailored polymer backbone, as the reactive end groups joins in a way such that functionality can be introduced in between the active chain ends. Such that one can enjoy the unique benefits associated with the RAFT polymerization while gaining the design flexibility on the backbone within step-growth polymerization.

RAFT step growth polymerization as described herein can provide polymers that up to now were not obtainable, such as types of functional polymeric side chains and functional brush backbones. RAFT step growth polymerization chain growth is depicted in Schemes 1 and 2.

In contrast, traditional RAFT polymerization can only provide functional side chains but has limited capability for functionalizing the backbone. Traditional RAFT polymerization chain growth is depicted in Scheme 3.

FIG. 1A-B also shows some of the distinctions between the processes described herein and the polymers now obtainable versus traditional RAFT polymerization.

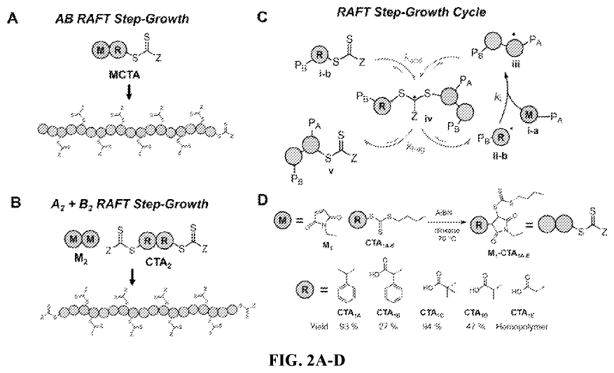

Suitable stoichiometric pairing was achieved for a monomer and a CTA functional group that selectively form a SUMI-CTA adduct at quantitative yields (FIG. 2D). In an embodiment, N-substituted maleimides act as a slow homopropagating monomer to favor the chain transfer cycle (N. B. Cramer, S. K. Reddy, A. K. O'Brien, C. N. Bowman, Thiol-Ene Photopolymerization Mechanism and Rate Limiting Step Changes for Various Vinyl Functional Group Chemistries. Macromolecules 36, 7964-7969 (2003)). Quantitative SUMI-CTA adduct yields of this monomer family are known with CTA_{1A} (Z. Huang, N. Corrigan, S. Lin, C. Boyer, J. Xu, Upscaling single unit monomer insertion to synthesize discrete oligomers. J. Polym. Sci., Part A: Polym. Chem. 57, 1947-1955 (2019)). However, described herein is the same Z-group to screen various R-groups that can be directly functionalized for tethering. Using N-ethyl maleimide as a model monomer (M₁), under the reaction conditions described herein (for example, [CTA₁]₀=[M₁]₀=1M, [AIBN]₀=0.05 M in dioxane at 70° C. for 4 h), CTA_{1A} gave quantitative SUMI-CTA adduct yield. CTA_{1B}, which only structurally differs from CTA_{1A} by an additional carboxylic acid, resulted in significantly slower kinetics. This was attributed to slower monomer addition (kᵢ) from increased radical stability of the R• species contributed by the additional neighboring conjugation.

As described herein, CTA_{1C}, whose reactivity lies between the former two CTA's (D. J. Keddie, A guide to the synthesis of block copolymers using reversible-addition fragmentation chain transfer (RAFT) polymerization. Chem. Soc. Rev. 43, 496-505 (2014)) gave quantitative SUMI-CTA adduct yield (FIG. 2D). In contrast, CTA_{1D} with one less methyl substituent, resulted in significantly lower yield with unequal consumption of monomer and CTA. Furthermore, CTA_{1E}, which does not favor chain transfer exchange with the monomer, resulted in retarded homopolymerization (Y. Kwak et al., A Kinetic Study on the Rate Retardation in Radical Polymerization of Styrene with Addition-Fragmentation Chain Transfer. Macromolecules 35, 3026-3029 (2002)).

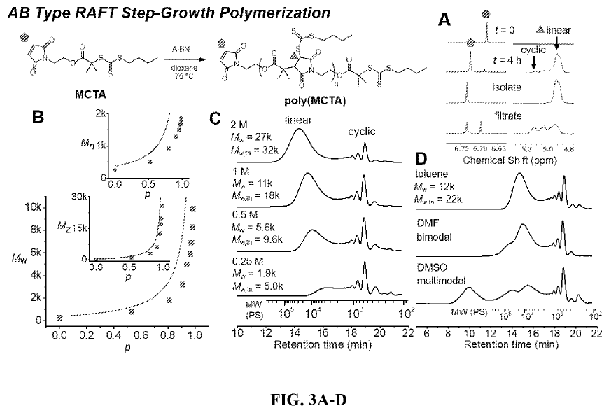

M₁ and CTA_{1C} pairing demonstrated quantitative insertion yield. MCTA, where the two functionalities are tethered together as the first AB type RAFT step-growth monomer was prepared. Herein, identical reaction conditions from the preliminary screening were used as the general procedure for RAFT step-growth polymerization. In all cases discussed, the molecular weight evolution by convention SEC analysis and ¹H-NMR was used to determine the extent of the reaction (p). In an embodiment that may be unique to the polymerization of MCTA, a downfield shift of monomer end group from the initial monomer species (FIG. 3A) was found. Nonetheless, experimental weight-average (M_{w}) and Z-average (M_{z}) molecular weight trended with values for molecular weight distribution of linear step-growth polymers that assumes equal monomer reactivity (P. J. Flory, Molecular Size Distribution in Linear Condensation Polymers. J. Am. Chem. Soc. 58, 1877-1885 (1936))(FIG. 3B). The low molecular weight cyclic species that are formed results in lack of correlation by number-average molecular weight (Mₙ). Typically, oligomeric cyclic species can be observed from ¹H-NMR with a downfield shift relative to the polymer backbone (J. Rosselgong, S. P. Armes, Quantification of Intramolecular Cyclization in Branched Copolymers by ¹H-NMR Spectroscopy. Macromolecules 45, 2731-2737 (2012))(FIG. 3A). Furthermore, data supports a better agreement of M_{w} by approximating imbalanced stoichiometry (rₜₕ) from initiation.

Briefly examining reaction conditions with this AB monomer, we found the polymerization conducted at higher concentration is optimal for yielding higher molecular weight polymers with lower initiator equivalence. Interestingly, lowering the initial concentration of the polymerization resulted in more noticeable presence of the cyclic species (FIG. 3C), which is a classical step-growth feature (H. R. Kricheldorf, The Role of Self-Dilution in Step-Growth Polymerizations. Macromol. Rapid Commun. 29, 1695-1704 (2008)), whilst the rate followed pseudo-first order kinetics that was dependent on initiator concentration. Surprisingly, changing the solvent to DMSO or DMF had undesirable loss of control, which was not observed using toluene or dioxane as the solvent (FIG. 3D).

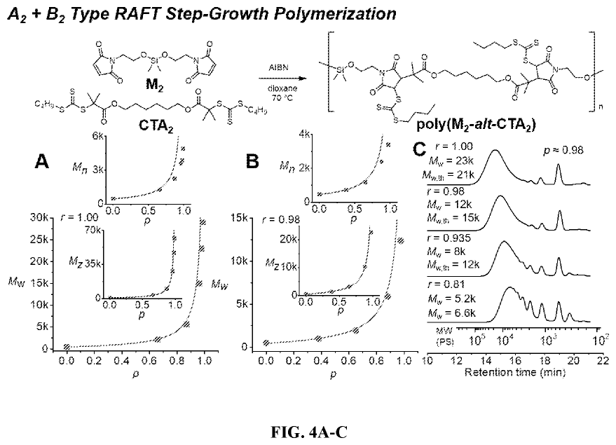

RAFT step-growth polymerization with A₂+B₂ type comonomers using bifunctional pairs of monomers (M₂) and CTA (CTA₂) (FIG. 4), was successfully achieved using the same general reaction conditions (FIG. 4A). Remarkably, the effect of using excess CTA₂to imbalance the stoichiometry proceeded with expected reduction in molecular weight averages (FIG. 4B, 4C). In addition, compared to the AB type step-growth, lower fraction of cyclic species are expected as the probability of the chain ends to cyclize is reduced by a factor of two (H. R. Kricheldorf, Polycondensation of ‘a−bₙ’ or ‘a₂++bₙ’ Monomers—A Comparison. Macromol. Rapid Commun. 28, 1839-1870 (2007)).

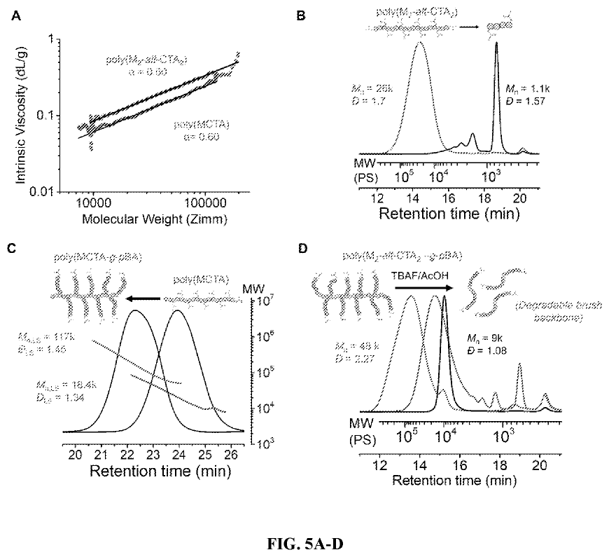

RAFT step-growth polymers were easily purifiable by precipitating the reaction mixture twice into diethyl ether to remove low molecular weight species. Furthermore, typical Mark-Houwink plots by triple detection SEC (dRI, LS, VS) analysis of the isolated polymers reveals an α value of 0.6, which is consistent with molecular weight distribution of linear polymers (Y. Lu, L. An, Z.-G. Wang, Intrinsic Viscosity of Polymers: General Theory Based on a Partially Permeable Sphere Model. Macromolecules 46, 5731-5740 (2013))(FIG. 5A).

Owing to the step-growth nature, specific functionality imbedded in the bifunctional reagents can be incorporated in the polymer backbone, such as dimethyl silyl ether in M₂. Interestingly, we found this functionality to be particularly susceptible to hydrolysis (M. C. Parrott et al., Tunable Bifunctional Silyl Ether Cross-Linkers for the Design of Acid-Sensitive Biomaterials. J. Am. Chem. Soc. 132, 17928-17932 (2010)), and the resulting polymer backbone can degrade when left under open atmospheric conditions (FIG. 5B).

Described herein is the successful syntheses of molecular brush polymers from a RAFT step-growth backbone with poly(butyl acrylate) (pBA) side chains (FIG. 5C). In addition, poly(M₂-alt-CTA₂-g-pBA₃₅) showed rapid stimuli-triggered degradation into well-defined linear polymers (Mₙ=9,000, Ð=1.08) (FIG. 5D), which was remarkably consistent with expected molecular weight for two pBA chains (M_{n,th}=4,900 per side chain) (FIG. 5B).

Over the years, numerous synthetic strategies of designing polymer brush architectures have emerged, due to their often superior properties over linear polymer structures (G. Xie, et al., (2019)), however, there are limited methods for introducing specific functionality along the main chain backbone, which is a highly desirable feature particularly for biomedical applications (P. Shieh, H. V. T. Nguyen, J. A. Johnson, Nature Chemistry 11, 1124-1132 (2019); Delplace (2015). RAFT step-growth as described herein can be widely exploited by the research community to address these challenges and allow new generation of materials that were previously unattainable.

Additionally, in embodiments, demonstrated herein are RAFT step-growth polymerizations with diacrylate monomers, expanding the accessibility and potential utility of this new RAFT step-growth method. Further, incorporation of functionality in the polymer backbone can now be achieved via embedding such functionality in the bifunctional CTA. These new results demonstrate that RAFT step-growth polymerization is a robust method to prepare a variety of functional linear and brush polymers.

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety. In the drawings, the relative sizes of regions or features may be exaggerated for clarity. This subject matter may, however, be embodied in many different forms and should not be construed as limited to the aspects set forth herein; rather, these aspects are provided so that this disclosure will be thorough and complete, and will fully convey the scope of the subject matter to those skilled in the art.

### I. Definitions

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the subject matter herein is for the purpose of describing particular aspects only and is not intended to be limiting of the subject matter. In case of a conflict in terminology, the present specification is controlling.

As used herein, “and/or” refers to and encompasses any and all possible combinations of one or more of the associated listed items, as well as the lack of combinations when interpreted in the alternative (“or”).

The term “about” as used herein when referring to a measurable value, such as, for example, an amount or concentration and the like, is meant to encompass variations of 20%, ±10%, ±5%, ±1%, ±0.5%, or even ±0.1% of the specified amount. A range provided herein for a measurable value may include any other range and/or individual value therein.

As used herein, a “RAFT step-growth polymerization process” refers to tunable, selective insertion processes of monomers, R groups and/or functional units with a RAFT agent to allow step-growth polymerization.

As used herein, “polymer” refers to the product of a polymerization reaction in which one or more monomers and/or repeat units are linked together. A polymer includes copolymers. Additionally, particular polymers are brush-like, comb-like, branched or hyperbranched, crosslinked, or a mixture thereof.

As used herein, a “RAFT agent residue” or “RAFT polymerization groups” include trithiocarbonate groups, dithiocarbonate groups (including O-esters of dithiocarbonate (xanthates). In certain embodiments, a “RAFT agent residue” means the residue of a group containing a thiocarbonylthio group may refer to the xanthate group —OC(S)S—, and a trithiocarbonate group refers to the group —SC(S)S—, and a dithiocarbamate group refers to the group —NC(S)S—, and a dithioester group refers to the group —CC(S)S—. After polymerization, in various embodiments, the RAFT polymerization groups may be removed to form, for example, a hydroxy-terminated multi-armed polymer. In various embodiments, the RAFT polymerization groups may be removed, for example, through nucleophilic substitution.

As used herein, a “RAFT step-growth adduct” refers to a single compound comprising a RAFT residue and a monomer. The RAFT step-growth adduct may further comprise R groups, functional groups, other monomers, backbone units and the like for incorporation into the polymer as defined elsewhere. The term “repeat unit” refers to a unit that is polymerizable or copolymerizable via a radical route, and can include a RAFT step-growth adduct, containing a monomer that is covalently attached to a RAFT group.

The term “step-growth molecular weight evolution” refers to the expected molecular weight averages with conversion as described by Flory (P. J. Flory, JACS, 58, 1877-1885 (1936)).

As used herein, “copolymer” refers to a polymer resulting from the polymerization of two or more chemically distinct monomers.

As used herein, the term “monomer” means any monomer that is polymerizable or copolymerizable via a radical route. Generally, RAFT monomers can be classified as more-activated monomers (MAMs) and less activated monomers (LAMs). MAMs have a vinyl bond conjugated to another double bond, including those of aromatic rings, as well as carbonyl and nitrile groups. Representative monomers of this class include butadiene, isoprene, styrene, vinyl pyridine, (meth)acrylates, (meth)acrylamides, maleic anhydride, maleimide, and acrylonitrile. LAMs have a double bond adjacent to an electron-withdrawing group such as a nitrogen, oxygen, halogen, or sulfur atom with a lone electron pair, or they have saturated carbons attached to the vinyl carbon atoms. Representative monomers of this class include vinyl acetate, N-vinylpyrrolidone (NVP), vinyl chloride, and alkenes are LAMs. Unsaturated free-radical-polymerizable monomers for use in the present disclosure may be selected from the following unsaturated monomers, among others: (a) vinyl monomers, including vinyl pyrrolidone, vinyl alcohol, halogenated vinyl compounds such as vinyl chloride and vinyl fluoride, vinyl imidazole, vinyl ethers, vinyl esters such as vinyl acetate, acrylonitrile, and vinyl aromatic monomers such as substituted and unsubstituted styrene, (b) alkylene monomers and derivatives, such as ethylene, propylenes (e.g., a-propylene, isopropylene), butylenes (e.g., a-butylene, P-butylene, isobutylene), pentenes, etc., (c) fluorinated unsaturated monomers including fluorinated alkylene monomers (e.g., tetrafluoroethylene, trifluorochloroethylene, vinylidene fluoride, etc.), (d) (meth)acrylic monomers and derivatives, such as acrylic acid, methacrylic acid, methyl acrylate, methyl methacrylate, ethyl acrylate, ethyl methacrylate, butyl acrylate, butyl methacrylate, hydroxyethyl acrylate, hydroxyethyl methacrylate, glyceryl acrylate, glyceryl methacrylate, dimethylaminoethyl acrylate, dimethylaminoethyl methacrylate, PEG acrylates and PEG methacrylates, for example, PEG methyl ether acrylate and PEG methyl ether methacrylate, acrylamide, methacrylamide, ethacrylamide, and so forth, (e) nitriles including acrylonitrile, and methacrylonitrile, and (f) diene monomers such as 1,3-butadiene, chloroprene, and isoprene, as well as combinations of the foregoing monomers.

The use of “M1/M2,” “M_{1/2}” and the like refers to the presence of a M1 or a M2 monomer. The use of “Y1/Y2” and the like refers to the presence of a R^{Y1} or R^{Y2}.

The term “alkyl” refers to a straight chain or branched chain saturated hydrocarbyl group. The term “C₁₋₂₀ alkyl” refers to an alkyl group having 1 to 20 carbon atoms. examples include C₁₋₁₂ alkyl, C₁₋₁₀ alkyl, C₁₋₆ alkyl, C₁₋₄alkyl and C₁₋₃ alkyl groups. Examples of C₁₋₆ alkyl include methyl (Me), ethyl (Et), propyl (Pr), isopropyl (i-Pr), butyl (Bu), isobutyl (i-Bu), sec-butyl (s-Bu), tert-butyl (t-Bu), pentyl, neopentyl, hexyl and the like. Unless the context requires otherwise, the term “alkyl” also encompasses alkyl groups containing one less hydrogen atom such that the group is attached via two positions, i.e. divalent.

The term “cycloalkyl” refers to a non-aromatic, saturated or partially unsaturated hydrocarbon ring group wherein the cycloalkyl group may be optionally substituted with one or more substituents described herein. In one example, the cycloalkyl group is 3 to 12 carbon atoms (C₃-C₁₂). In other examples, cycloalkyl is C₃-C₆, C₃-C₈, C₃-C₁₀ or C₅C₁₀. In other examples, the cycloalkyl group, as a mnonocycle, is C₃-C₈, C₃-C₆ or C₅-C₆. In another example, the cycloalkyl group, as a bicycle, is C₇-C₁₂. In another example, the cycloalkyl group, as a spiro system, is C₅-C₁₂. Examples of monocyclic cycloalkyl include cyclopropyl, cyclobutyl, cyclopentyl, 1-cyclopent-1-enyl, 1-cyclopent-2-enyl 1-cyclopent-3-enyl, cyclohexyl, perdeuteriocyclohexyl, 1-cyclohex-1-enyl, 1-cyclohex-2-enyl, 1-cylohex-3-enyl, cyclohexadienyl, cycloheptyl, cyclooctyl, cyclononyl, cyclodecyl, cycloundecyl and cyclododecyl. Exemplary arrangements of bicyclic cycloalkyls having 7 to 12 ring atoms include, but are not limited to, [4,4], [4,5], [5,5], [5,6] or [6,6]ring systems. Exemplary bridged bicyclic cycloalkyls include, but are not limited to, bicyclo[4.1.0]heptane, bicycle[3.1.1]heptane, bicyclo[2.2 1]heptane, bicyclo[2.2.2]octane, bicyclo[4.1.0]heptane and bicyclo[3.2.2]nonane. Examples of spiro cycloalkyl include, spiro[2.2]pentane, spiro[2.3]hexane, spiro[2.4]heptane, spiro[2.5]octane and spiro[4.5]decane. In some embodiments, substituents for “optionally substituted cycloalkyls” include one to four instances of F, Cl, Br, I, OH, SH, CN, NH₂, NO₂, N₃, COOH, methyl, ethyl, propyl, iso-propyl, butyl, isobutyl cyclopropyl, methoxy, ethoxy, propoxy, oxo, trifluoromethyl, difluoromethyl, sulfonylamino, methanesulfonylamino, SO, SO₂, phenyl, piperidinyl, piperazinyl, and pyrimidinyl, wherein the alkyl, aryl and heterocyclic portions thereof may be optionally substituted.

The terms “halo” or “halogen,” by themselves or as part of another substituent, mean, unless otherwise stated, a fluorine, chlorine, bromine, or iodine atom.

The term “cyano” or “nitrile” refers to the group —CN.

The term “thiocarbonylthio” refers to an ester group where one or more oxygen atoms have been replaced with a sulphur atom, e.g., a xanthate group may refer to the group —OC(S)S—, and a trithiocarbonate group refers to the group —SC(S)S—.

“Functionalized” as used herein, means the indicated substituent groups are chemically bonded in the main backbone chain or pendant to the main backbone. A “functional unit” as used herein, means a chemical group or moiety used in the chain itself to functionalize the main backbone chain or used pendant to the main backbone chain. In certain embodiments, a functional unit is analogous to a functional group. In certain embodiments, the functional unit can be a L_{X}, including a G group as set forth herein, or a R group (R, R^{Y1}, R^{Y2}, R^{M} and R^{Mp}). The functional unit can be identified as “Func” and the like. The particular position of the functional unit in the polymer is clear based on the context of the term's use herein. For example, a “backbone functional unit” is present in the main chain.

As used herein, the term “residue” or “residue of” a chemical moeity refers to a chemical moiety that is bound to a molecule, whereby through the binding, at least one covalent bond has replaced at least one atom of the original chemical moiety, resulting in a residue of the chemical moiety in the molecule. A residue can also be depicted as a structure either showing the replaced atom with a bond or the atom prior to replacement.

The term “cleavable” refers to a chemical group or moiety that is chemically labile under normal conditions. The term “non-cleavable” refers to a chemical group or moiety that is chemically stable under normal conditions.

As used herein, a “radical initiator” or “initiator” include, for example, hydrogen peroxide, organic peroxides such as dibenzoyl peroxide, di-t-butyl peroxide, benzoyl peroxide or methyl ethyl ketone peroxide, among others, and azo compounds such as azobisisobutyronitrile (AIBN), or 1,1′-azo-bis(cyclohexane-carbonitrile) (ABCN), among others.

As used herein, the term “photocatalyst” refers to a polymerization initiator used in PET-RAFT polymerizations. PET-RAFT initiates via a transfer of triplet excited stated energy or electron from an excited photocatalyst to RAFT agent or RAFT residue, which results in fragmentation to create radicals. The photocatalyst can comprise a closed-shell metalloporphyrin complex. In some non-limiting examples, the polymerization initiator comprises Zn(II) tetraphenylporphyrin (ZnTPP); meso-tetraphenylporphyrin (TPP); 5,10,15,20-tetraphenyl-21H,23H-porphine nickel(II) (NiTPP); 5,10,15,20-tetrakis(4-methoxyphenyl)-21H,23H-porphine cobalt(II) (CoTMPP); 5,10,15,20-tetrakis(4-methoxyphenyl)-21H,23H-porphine iron(III) chloride (FeTMPP); palladium(II) octaethylporphyrin (PdOEP); or a combination thereof. In some examples, the polymerization initiator comprises Zn(II) tetraphenylporphyrin (ZnTPP); palladium(II) octaethylporphyrin (PdOEP); or a combination thereof. In some examples, the polymerization initiator comprises Zn(II) tetraphenylporphyrin (ZnTPP). In some examples, the polymerization initiator comprises palladium(II) octaethylporphyrin (PdOEP).

As used herein, “linear polymer” refers to a polymer having side chains that are shorter than the spacer between neighboring side chains along the backbone or main chain of the polymer. When the spacer is negligibly short, “linear polymer” refers to a polymer having side chains that are shorter than the persistence length of the side chains. For example, a polymer chain with side chains, in which the spacer consists of two covalent bonds and side chain persistence length is ten covalent bonds long, is considered as a “linear polymer.” Examples of linear polymers include, but are not limited to, vinyl polymers with relatively short side chains or small side groups. When the side chains become longer than their persistence length, the polymer is no longer considered a linear polymer. Rather, the polymer is now considered a brush/comb polymer as further detailed below. For example, poly(butyl acrylate) with n-butyl side groups is a linear polymer whereas poly(octadecyl acrylate) with n-octadecyl side chains is a brush-like polymer.

As used herein, the term “brush polymer” and the like refers to a polymer block having side chains that are significantly longer than the spacer between neighboring side chains along the backbone or main chain of the polymer. Thus, without wishing to be bound by theory, the side chains can be at least more than two monomeric units long, more than 3 monomeric units long, more than 4 monomeric units long, more than 5 monomeric units long, more than 6 monomeric units long, more than 7 monomeric units long, or more than 8 monomeric units long, so long as the spacer is shorter than the square-root of the side chain length. For example, a brush-like polymer block could have poly(butyl acrylate) side chains with a degree of polymerization of 100 separated by a poly(butyl acrylate) spacer with a degree of polymerization of 2 (2<<<(100)). The chemical nature (i.e., repeat unit) of the side chains and the backbone are not necessarily identical.

As used herein, the term “side chain” refers to a chain pendant to the main polymer chain. Examples of chemical structures of side chains include, but are not limited to homopolymers and copolymers of polysiloxanes, polyacrylates, polymethacrylates, polyethers, polyolefins (e.g., polyisobutylene, polyethylene, ethylene/propylene copolymers), polyoxazolines, poly(glycerol sebacate), poly(a-esters), polyglycolide, polylactides, poly(lactide-co-glycolide), polycaprolactone, poly(ortho esters), polydioxanone, polyanhydrides, polyamides, poly(ester amide)s, polyurethanes, poly(propylene fumarate), poly(ethylene terephthalate), polycarbonate, polystyrene, poly(tetrafluoroethylene) and corresponding derivatives, copolymers and blends. Some examples of chemical composition of brush-like adhesive formulations include polydimethylsiloxane, polyisobutylene, poly(n-butyl acrylate), and polyethylene glycol.

As used herein, the term “visible light” refers to light with a wavelength between about 380 nm and about 750 nm, between about 400 nm and about 700 nm, or between about 440 nm and about 650 nm. Near infrared (NIR) light may refer to light with a wavelength between about 750 nm to about 2500 nm. The desired infrared (IR) wavelength range may refer to the wavelength range of IR light that can be detected by a suitable IR sensor (e.g., a complementary metal-oxide semiconductor (CMOS), a charge-coupled device (CCD) sensor, or an InGaAs sensor), such as between 830 nm and 860 nm, between 930 nm and 980 nm, or between about 750 nm to about 1000 nm.

As used herein, the terms “contacting” and “mixing” and the like refer to reagents, such as macromonomers, in close proximity so that a reaction may occur.

As used herein, “ambient temperature” or “room temperature” refers to a temperature in the range of about 20 to 25° C.

As used herein, the term “substantially” refers to the complete or nearly complete extent or degree of a component, or an action, characteristic, property, state, structure, item, or result. The exact allowable degree of deviation from absolute presence of such a component, or an action, characteristic, property, state, structure, item, or result may in some cases depend on the specific context. However, generally speaking, “substantially” will be so near as to have the same overall result as if absolute and total extent or degree were obtained. The use of “substantially” is equally applicable when used in a negative connotation to refer to the complete or near complete lack of a component, or an action, characteristic, property, state, structure, item, or result. For example, a composition that is “substantially free of” leaching would either completely lack leaching or so nearly completely lacking that the effect would be the same as if it completely lacked leaching. In other words, a composition that is “substantially free of” leaching may still actually leach as long as there is no measurable effect thereof, for example, trace amounts. As used herein, “essentially free” means a component, or an action, characteristic, property, state, structure, item, or result is not present or is not detectable.

Additional definitions may also be provided below.

### II. RAFT Step-Growth Polymerization Methods and Polymers

The subject matter described herein includes, but is not limited to, the following embodiments:
1. A RAFT step-growth polymerization process, comprising
   allowing a RAFT step-growth adduct to polymerize in a step-growth process in the presence of a solvent and one or more of the following: an initiator, visible light and a photocatalyst,
   wherein a RAFT step-growth polymer comprising one or more inserted backbone functional units and a RAFT agent residue in each repeat unit in the backbone of the polymer is prepared.
2. The RAFT step-growth polymerization process of embodiment 1, wherein the allowing a RAFT step-growth adduct to polymerize causes a cyclic process of chain transfer (kₜᵣ), to form a chain end radical; monomer addition (k₁) to the radical to form a mid-chain radical; and chain transfer (kₜᵣ), wherein the polymer forms by step-growth molecular weight evolution.
3. The RAFT step-growth polymerization process of embodiment 1 or 2, wherein the RAFT step-growth polymer comprises one or more repeat units selected from the group consisting of:

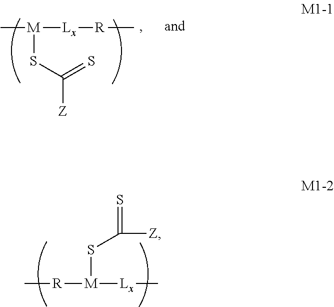

wherein,
   M, in each instance, is independently a residue of a monomer;
   R, in each instance, is independently a residue of a first backbone functional unit;
   L_{X}, in each instance, is independently a covalent bond or a linker covalently bound to M and/or to R;
   Z, in each instance, is independently selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl.
3a. The RAFT step-growth polymerization process of embodiment 3, wherein the monomer, in each instance, is independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers. In certain embodiments, the monomer is selected from the group consisting of a M_{A} and M_{A′}, as described elsewhere herein.
3b. The RAFT step-growth polymerization process of embodiment 3 or 3a, wherein L_{X}, in each instance, is independently selected from the group consisting of a covalent bond or a linker. In certain embodiments, the linker is selected from the group consisting of a C₁₋₂₀ alkylene, a C₁₋₁₈ alkylene, a C₁₋₁₆ alkylene, a C₁₋₁₄ alkylene, a C₁₋₁₂ alkylene, a C₁₋₁₀ alkylene, a C₁₋₈ alkylene, a C₁₋₆ alkylene, a C₁₋₄ alkylene, a C₁₋₂ alkylene, a L_{Y} group, as described elsewhere herein, and a G group, as described elsewhere herein.
3c. The RAFT step-growth polymerization process of embodiment 3, 3a or 3b, wherein R, in each instance, is independently a residue of a first backbone functional unit. In certain embodiments, R is selected from the group consisting of R^{M}, R^{Mp}, R^{Y1} and R^{Y2}, each of which is described elsewhere herein.
3d. The RAFT step-growth polymerization process of embodiment 3, wherein one or more repeat units has the structure:

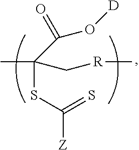

wherein D is C₁₋₂₀ alkyl, such as

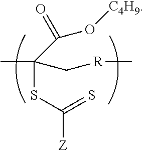

3e. The RAFT step-growth polymerization process of embodiment 3d, wherein Z is a C₁₋₂₀ alkyl.
4. The RAFT step-growth polymerization process of embodiment 1, 2 or 3, 3a, 3b, 3c, 3d or 3e, wherein the RAFT step-growth adduct is a Monomer-Chain Transfer Agent (M_{A}-CTA).
5. The RAFT step-growth polymerization process of claim 4, wherein the M_{A}-CTA has the following structure:

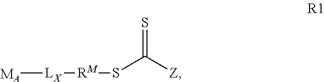

wherein,
   M_{A} is a residue of a monomer M;
   R^{M} is a residue of a first backbone functional unit;
   L_{X}, in each instance, is independently a covalent bond or a linker covalently bound to M_{A} and to R^{M};
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl.
6. The RAFT step-growth polymerization process of embodiment 5, wherein R^{M} is selected from the group consisting of:

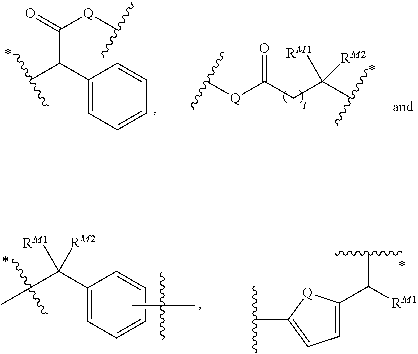

wherein,
   * indicates attachment to S;
   R^{M1} and R^{M2} are each independently selected from the group consisting of hydrogen, cyano and C₁₋₆ alkyl;
   t is 0, 1 or 2; and,
   Q is CR^{Q}₂, S, O or NR^{Q},
      wherein R^{Q} in each instance is independently hydrogen or C₁₋₆ alkyl.
7. The RAFT step-growth polymerization process of embodiment 6, wherein the M_{A}-CTA has the structure:

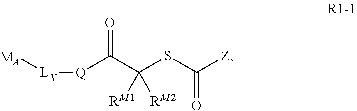

wherein,
   M_{A} is a residue of a monomer M;
   L_{X}, in each instance, is independently a covalent bond or a linker covalently bound to M_{A} and to R^{M};
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
and,
   R^{M1} and R^{M2} are each independently hydrogen or optionally substituted C₁₋₆ alkyl.
8. The RAFT step-growth polymerization process of embodiment 7, wherein the M_{A}-CTA has the structure:

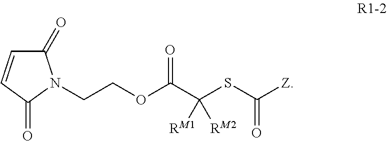

9. The RAFT step-growth polymerization process of embodiment 8, wherein the M_{A}-CTA has the structure:

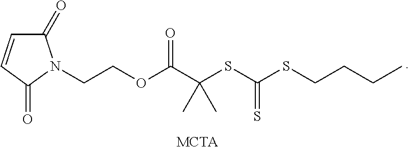 [SMILES: CCCCSC(=S)SC(C)(C)C(=O)OCCN1C(=O)C=CC1=O]

10. The RAFT step-growth polymerization process of embodiment 1, wherein the polymer has the formula:

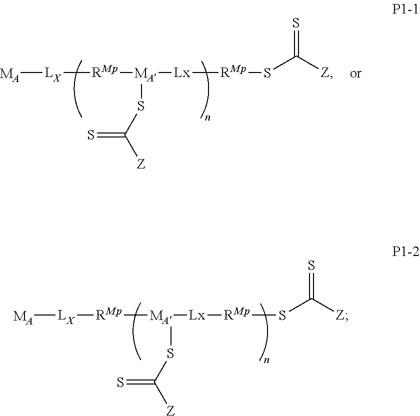

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
   and,
      n is an integer from 1 to 1,000.
11. The RAFT step-growth polymerization process of embodiment 10, wherein the monomer M_{A} and M_{A′} are each independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.
12. The RAFT step-growth polymerization process of embodiment 11, wherein M_{A} is a residue of:

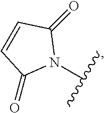 [SMILES: *N1C(=O)C=CC1=O]

and
   M_{A′} is a residue of:

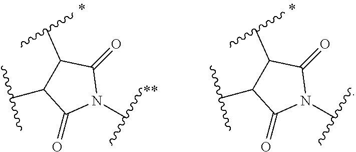 [SMILES: *C1C(=O)N(*)C(=O)C1* ; *C1C(=O)N(*)C(=O)C1*]

where * indicates attachment to the RAFT group, and ** indicates attachment to L_{X}.
13. The RAFT step-growth polymerization process of embodiment 10, wherein R^{Mp} is selected from the group consisting of:

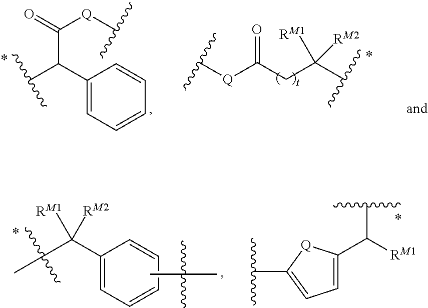

wherein,
   * indicates attachment to S;
   R^{M1} and R^{M2} are each independently selected from the group consisting of hydrogen, cyano and C₁₋₆ alkyl;
   t is 0, 1 or 2; and,
   Q is CR^{Q}₂, S, O or NR^{Q},
      wherein R^{Q} in each instance is independently hydrogen or C₁₋₆ alkyl.
14. The RAFT step-growth polymerization process of embodiment 10, wherein the polymer has the structure:

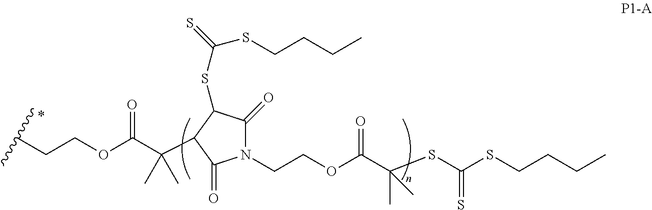

wherein,

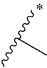

denotes attachment to a terminal group selected from the group consisting of:

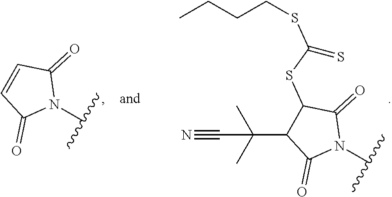 [SMILES: *N1C(=O)C=CC1=O ; *N1C(=O)C(SC(=S)SCCCC)C(C(C)(C)C#N)C1=O]

15. The RAFT step-growth polymerization process of embodiment 1, wherein the RAFT step-growth adduct is a Bifunctional-Chain Transfer Agent (CTA₁-G-CTA₂), and the process further comprises contacting the CTA₁-G-CTA₁ with a bifunctional monomer pair M₁-L_{Y}-M₂, wherein L_{Y} is a linker covalently bound to M₁ and to M₂, and each of M₁ and M₂ is a monomer.
16. The RAFT step-growth polymerization process of embodiment 15, wherein M₁ and M₂ are each independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.
17. The RAFT step-growth polymerization process of embodiment 16, wherein M₁ and M₂ are each, independently selected from the group consisting of.

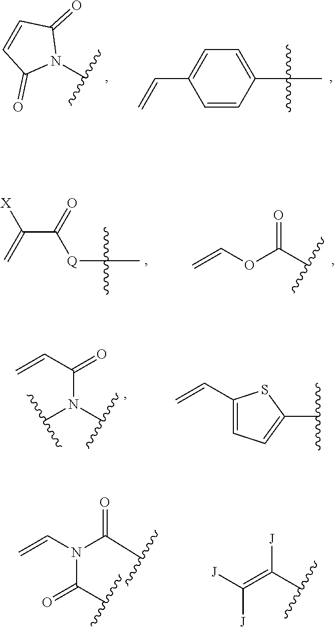

wherein,
   X is CH₃ or H, Q is O or N—H;
J is Br, Cl, F or H; and, [symbol] denotes the attachment to L_{Y}.
18. The RAFT step-growth polymerization process of embodiment 17, wherein M₁ and M₂ are each a residue of:

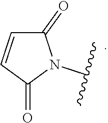 [SMILES: *N1C(=O)C=CC1=O]

18a. The RAFT step-growth polymerization process of embodiment 17, wherein M₁ and M₂ are each a residue of:

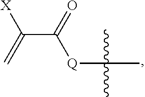

wherein, X is CH₃ or H, Q is O or N—H.
18b. The RAFT step-growth polymerization process of embodiment 18a, wherein X is H and Q is 0.
18c. The RAFT step-growth polymerization process of embodiment 18a, wherein X is H and Q is NH.
19. The RAFT step-growth polymerization process of embodiment 15, wherein L_{Y} is cleavable.
20. The RAFT step-growth polymerization process of embodiment 15, wherein L_{Y} is non-cleavable.
21. The RAFT step-growth polymerization process of embodiment 15, wherein L_{Y} is selected from the group consisting of:

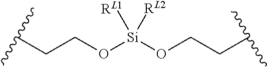

wherein, R^{L1} and R^{L2} are each independently selected from the group consisting of C₁₋₆ alkyl and phenyl;

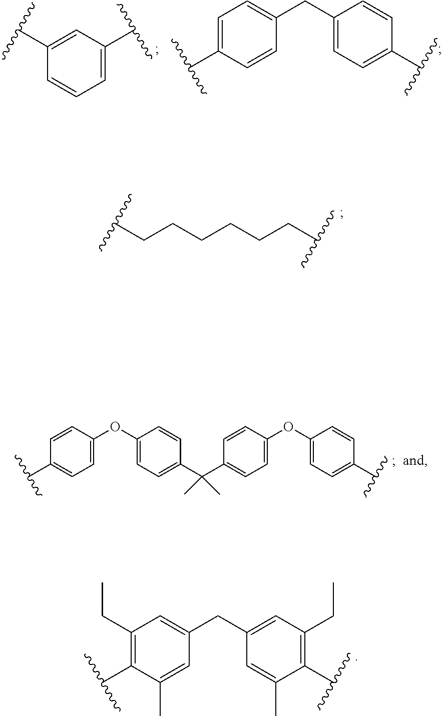 [SMILES: *c1cccc(*)c1 ; *c1ccc(Cc2ccc(*)cc2)cc1 ; *CCCCCC* ; *c1ccc(Oc2ccc(C(C)(C)c3ccc(Oc4ccc(*)cc4)cc3)cc2)cc1 ; *c1c(C)cc(Cc2cc(C)c(*)c(CC)c2)cc1CC]

21a. The RAFT step-growth polymerization process of embodiment 15, wherein L_{Y} is selected from the group consisting of

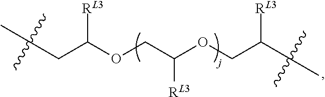

wherein, J is an integer from 1 to 100, or 1 to 90, or 1 to 80, or 1 to 70, or 1 to 60, or 1 to 50, or 1 to 40, or 1 to 30, or 1 to 20 or 1 to 10 and any integer within these ranges; and R^{L3} in each instance is independently selected from the group consisting of hydrogen and C₁₋₆ alkyl, such as methyl;

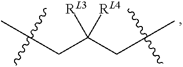

wherein, R^{L3} and R^{L4} in each instance is independently selected from the group consisting of hydrogen, halo and C₁₋₆ alkyl, such as methyl;
is derived from,

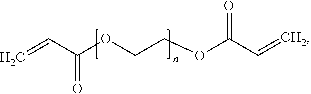

wherein, n is an integer from 1 to 100, or 1 to 90, or 1 to 80, or 1 to 70, or 1 to 60, or 1 to 50, or 1 to 40, or 1 to 30, or 1 to 20 or 1 to 10 and any integer within these ranges, when n is in the structure above is 1, L_{Y} is

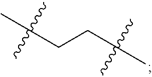 [SMILES: *CC*]

and when n is 2 or more in the structure above, L_{Y} has the structure:

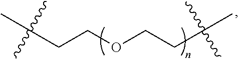

and,

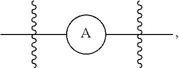

wherein, A is a C₅₋₁₂ cycloalkyl, such as a bridged, bicyclic C₁₀ cycloalkyl:

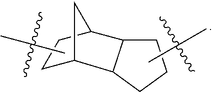

21b. The RAFT step-growth polymerization process of embodiment 21a, wherein M₁ and M₂ are each a residue of

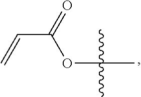 [SMILES: *OC(=O)C=C]

22. The RAFT step-growth polymerization process of embodiment 15, wherein the bifunctional monomer pair M₁-L_{Y}-M₂ is:

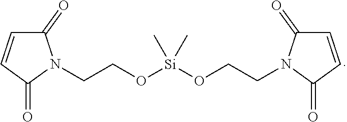 [SMILES: C[Si](C)(OCCN1C(=O)C=CC1=O)OCCN1C(=O)C=CC1=O]

23. The RAFT step-growth polymerization process of embodiment 15, wherein CTA1-G-CTA2 has the formula:

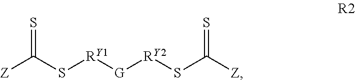

wherein,
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
   wherein, R^{x} and R^{y} are each independently selected from the group consisting of C₁₋₂₀ alkyl and pyridinyl.
24. The RAFT step-growth polymerization process of embodiment 23, wherein G is non-cleavable.
25. The RAFT step-growth polymerization process of embodiment 24, wherein G is cleavable.
26. The RAFT step-growth polymerization process of embodiment 24, wherein G is —(C₁₋₁₂ alkyl)- or —(C₁₋₆ alkyl)-S—S—(C₁₋₆ alkyl)-.
27. The RAFT step-growth polymerization process of embodiment 23, wherein G is selected from the group consisting of:

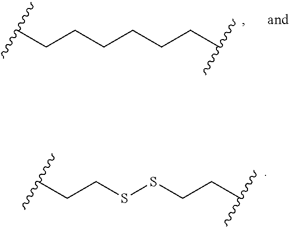 [SMILES: *CCCCCC* ; *CCSSCC*]

28. The RAFT step-growth polymerization process of embodiment 23, wherein R^{Y1} and R^{Y2} are each independently selected from the group consisting of:

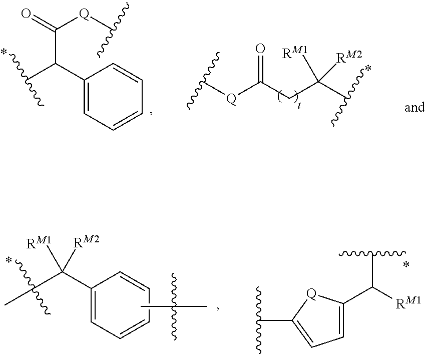

wherein,
   * indicates attachment to S;
   R^{M1} and R^{M2} are each independently selected from the group consisting of hydrogen, cyano and C₁₋₆ alkyl;
   t is 0, 1 or 2; and,
   Q is CR^{Q}₂, S, O or NR^{Q},
      wherein R^{Q} in each instance is independently hydrogen or C₁₋₆ alkyl.
29. The RAFT step-growth polymerization process of embodiment 28, wherein CTA1-G-CTA2 has the structure:

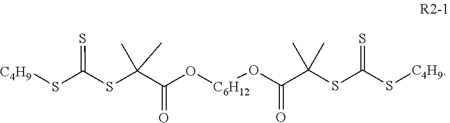

30. The RAFT step-growth polymerization process of embodiment 15, wherein the polymer comprises one or more repeat units having the formula:

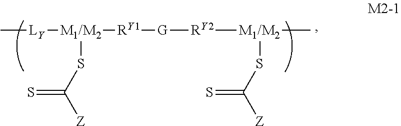

wherein,
   M₁ and M₂, in each instance, is independently a residue of a monomer;
   L_{Y} is a linker covalently bound to M₁ and/or M₂;
   R^{Y1} and R^{Y2} are each independently a residue of a first backbone functional unit;
   G is a residue of a second backbone functional unit; and,
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl.
31. The RAFT step-growth polymerization process of embodiment 30, wherein the polymer has the structure:

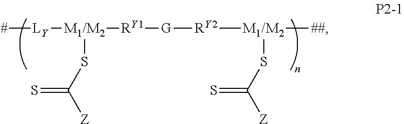

wherein, # and ## each independently denotes attachment to a terminal group selected from the group consisting of:

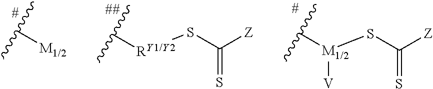

wherein,
   M₁ and M₂, in each instance, is independently a residue of a monomer;
   V, in each instance, is independently absent or is a residue of an initiator;
   L_{Y} is a linker covalently bound to M₁ and/or M₂;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and, n is an integer from 1 to 1,000.
32. The RAFT step-growth polymerization process of embodiment 31, wherein the polymer has the structure:

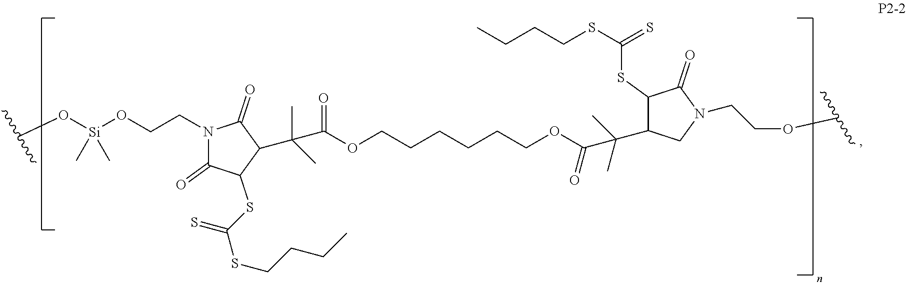

wherein [symbol] in each instance independently denotes attachment to a terminal group selected from the group consisting of:

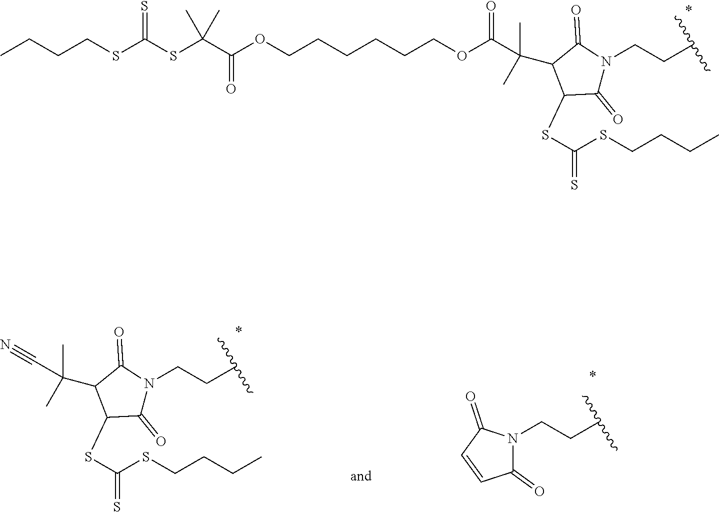 [SMILES: *CCN1C(=O)C(SC(=S)SCCCC)C(C(C)(C)C(=O)OCCCCCCOC(=O)C(C)(C)SC(=S)SCCCC)C1=O ; *CCN1C(=O)C(SC(=S)SCCCC)C(C(C)(C)C#N)C1=O ; *CCN1C(=O)C=CC1=O]

32a. The RAFT step-growth polymerization process of embodiment 31, wherein the repeat unit has the structure:

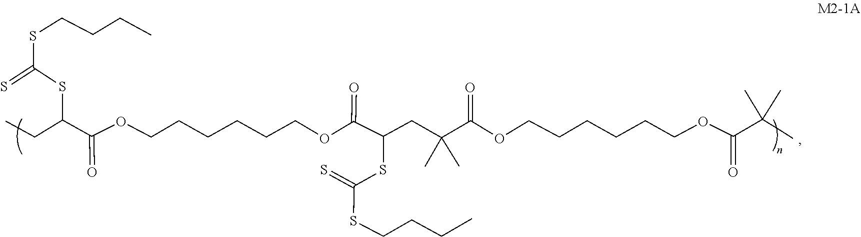

and n is as described herein.
32b. The RAFT step-growth polymerization process of embodiment 31, wherein the polymer comprises the structure:

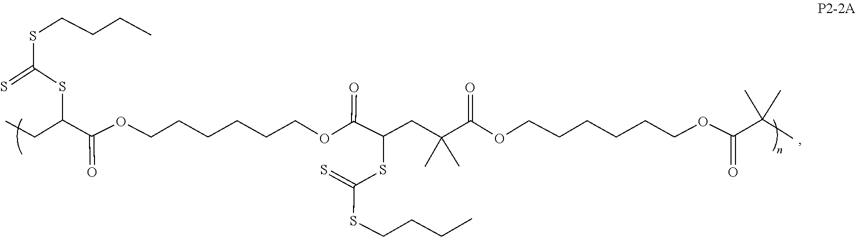

and n is as described herein.
32c. In embodiments, the polymers of the RAFT step-growth polymerization process comprise end groups as exemplified, but not limited to, in the following units:

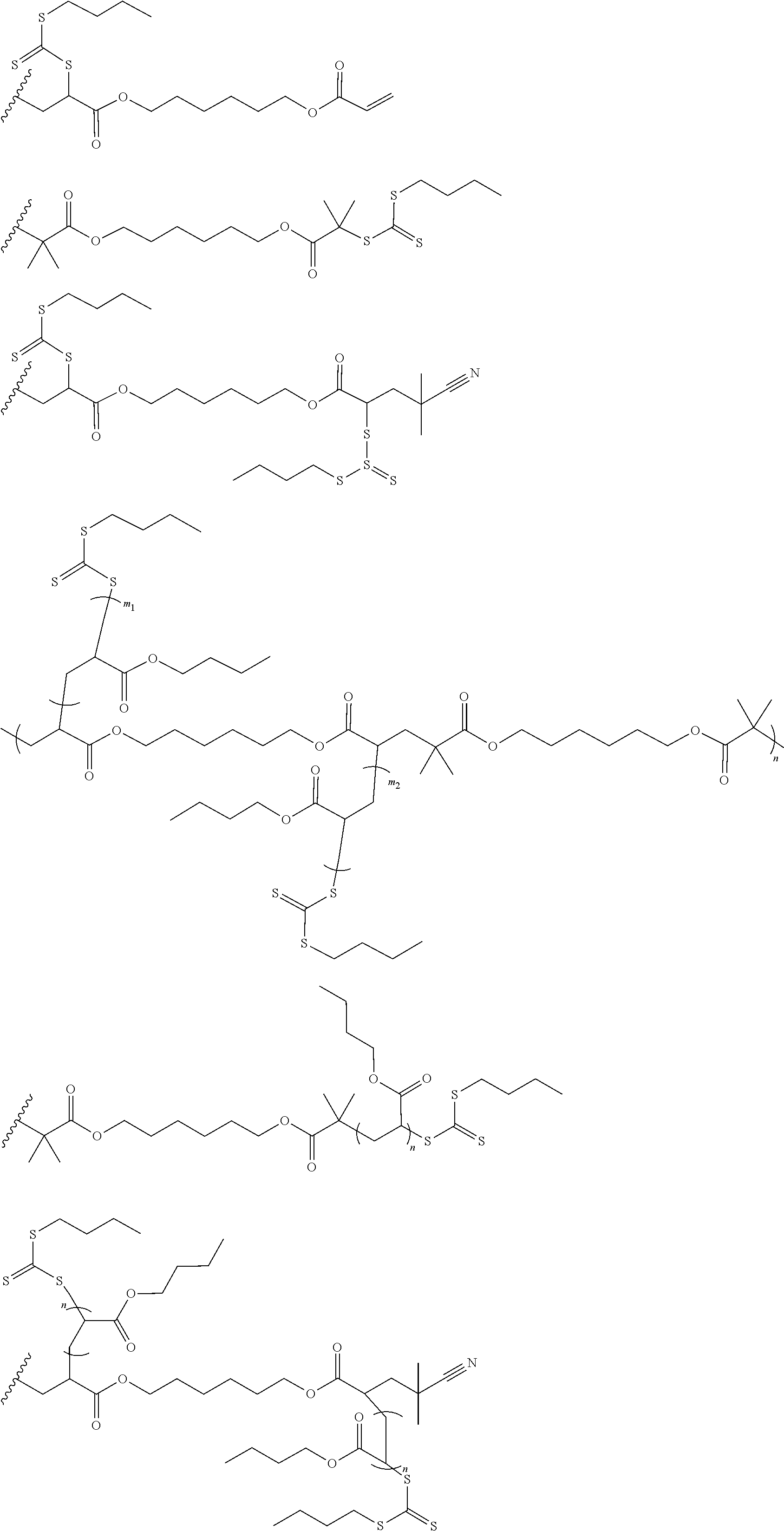

33. The RAFT step-growth polymerization process of embodiment 15, wherein M₁ and M₂ are the same.
34. The RAFT step-growth polymerization process of embodiment 15, wherein the stoichiometric ratio of the CTA1-G-CTA2 to the M₁-L_{Y}-M₂ is from about 0.1 to about 10, or from about 10 to about 0.1.
35. The RAFT step-growth polymerization process of embodiment 34, wherein the ratio of CTA1-G-CTA2/M₁-L_{Y}-M₂ is about 1 to about 0.1. 36. The RAFT step-growth polymerization process of embodiment 1 or 15, wherein the one or more RAFT residues comprises a thiocarbonylthio moiety.
37. The RAFT step-growth polymerization process of embodiment 36, further comprising,
   contacting one or more thiocarbonylthio residues of the polymer with a monomer M_{B} to prepare a brush polymer.
38. The RAFT step-growth polymerization process of embodiment 37, wherein the brush polymer has the structure:

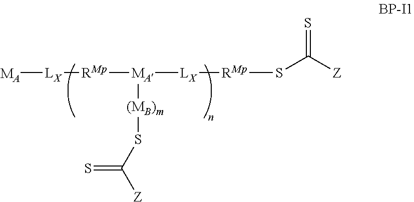

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   M_{B} is a residue of a monomer;
   m is an integer from 1 to 1,000;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
   and,
      n is an integer from 1 to 1,000.
39. The RAFT step-growth polymerization process of embodiment 37, wherein the brush polymer has the structure:

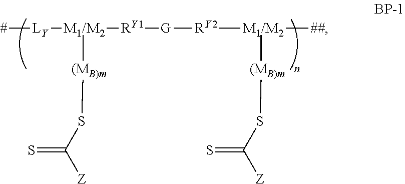

wherein, # and ## each independently denotes attachment to a terminal group selected from the group consisting of:

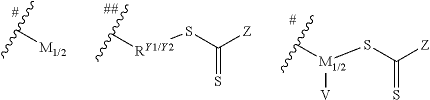

wherein,
   M₁ and M₂, in each instance, is independently a residue of a monomer;
   V, in each instance, is independently absent or is a residue of an initiator;
   M_{B} is residue of a monomer;
   m is an integer from 1 to 1,000
   L_{Y} is a linker covalently bound to M₁ and/or M₂;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and, n is an integer from 1 to 1,000.
40. The RAFT step-growth polymerization process of embodiment 38 or 39, wherein the monomer M_{B} is selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.
41. The RAFT step-growth polymerization process of embodiment 40, wherein the monomer M_{B} is selected from the group consisting of:

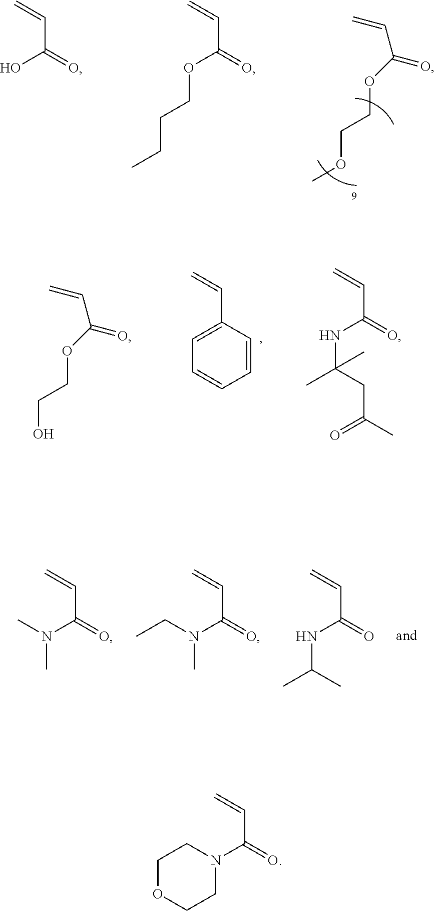

42. The RAFT step-growth polymerization process of embodiment 41, wherein the brush polymer comprises one or more monomers having the formula:

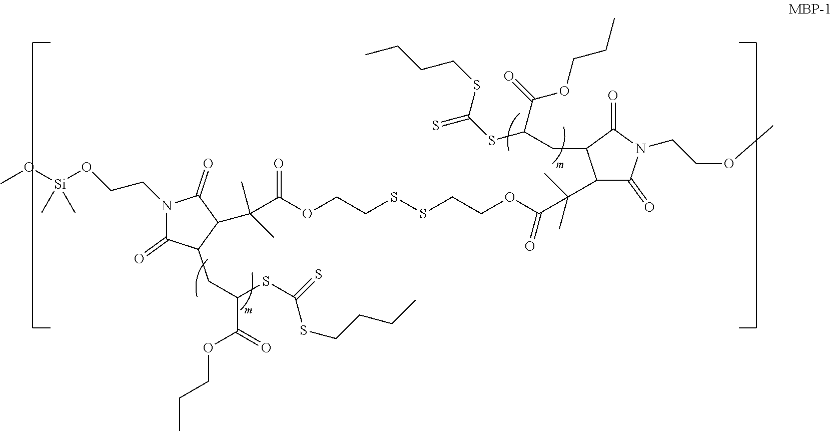

wherein, m is an integer from 1 to 1,000.
42a. The RAFT step-growth polymerization process of embodiment 41, wherein the brush polymer comprises one or more monomers having the formula:

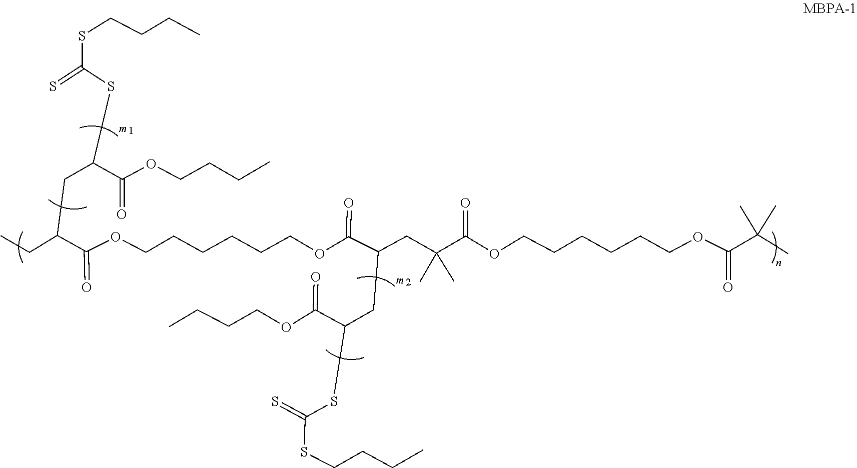

wherein, m is an integer from 1 to 1,000.
43. The RAFT step-growth polymerization process of embodiment 42, wherein m is an integer from about 20 to about 100.
44. The RAFT step-growth polymerization process of embodiment 42, wherein the brush polymer has the structure:

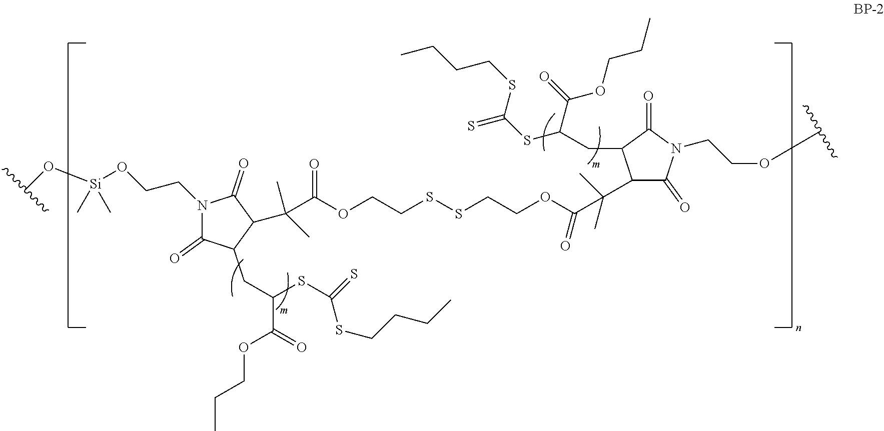

wherein,
n is an integer from 1 to 1,000; and
[symbol] in each instance independently denotes attachment to a terminal group selected from the group consisting of:

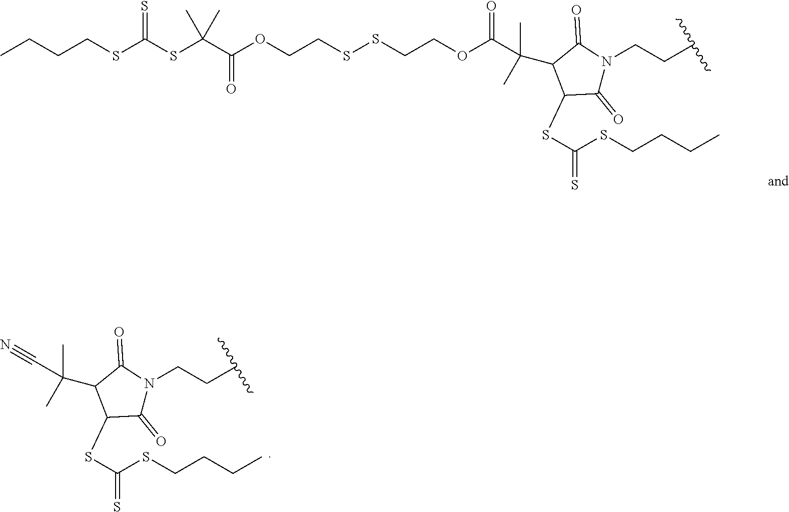 [SMILES: *CCN1C(=O)C(SC(=S)SCCCC)C(C(C)(C)C(=O)OCCSSCCOC(=O)C(C)(C)SC(=S)SCCCC)C1=O ; *CCN1C(=O)C(SC(=S)SCCCC)C(C(C)(C)C#N)C1=O]

45. The RAFT step-growth polymerization process of embodiment 1, wherein the solvent is selected from the group consisting of water, alcohol, halogenated solvent, DMSO, DMF, dioxane, NMP, toluene, cresol, tetrachloroethane and trifluoroethanol.
46. The RAFT step-growth polymerization process of embodiment 45, wherein the solvent is selected from the group consisting of tetrachloroethane, cresol and dioxane.
47. The RAFT step-growth polymerization process of embodiment 46, wherein the solvent is dioxane.
48. The RAFT step-growth polymerization process of embodiment 1 or 15, further comprising removing one or more of the RAFT residues.
49. A polymer comprising a functional backbone, wherein the polymer has the formula:

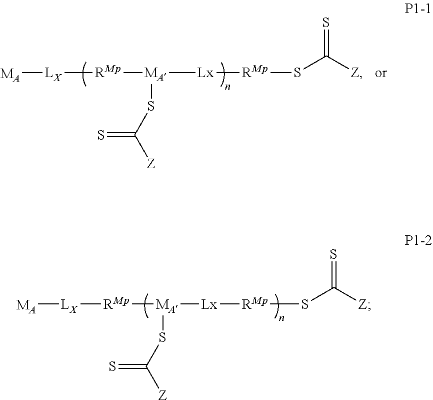

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
   and,
      n is an integer from 1 to 1,000.
50. A polymer made by the process of embodiment 1, comprising a functional backbone, wherein the polymer has the formula:

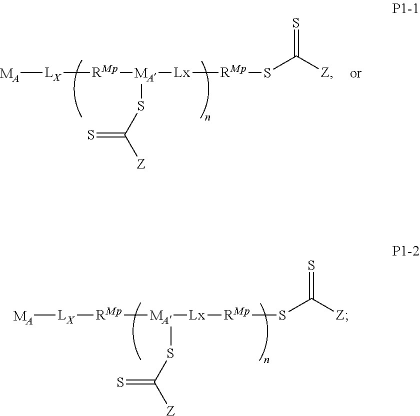

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
and,
   n is an integer from 1 to 1,000.
51. A polymer comprising a functional backbone, wherein the polymer has the formula:

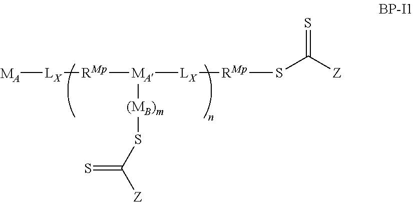

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   M_{B} is a residue of a monomer;
   m is an integer from 1 to 1,000;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
and,
   n is an integer from 1 to 1,000.
52. A polymer made by the process of embodiment 37, comprising a functional backbone, wherein the polymer has the formula:

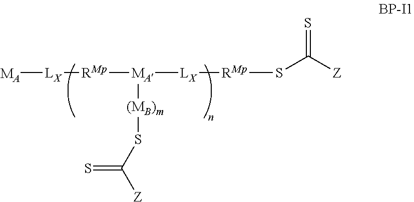

wherein,
   M_{A} and M_{A′} in each instance, is independently a residue of a monomer;
   L_{X}, in each instance, is independently a covalent bond or a linker covalently bound to M_{A} and to R^{Mp};
   R^{Mp}, in each instance, is independently a residue of a first backbone functional unit;
   M_{B} is a residue of a monomer;
   m is an integer from 1 to 1,000;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl;
and,
   n is an integer from 1 to 1,000.
53. A polymer comprising a functional backbone, wherein the polymer has the structure:

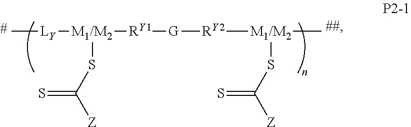

wherein, # and ## each independently denotes attachment to a terminal group selected from the group consisting of:

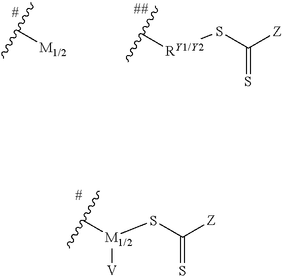

wherein,
   M₁ and M₂, in each instance, is independently a residue of a monomer;
   V is a residue of an initiator;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and,
   n is an integer from 1 to 1,000.
54. A polymer made by the process of embodiment 15, comprising a functional backbone, wherein the polymer has the structure:

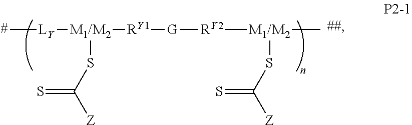

wherein, # and ## each independently denotes attachment to a terminal group selected from the group consisting of:

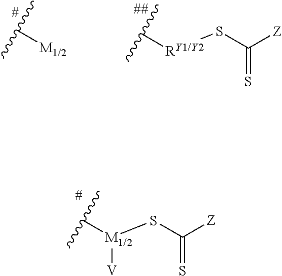

wherein,
   M₁ and M₂, in each instance, is independently a residue of a monomer;
   V is a residue of an initiator;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and,
   n is an integer from 1 to 1,000.
55. A polymer comprising a functional backbone, wherein the polymer has the structure:

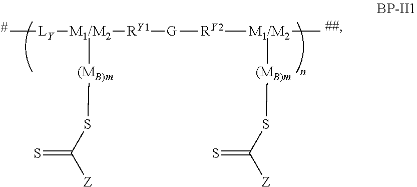

wherein, # and ## each independently denotes attachment to a terminal group selected from the group consisting of:

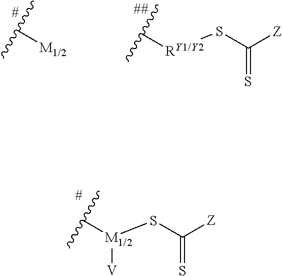

wherein,
   M₁ and M₂, in each instance, is independently a residue of a monomer;
   V is a residue of an initiator;
   M_{B} is residue of a monomer;
   m is an integer from 1 to 1,000;
   L_{Y} is a linker covalently bound to M₁ and/or M₂;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and,
   n is an integer from 1 to 1,000.
56. A polymer made by the process of embodiment 38, comprising a functional backbone, wherein the polymer has the structure:

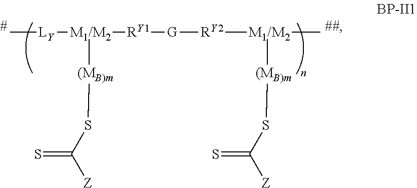

wherein, # and ## each independently denotes attachment to a terminal group selected from the group consisting of

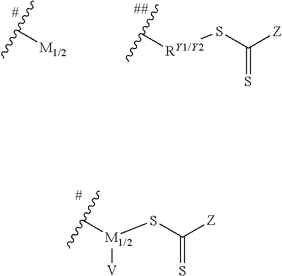

wherein,
   M₁ and M₂, in each instance, is independently a residue of a monomer;
   V is a residue of an initiator;
   M_{B} is residue of a monomer;
   m is an integer from 1 to 1,000 L_{Y} is a linker covalently bound to M₁ and/or M₂;
   R^{Y1} and R^{Y2} are each independently a residue of a first backbone functional unit;
   G is a residue of a second backbone functional unit;
   Z is selected from the group consisting of —S—C₁₋₂₀ alkyl, —O—C₁₋₂₀ alkyl, phenyl, —O-phenyl, pyrrolyl and NR^{x}R^{y};
      wherein, R^{x} and R^{y} are each independently selected from the group consisting of C₁₋₂₀ alkyl and pyridinyl; and,
   n is an integer from 1 to 1,000.
57. The RAFT step-growth polymer of embodiment 49, 50, 51 or 52, wherein the monomer M_{A} and M_{A′}, in each instance, is independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.
58. The RAFT step-growth polymer of embodiment 49, 50, 51, 52 or 57, wherein L_{X}, in each instance, is independently selected from the group consisting of a covalent bond or a linker. In certain embodiments, the linker is selected from the group consisting of a C₁₋₂₀ alkylene, a C₁₋₁₈ alkylene, a C₁₋₁₆ alkylene, a C₁₋₁₄ alkylene, a C₁₋₁₂ alkylene, a C₁₋₁₀ alkylene, a C₁₋₈ alkylene, a C₁₋₆ alkylene, a C₁₄ alkylene, a C₁₋₂ alkylene, a L_{Y} group, as described elsewhere herein, and a G group, as described elsewhere herein.
59. The RAFT step-growth polymer of embodiment 49, 50, 51, 52, 57 or 58, wherein R^{Mp}, in each instance, is independently a residue of a first backbone functional unit selected from the group consisting of:

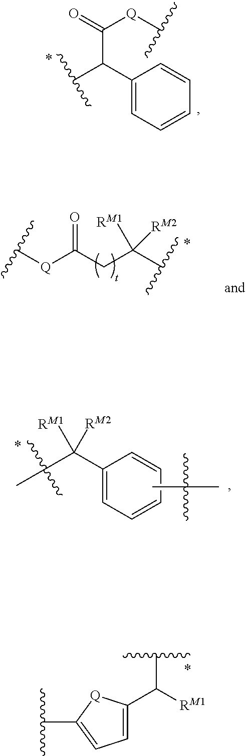

wherein,
   * indicates attachment to S;
   R^{M1} and R^{M2} are each independently selected from the group consisting of hydrogen, cyano and C₁₋₆ alkyl;
   t is 0, 1 or 2; and,
   Q is CR^{Q}₂, S, O or NR^{Q},
      wherein R^{Q} in each instance is independently hydrogen or C₁₋₆ alkyl.
60. The RAFT step-growth polymerization process of embodiment 30, 31, 32, 33, 34, 35 or 38, or polymer of embodiment 52, 53, 54, 55 or 56, wherein L_{Y} is cleavable; non-cleavable; or is selected from the group consisting of:

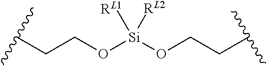

wherein, R^{L1} and R^{L2} are each independently selected from the group consisting of C₁₋₆ alkyl and phenyl;

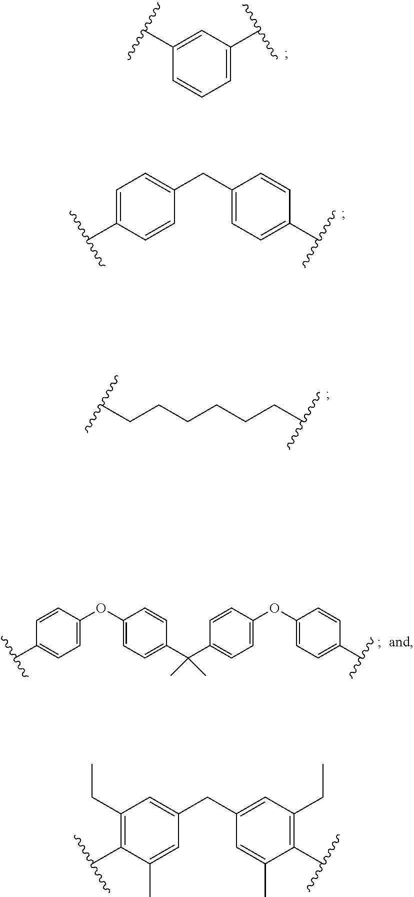 [SMILES: *c1cccc(*)c1 ; *c1ccc(Cc2ccc(*)cc2)cc1 ; *CCCCCC* ; *c1ccc(Oc2ccc(C(C)(C)c3ccc(Oc4ccc(*)cc4)cc3)cc2)cc1 ; *c1c(C)cc(Cc2cc(C)c(*)c(CC)c2)cc1CC]

or, L_{Y} is selected from the group consisting of:

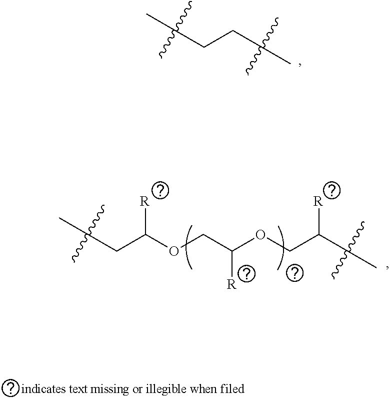

wherein, J is an integer from 1 to 100, or 1 to 90, or 1 to 80, or 1 to 70, or 1 to 60, or 1 to 50, or 1 to 40, or 1 to 30, or 1 to 20 or 1 to 10 and any integer within these ranges; and R^{L3} in each instance is independently selected from the group consisting of hydrogen and C₁₋₆ alkyl, such as methyl;

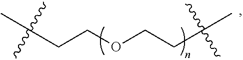

wherein, n is an integer from 1 to 100 or 1 to 90, or 1 to 80, or 1 to 70, or 1 to 60, or 1 to 50, or 1 to 40, or 1 to 30, or 1 to 20 or 1 to 10 and any integer within these ranges;

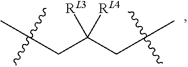

wherein, R^{L3} and R^{L4} in each instance is independently selected from the group consisting of hydrogen, halo and C₁₋₆ alkyl, such as methyl; and

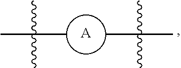

wherein, A is a C₅₋₁₀ cycloalkyl, such as a bridged, bicyclic C₁₀ cycloalkyl:

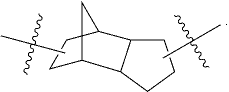

61. The RAFT step-growth polymerization process of embodiment 30, 31, 32, 33, 34, 35 or 38, or polymer of embodiment 52, 53, 54, 55, 56 or 60, wherein M₁ and M₂ are each independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.
62. The RAFT step-growth polymerization process of embodiment 30, 31, 32, 33, 34, 35 or 38, or polymer of embodiment 52, 53, 54, 55, 56, 60 or 61, wherein M₁ and M₂ are each, independently selected from the group consisting of:

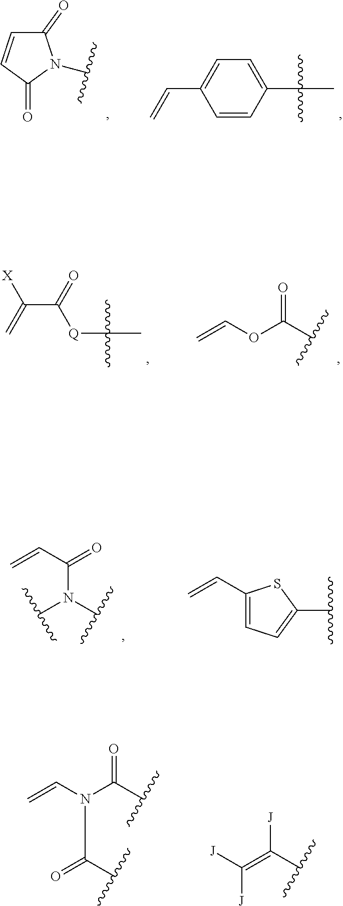

wherein,
   X is CH₃ or H, Q is O or N—H;
   J is Br, Cl, F or H; and,
   [symbol] denotes the attachment to L_{Y}.
63. The RAFT step-growth polymerization process of embodiment 30, 31, 32, 33, 34, 35 or 38, or polymer of embodiment 52, 53, 54, 55, 56, 60, 61 or 62, wherein M₁ and M₂ are each a residue of:

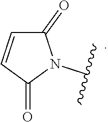 [SMILES: *N1C(=O)C=CC1=O]

64. The RAFT step-growth polymerization process of embodiment 30, 31, 32, 33, 34, 35 or 38, or polymer of embodiment 52, 53, 54, 55, 56, 60, 61, 62 or 63, wherein R^{Y1} and R^{Y2} are each independently selected from the group consisting of:

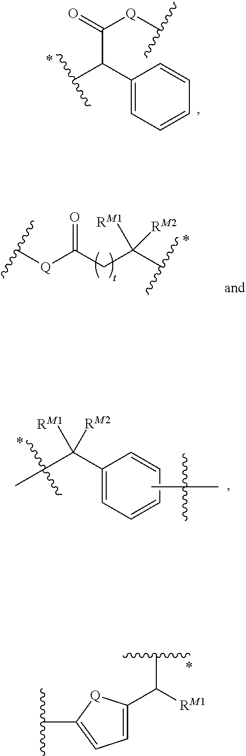

wherein,
   * indicates attachment to S;
   R^{M}₁ and R^{M2} are each independently selected from the group consisting of hydrogen, cyano and C₁₋₆ alkyl;
   t is 0, 1 or 2; and,
   Q is CR^{Q}₂, S, O or NR^{Q},
      wherein R^{Q} in each instance is independently hydrogen or C₁₋₆ alkyl.
65. The RAFT step-growth polymerization process of embodiment 30, 31, 32, 33, 34, 35 or 38, or polymer of embodiment 52, 53, 54, 55, 56, 60, 61, 62, 63 or 64, wherein G is non-cleavable; is cleavable; is —(C₁₋₁₂ alkyl)- or —(C₁₋₆ alkyl)-S—S—(C₁₋₆ alkyl)-; or is selected from the group consisting of:

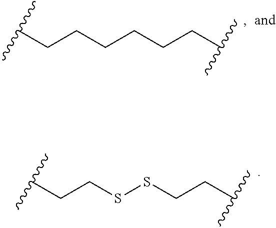 [SMILES: *CCCCCC* ; *CCSSCC*]

66. The RAFT step-growth polymerization process of embodiment 38, 39, 40, 41, 42, 43 or 44, or polymer of embodiment 51, 52, 55, 56, 57, 58, 59, 60, 61, 62, 63, 64 or 65, wherein m is an integer of 1 to 900; or an integer of 1 to 800; 1 to 700; or an integer of 1 to 600; 1 to 500; or an integer of 1 to 400; 1 to 300; or an integer of 1 to 200; 1 to 100; or an integer of 1 to 50.
67. The RAFT step-growth polymerization process of embodiment 10, 11, 12, 13, 14, 31, 32, 38, 39, 40, 41, 42, 43 or 44, or polymer of embodiment 49, 50, 51, 52, 53, 54, 55, 56, 57, 58, 59, 60, 61, 62, 63, 64, 65 or 66, wherein n is an integer of 1 to 900; or an integer of 1 to 800; 1 to 700; or an integer of 1 to 600; 1 to 500; or an integer of 1 to 400; 1 to 300; or an integer of 1 to 200; 1 to 100; or an integer of 1 to 50.

Useful monomers and monomer pairs include those described herein. Non-limiting examples of bifunctional monomer pairs M₁-L_{Y}-M₂ and Bifunctional-Chain Transfer Agents CTA1-G-CTA2, and the resulting polymers include the following:

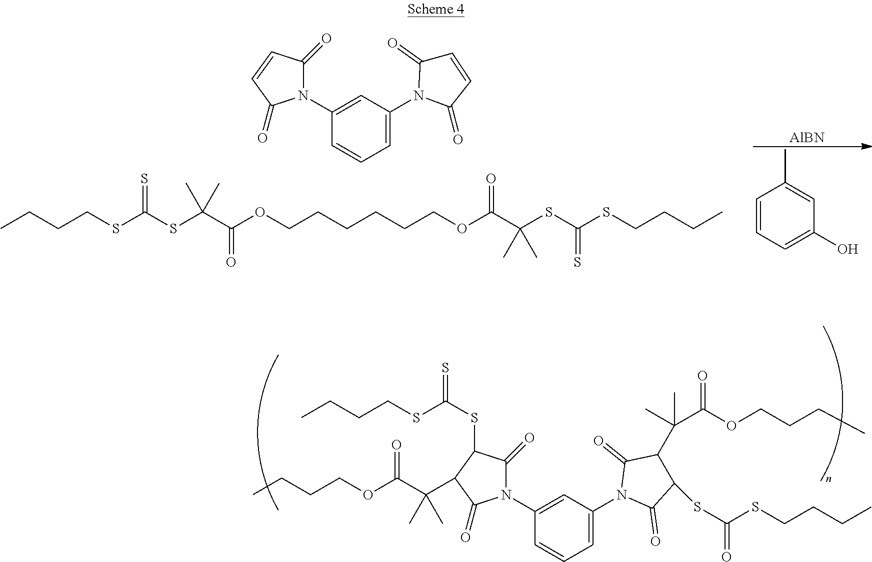

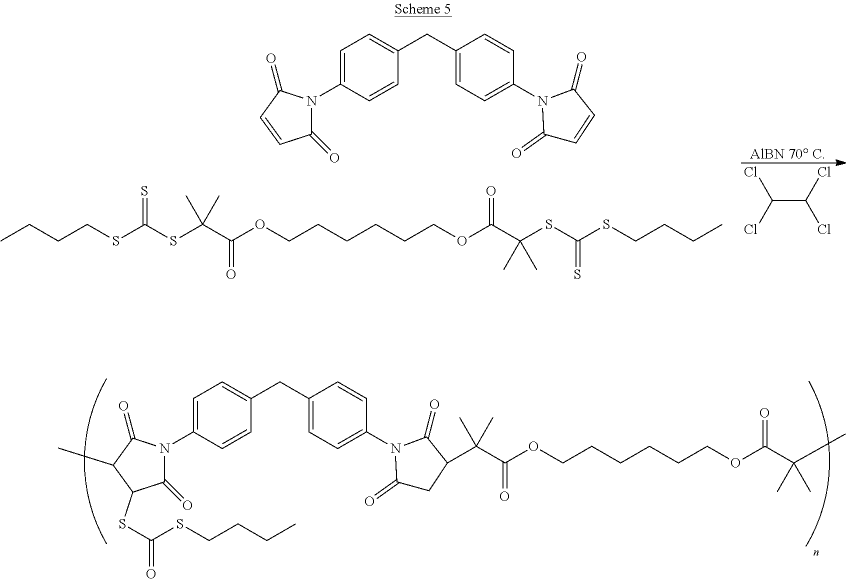

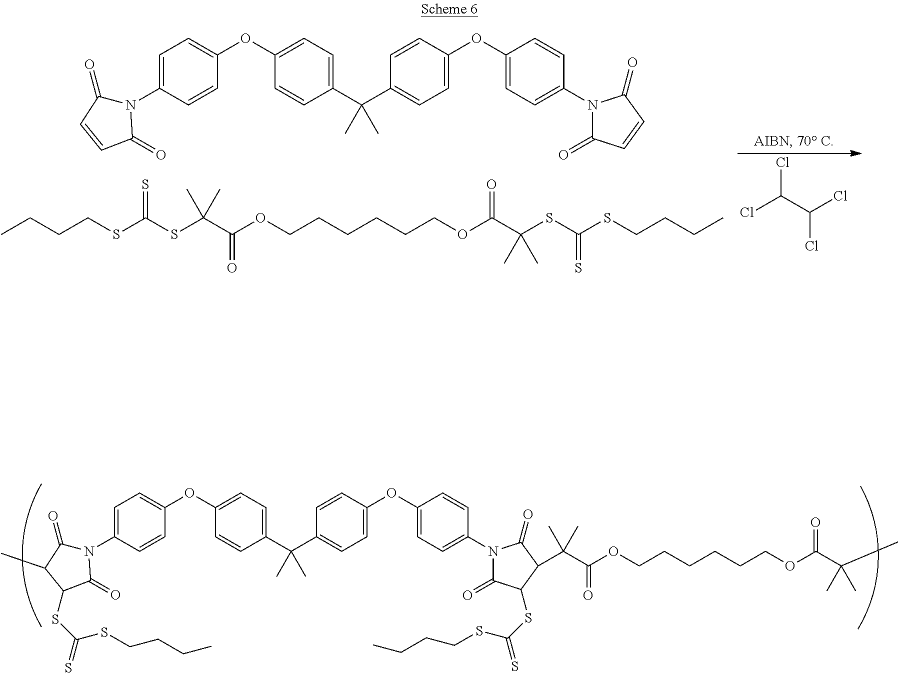

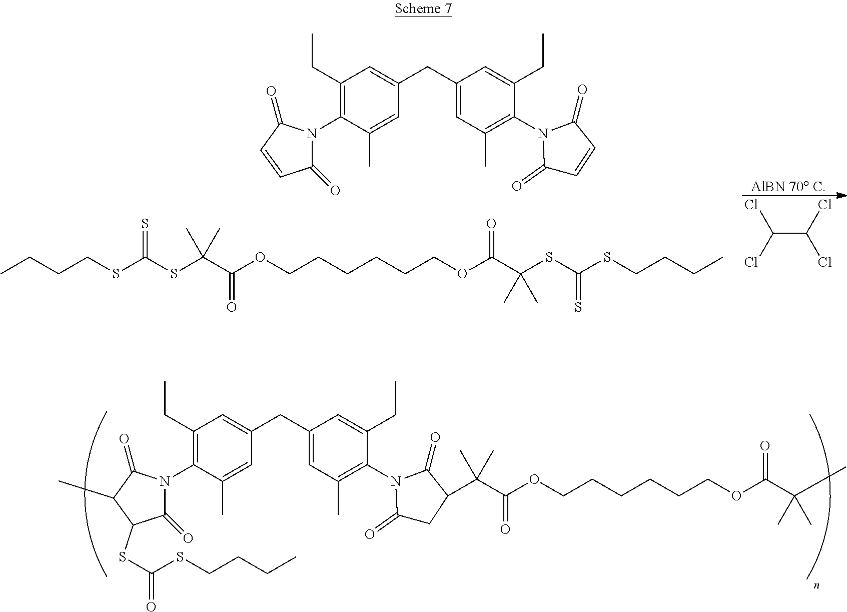

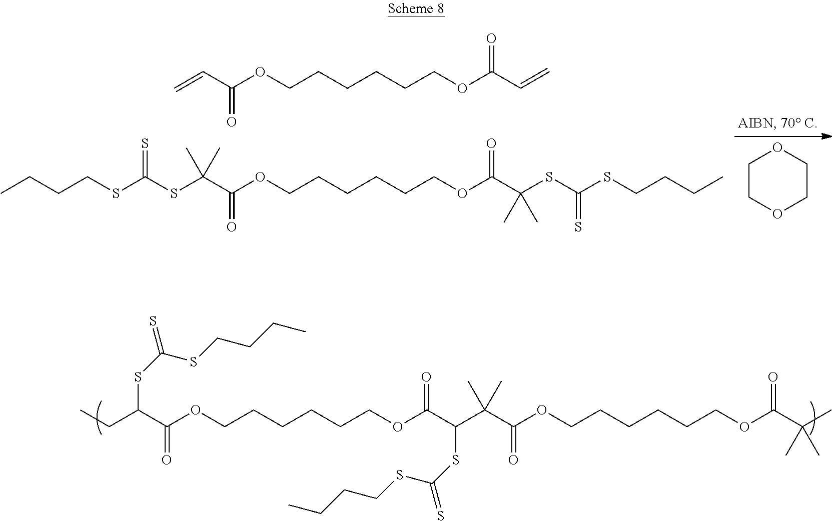

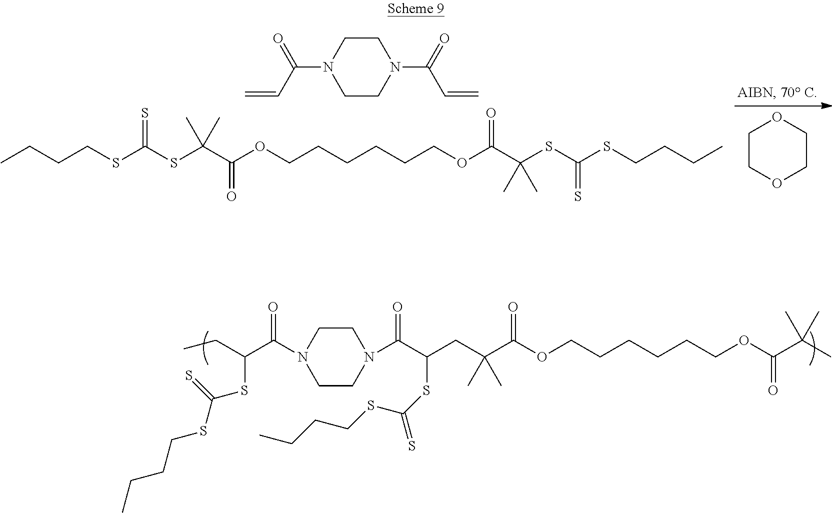

and also includes Scheme 20, disclosed elsewhere herein.

In certain embodiments, brush polymers are produced by grafting, including the following non-limiting examples using acrylates, acrylamides and styrene, respectively:

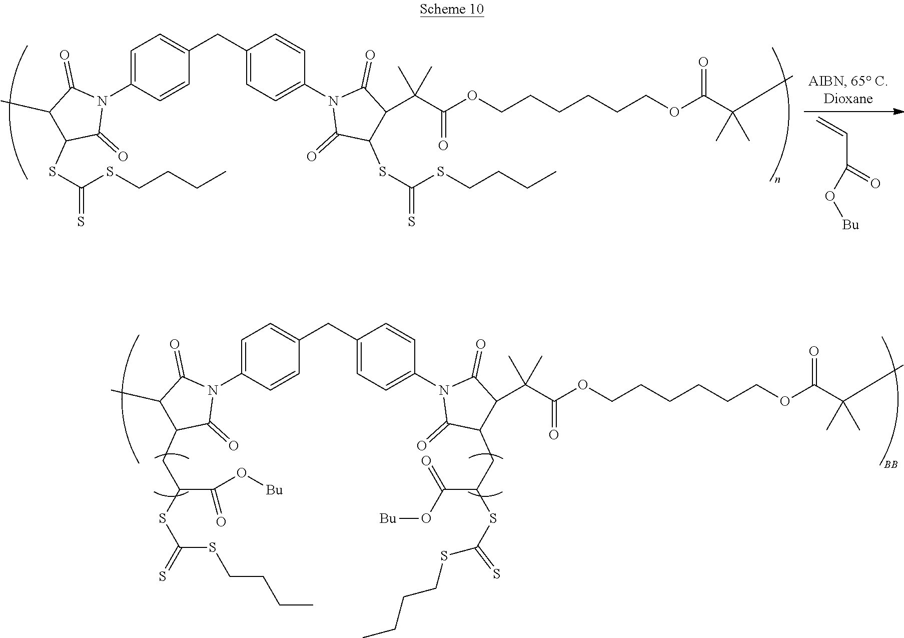

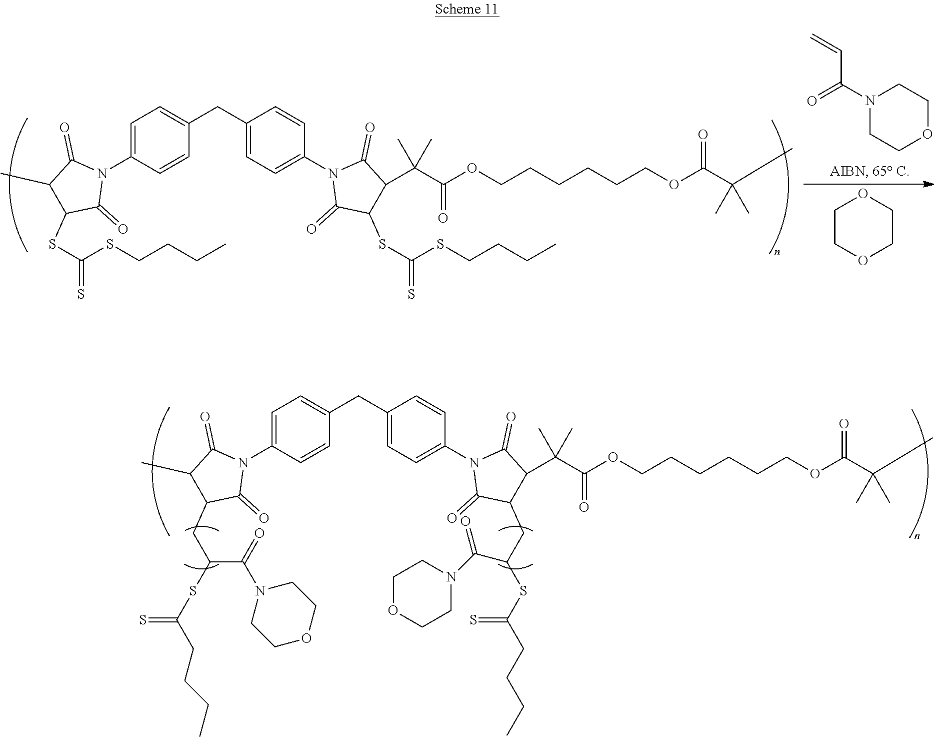

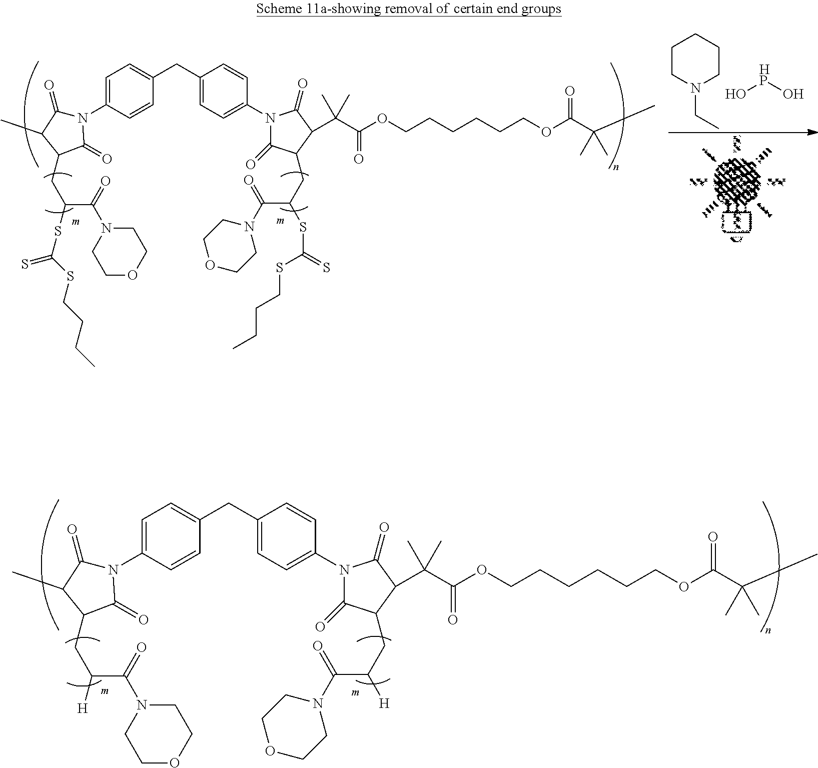

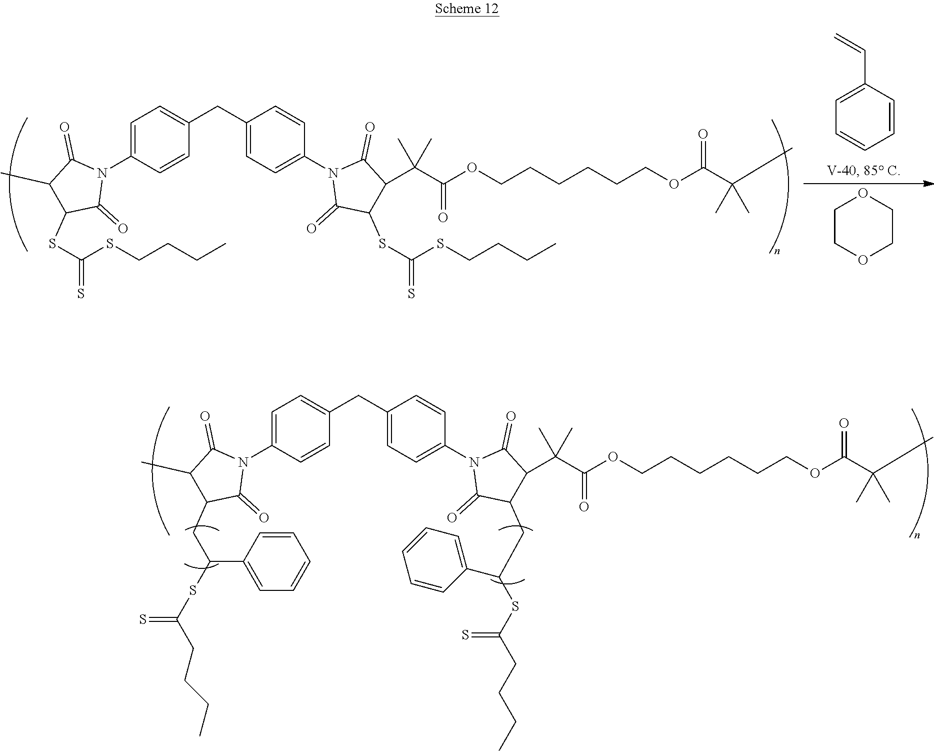

Without being bound to theory, in certain embodiments, the RAFT step-growth polymerization (both AB (Formula I adducts) and A2+B2 (Formula B-1 adducts)) can proceed by a cycle of monomer addition (kₗ) to the R• at the chain end forming a mid-chain radical (-RM•-), followed by chain transfer to reform the R• radical. In addition, preventing monomer propagation (kᵣ) is a consideration to prevent undesirable high molecular weight branching. To achieve this selectivity, generally there are two main considerations (Scheme 13).

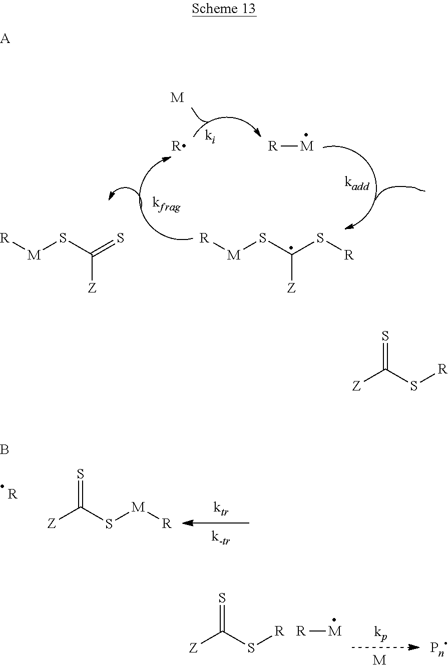

Firstly, the relative rate of forward fragmentation kₜᵣ is to be significantly more rapid than monomer propagation kₚ (kₜᵣ>kₚ), which is dependent on the M• reactivity with another monomer vs. R-group bearing the RAFT agent. Secondly, the rate of forward exchange should be significantly more rapid than the reverse exchange (kₜᵣ>>k₋ₜᵣ), which is determined by the difference between the relative M• (monomer radical) and R• (fragmented R-group radical) stability (Scheme 13). In addition, this will determine an equilibrium limit of the polymerization, as the rate of forward fragmentation exchanges becomes equal with the rate of reverse fragmentation (eq 1). Rearranging (eq 1) gives the equilibrium equation (eq 2), indicating that the step-growth selectivity becomes limited by chain transfer equilibrium (Kₜᵣ, in eq 2).

$${k}_{- tr} [ M - CTA ] [ R ] = {k}_{tr} [ R - CTA ] [ M ] \qquad ( 1 )$$

$${K}_{tr} = \frac{{[ M - CTA ]}_{eq}}{{[ R - CTA ]}_{eq}} = \frac{{k}_{tr}}{{k}_{- tr}} = \frac{{k}_{add} {k}_{β}}{{k}_{- add} {k}_{- β}} \qquad ( 2 )$$

$$DP = \frac{1}{1 - p} \qquad ( 3 )$$

$$- \frac{{d [ M ]}_{t}}{dt} = {k}_{i} [ M ] [ R ] \qquad ( 4 )$$

In addition to the requirement of selectivity for chain transfer to achieve step-growth, it is strongly desirable for the polymerization to occur at a rapid rate, as high monomer conversions (p) is required to obtain appreciable degree of polymerization (DP) by step growth polymerization according to the Carothers equation (eq 3).

Without being bound to theory, the addition of R• with monomer end group forming R-M• species can be the rate limiting step (kᵢ in Scheme 13). Therefore the polymerization would follow first-order dependence with respect to monomer concentration with a rate constant, kᵢ when concentration of R• species is constant (eq 4). The rate thus becomes dependent on relative difference in radical stabilization between R• and M• species (Scheme 13).

Assuming that under a rapid chain transfer, the rate of formation of R• is equal to the rate of I-M• formed from the initiation step by the initiator (Scheme 14), which is dependent on the decomposition rate of initiator (k_{d}) and initiation efficiency (f) (Scheme 14). From the steady state approximation (rate of termination=rate of initiation, eq 5), it can be further assumed that the concentration of M• radical species to have a half order rate dependence with respect to initiator concentration (eq 6). Therefore, at relatively low initiator consumption, the generation of M• is approximately constant, pseudo-first order kinetics is observed for RAFT step-growth polymerization using free radical initiators (eq 7), until the initiation efficiency (f) lowers at high monomer conversion.

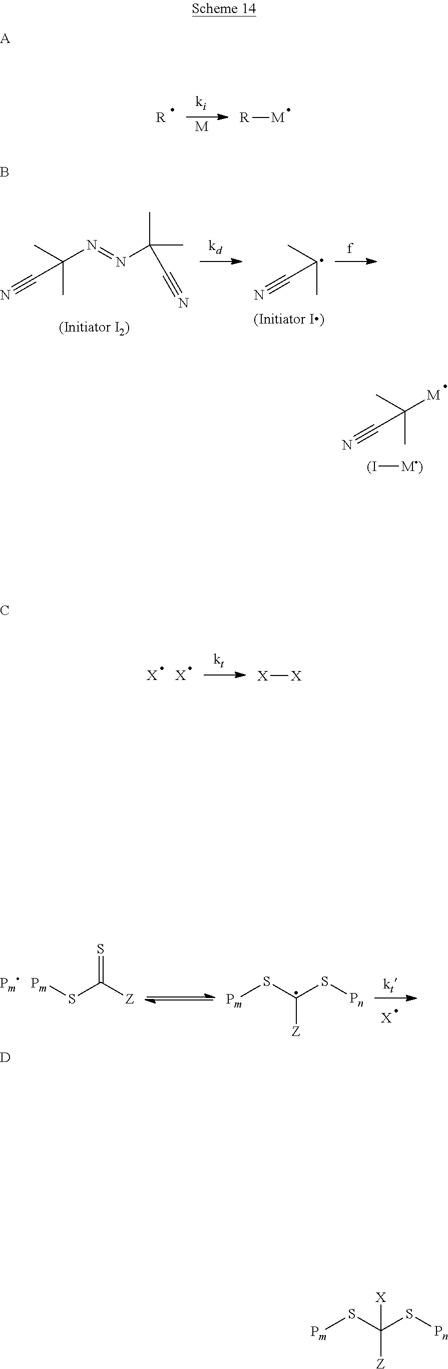

$$2 {k}_{d} f [ I ] = 2 {{k}_{t} [ M ]}^{2} \qquad ( 5 )$$

$$[ M ] = \sqrt{\frac{{k}_{d} f [ I ]}{{k}_{t}}} \qquad ( 6 )$$

$${R}_{p} \approx {k}_{i} [ M ] \sqrt{\frac{{k}_{d} f [ I ]}{{k}_{t}}} \qquad ( 7 )$$

$${R}_{p} ∝ \sqrt{\frac{{k}_{d} f [ I ]}{{k}_{t} + {k}_{t}^{′} {K}_{int} [ CTA ]}} \qquad ( 8 )$$

$$[ X ( {ZCS}_{2} ) [ M ] = {K}_{int} [ X ( {ZCS}_{2} ] M ] \qquad ( 9 )$$

$$DP = \frac{1 + r}{1 + r - 2 rp} \qquad ( 10 )$$

Another consideration is that although active Z-group is crucial for step-growth selectivity to mediate rapid chain transfer exchange (kₜᵣ>>kₚ), active Z-groups may also result in retardation due to termination (kₜ′ in Scheme 14D) of the stabilized chain transfer intermediate, which is known to occur in traditional RAFT chain-growth polymerization (eq 8), where the rate depends on the equilibrium of chain transfer intermediate adduct (Kᵢₙₜ) (eq 9). Consequently, using an active Z-group to promote the chain transfer exchange and R-group with higher R• radical stability than M• to favor chain transfer equilibrium may be preferable or required for RAFT step-growth selectivity. However, both factors may have negative consequences in the overall rate of polymerization, as higher R• stability will result in lower rate of monomer addition (kᵢ) and, more active Z-group may lead to retardation as observed for traditional chain-growth RAFT polymerization. Yet another consideration is that one of the consequences of using external radical initiators is the sacrificial consumption of the monomer end groups (Scheme 15); the resultant imbalanced stoichiometry between monomer and RAFT agent may limit DP obtainable by RAFT step-growth polymerization according to the general Carothers equation (eq 10).

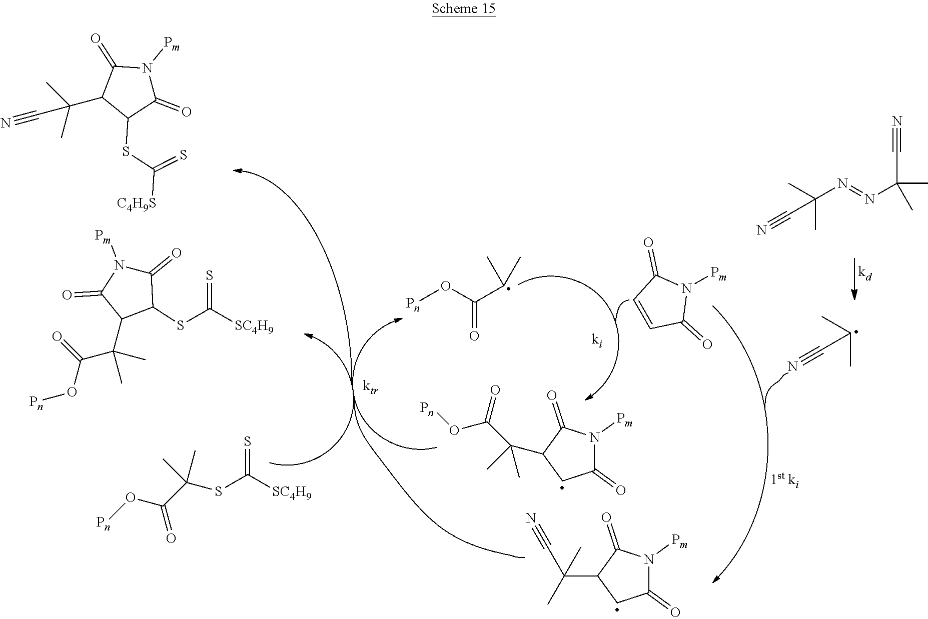

Acrylates are fast homopropagating monomers, which can pose a technical problem for RAFT step-growth polymerization compared to relatively slow homopropagating monomers. That is, acrylates have a relatively high kₚ. Scheme 16 depicts a proposed mechanism of RAFT step-growth polymerization. Specifically, the R• (fragmented CTA end group species) adds to the monomer end group (M) to generate the R-M• (kᵢ), which can react with R-group bearing CTA species (k_{add}) to form the chain transfer intermediate adduct. Fragmentation of this intermediate (k_{frag}) regenerates the R• and concurrently appends CTA to the backbone repeat unit. However, branching would occur if R-M• reacts with additional monomer species, which is dictated by the homopolymerization rate of the monomer (kₚ). To limit this occurrence, monomers with low kₚ were chosen (maleimides and vinyl ether). Up until now, more reactive monomers such as acrylates that have higher kₚ have not been explored for RAFT step-growth polymerization. The reaction in the shaded box is undesirable homopolymerization.

As described herein, in embodiments, RAFT step-growth polymerization is achieved with acrylates using a suitable CTA where k_{add} outweighs kₚ.

Following completion of the polymerization, the polymer can be isolated by stripping off the medium and unreacted monomer(s) or by precipitation with a non-solvent. Alternatively, the polymer solution/emulsion can be used as such, if appropriate to its application. Other suitable isolation/purification techniques are well known in the art. The photoredox catalyst may be removed during this isolation and/or purification procedure. The photoredox catalyst may also be recovered during the purification step. The recovered catalyst may then be reused in further polymerizations.

Following isolation, the resultant polymer may be further reacted to, for example, add additional functionality or modify the end-groups of the polymer chain. Techniques for such modifications are known in the art as for traditional polymers produced by RAFT polymerization.

The General Procedures and Examples provide exemplary methods for preparing compounds, copolymers and compositions. Those skilled in the art will appreciate that other synthetic routes may be used to synthesize the compounds. Although specific starting materials and reagents are depicted and discussed in the Schemes, General Procedures, and Examples, other starting materials and reagents can be easily substituted to provide a variety of derivatives and/or reaction conditions. In addition, many of the exemplary compounds prepared by the described methods can be further modified in light of this disclosure using conventional chemistry well known to those skilled in the art.

The following examples are offered by way of illustration and not by way of limitation.

### EXAMPLES

### Materials and Methods

Unless stated all reagents were purchased from commercial suppliers and used as received. Azobisisobutyronitrile (AIBN) was recrystallized with methanol. Butyl acrylate (BA) and anhydrous dioxane were passed through activated basic aluminum oxide and discarded after several uses. All NMR spectrums were recorded on a Bruker 400 MHz spectrometer in CDCl₃. All NMR spectrums were processed using Mestrenova. General procedure for RAFT-Step-growth polymerization.

Solvent (including initiator stock solution) is measured by weight based on the reported density (Dioxane=1.03 g/mL) to target specified volume. Initiator (AIBN) stock solution was prepared as 20 mg/ml in dioxane. For simplicity, molar concentration of the reacting species here is defined by moles of the reactants divided by the total volume of the solvent. All experiments were carried out in 3.7 ml scintillation vials with outer dimensions of 15 mm and secured with a 14/20 rubber. Coming PC-420D equipped with coming 6795PR external temperature controller was used to maintain constant temperature of heat block and oil, which was equilibrated prior to the experiment. 22-gauge, 4 inch hypodermic needle (air-tite product) was used for sample reaction mixture under argon flow. Typically, a single needle and syringe was used to take sample for both THF-SEC and ¹H-NMR spectroscopy per aliquot, by drawing out approximately 50 to 100 μL and dropping a few drops into a vial for NMR and the remaining mixture left in the needle was flushed out with THE in a separate vial for SEC analysis. Monomer conversion was determined by ¹H-NMR spectroscopy by integrating CH═CH maleimide ring proton(s) were measured relative to CH₃ at 0.96 ppm on the Z-group of the CTA to determine monomer conversion. Here satellite peaks were omitted from the analysis, as a result integration of CH═CH maleimide ring protons are underestimated (typically 4-5% lower), relative to the Z-group. Nonetheless, in all cases the relative monomer consumption ([M]t/[M]₀) was calculated relative to the value measured at t=0 to determine the extent of the reaction (p). For purification, RAFT step-growth polymers were precipitated directly into 50 ml centrifuge tube with diethyl ether and collected with centrifugation. After discarding the supernatant, the polymers were redissolved in acetone and then reprecipitated again in diethyl ether. Typical yields of 50% are obtained.

Characterization of Molecular weight distribution—Conventional SEC analysis of the crude polymerization mixture was carried out using polystyrene calibration in THE with calibration range of molecular weight from 195 k to 270. These were measured using Waters 2695 separations module liquid chromatograph equipped with two Agilent ResiPore columns (linear SEC separation range up to 500 k) maintained at 35° C., and a Waters 2412 refractive index detector. THE (without additives) was used as the mobile phase and the flow rate was set to 1 mL/min. All the samples were run with 100 μL injection volume. The dRI response was measured from the start of the peak (at low retention time) down to the high retention time corresponding to the initial species (M₀) at t=0.

Mark-Houwink analysis and absolute molecular weight analysis were carried out using multidetector detector GPC system (RI, LS, VS). These were measured using Agilent 1260 infinity Series (Degasser, Isocratic pump, Autosampler) and Wyatt Technology Corporation detectors (Dawn Hellos—11 18 angle MALS detector, Viscostar-II viscometer, Optilab T-rEX differential refractive index detector) equipped with 3× PLGel-Mixed-BLS (linear SEC separation range of molecular weight from 10 M to 500) and 10 μm PLgel guard column. THE (with BHT stabilizer) was used as the mobile phase and the flow rate was set to 1 mL/min. All the samples were run with 100 μL injection volume. In this study, scattering angles of 64.0° and 117.0° were used. dn/dC of the polymer samples in THE were determined by the instrument assuming 100% mass recovery. For polyMCTA, poly(M₂-alt-CTA2) and poly(MCTA-g-PBA₁₅) dn/dC of 0.1471, 0.1331, 0.0727 were measured respectively.

Theoretical number-average molecular weight (M_{n,th}), weight-average molecular weight (M_{w,th}) and Z-average molecular weight (M_{z,th}) with respect to monomer conversion, p was calculated as described by Flory for linear step-growth polymerization (P. J. Flory, JACS, 58, 1877-1885 (1936):

$${M}_{w , th} = {M}_{0} \frac{1}{1 - p} \qquad ( Eq . S 1 )$$

$${M}_{w , th} = {M}_{0} \frac{1 + p}{1 - p} \qquad ( Eq . S 2 )$$

$${M}_{z , th} = {M}_{0} \frac{1 + 4 p + {p}^{2}}{( 1 - {p}^{2} )} \qquad ( Eq . S 3 )$$

For clarity, M₀ is the molecular weight of AB monomer (MCTA) or average molecular weight of A₂ and B₂ comonomers (M₂ and CTA₂). These above equations (S1-S3) describe molecular weight averages for step-growth polymerization with balanced stoichiometry. Flory has also described M_{n,th} for A₂+B₂ type step growth polymerization with imbalanced stoichiometric ratio of the two reagents (r=[A₂]₀/[B₂]₀):

$${M}_{n , th} = {M}_{0} \frac{1 + r}{1 + r - 2 rp} \qquad ( Eq . S 4 )$$

Here, stoichiometric ratio, r (≤1) is the initial molar ratio of Monomer and CTA functional groups (r=[M]₀/[CTA]₀), is defined monomer as the limiting reagent. For M_{w,th} and M_{z,th} with imbalanced stoichiometry, summation of different distribution functions that describes the specific end group species would be required to truly determine the respective average-molecular weights (Flory (1936)). For simplicity here we used the following approximation:

$${M}_{w , th} \approx {M}_{0} \frac{1 + {r}^{1 / 2} p}{1 - {r}^{1 / 2} p} \approx {M}_{0} ( 1 + p ) \frac{1 + r}{1 + r - 2 rp} \qquad ( Eq . S5 )$$

$${M}_{z , th} \approx {M}_{0} \frac{1 + 4 {r}^{1 / 2} p + {( {r}^{1 / 2} p )}^{2}}{( 1 - {( {r}^{1 / 2} p )}^{2} )} \approx {M}_{0} \frac{1 + 4 p + {p}^{2}}{( 1 + p )} \frac{1 + r}{1 + r - 2 rp} \qquad ( Eq . S6 )$$

On the left-hand side (LHS) of the both equations (Eq S5, Eq S6), M_{w,th} and M_{z,th} are approximated by replacing p in Eq S2 and Eq S3 with r^{1/2}p. Alternatively M_{w,th} and M_{z,th} can be approximated by dividing Eq S2 and Eq S3 with Eq Si, then multiplied by S4 as shown on the right-hand side (RHS) of the two equations (Eq S5, Eq S6) (T. Gegenhuber, et al., Macromolecules, 50, 6451-6467 (2017)). We emphasize that Flory's equations assume equal monomer reactivity and describes molecular weight distribution of the crude reaction mixture without taking cyclization into account.¹ Cyclization during step-growth will results in species with no end groups for further growth, as a result, this will typically lower the number-average molecular weight (Mₙ) significantly below the expected values. In contrast, this will make smaller impact on M_{w} and negligible impact on M_{z} as higher molecular weight species are accounted more.

Theoretical approximation of overall imbalance stoichiometry with initiator consumption—Without considering radical termination events, theoretical imbalanced stoichiometry, rₜₕ, from external radical initiator used to initiate the RAFT step-growth cycle, is approximated using the following equation:

$${r}_{th} = \frac{{[ M ]}_{0}}{{[ CTA ]}_{0} + 4 f ( {[ I ]}_{0} - {[ I ]}_{t} )} \qquad ( Eq . S 7 )$$

The factor “4” accounts for two radicals generated from one molecule of azo initiator with efficiency f, to react with a monomer with equal reactivity to CTA. As the reaction with a single initiating radical results in loss of a monomer end group, it effectively has the same quantitative effect in limiting the molecular weight as two species of the excess bifunctional reagent (Odian, G., Step Polymerization. In Principles of Polymerization, 2004; pp 39-197), therefore resulting in overall factor of 4. Here we assume a constant initiator efficiency f, with a constant value of 0.65 for AIBN to escape the “cage” effect to generate radicals, which is the recommended value for azo-initiators by Moad. (G. Moad, Prog. Polym. Sci., 88, 130-188 (2019). The initiator remaining is calculated for specific time, t, with first-order decay with rate constant, k_{d}:

$${[ I ]}_{t} = {[ I ]}_{0} {e}^{- {k}_{d} t} \qquad ( Eq . S 8 )$$

The decomposition rate (k_{d}) of AIBN at 70° C. k_{d} was estimated to 0.135 hr⁻¹ or 3.74×10⁻⁵ s⁻¹ from the Arrhenius equation, using activation energy of 132400 Jmol⁻¹ and pre-exponential factor determined as 5.43×10¹⁵ for AIBN from 10 hr half-life temperature of 65° C. [I]ₜ in Eq. S8 can be substituted in Eq. S7. In addition, Eq. S8 can be expressed with the targeted imbalanced stoichiometry using excess bifunctional CTA, (r=[M]₀/[CTA]₀) and initial concentration of initiator to monomer functional group ratio ([I]₀/[M]₀) by diving the denominator and numerator with [M]₀. Thus Eq. S7 can be expressed as:

$${r}_{th} = \frac{1}{\frac{1}{r} + 4 f \frac{{[ I ]}_{0}}{{[ M ]}_{0}} ( 1 - {e}^{- {k}_{d} t} )} \qquad ( Eq . S 9 )$$

Limitations—It is worth noting, the initiation efficiency, f is expected fall particularly at high monomer conversion, therefore when the reaction is left for longer period after the polymerization reaches high monomer conversion (Moad (2019), therefore resulting in overestimation of imbalanced stoichiometry. In particular the shortcoming of constant value of f (0.65) is evident when the predicted M_{w,th}falls as the reaction proceeds instead of increasing with conversion. To account for this, we recommend using rₜₕ values calculated at earlier time points, assuming initiation efficiency falls at high conversion.

### Monomer and CTA Synthesis

CTA_{1C} was prepared according to literature (C. Bray, et al., Polym. Chem., 8, 5513-5524 (2017)). Starting material SM2 to SM3 were prepared according following two separate sources (Y. Jiang, et al., J. Materials Chem. B, 4, 2017-2027 (2019); Z. Wang, et al., Chem. Commun., 55, 12263-12266 (2019)

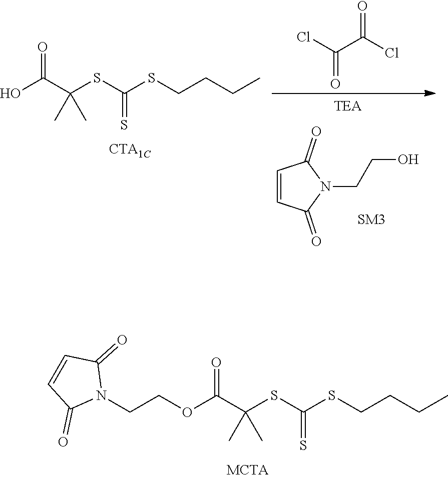 [SMILES: CCCCSC(=S)SC(C)(C)C(=O)O ; O=C(Cl)C(=O)Cl ; O=C1C=CC(=O)N1CCO ; CCCCSC(=S)SC(C)(C)C(=O)OCCN1C(=O)C=CC1=O]

Oxalyl chloride (25 ml, 0.2915 mol) was slowed added via syringe to a sealed Round-Bottom Flask with CTA_{1C} (7.2 g, 0.0287 mol) with continuous stirring, cooled on ice, under argon flow. The mixture was then stirred for 4 hours at room temperature with continuous argon flow to expel HCl gas. The excess oxalyl chloride was then removed under reduced pressure, to yield acid chloride adduct as an orange oil. This was then redissolved in anhydrous DCM (20 ml), then placed on an ice bath with continuous argon flow. Separate anhydrous DCM solutions of 20 ml with triethylamine (3.18 g, 0.0314 mol), and 100 ml of suspended solution of SM3 (6.04 g, 0.0429 mol) were prepared and simultaneously added, and any undissolved SM3 remaining was flushed through with an additional 100 ml of DCM. Note, the solubility of SM3 in DCM varies depending on the purity. The reaction mixture was then warmed to room temperature and then left stirring for 2 hours. The reaction mixture was directly purified by flash column chromatography (SiO₂, 200 g) using DCM as eluent. After removing the solvent, the orange oil was recrystallized twice from ethyl acetate with hexane to yield fluffy MCTA as fluffy yellow crystals. Maximum yield of 6.91 g, 65% yield was obtained. Alternative esterification's of SM3 using DMAP, results in poor yields, due to undesirable side reaction. ¹H-NMR (CDCl₃, 400 MHz, ppm): 6 6.68 (s, 2H), 5.29 (s, 1H), 4.22 (t, J=5.3 Hz, 2H), 3.80 (t, J=5.3 Hz, 2H), 3.22 (t, J=7.5 Hz, 2H), 1.62 (m, 8H), 1.39 (m, 2H), 0.91 (t, J=7.4 Hz, 3H). ¹³C-NMR (CDCl₃, 400 MHz, ppm): 6 172.91, 170.38, 134.12, 62.99, 55.89, 36.76, 36.60, 29.92, 25.27, 22.21, 13.72

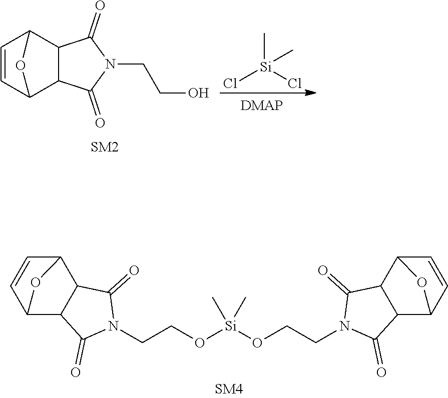

SM2 was suspended in anhydrous dichloromethane (100 ml) with triethylamine (3.870 g, 38.24 mmol), and DMAP (11.21 mg, 0.092 mmol), which was cooled in an ice bath. Dichlorodimethylsilane (2.369 g, 18.36 mmol) was added dropwise to the mixture over 4 hours and then left at room temperature for 12 hours. Subsequently the reaction mixture was washed twice with 0.1 M HCl and brine to remove salts of the triethylamine. The organic layer was dried with magnesium sulfate and the solvent was removed under reduced pressure and washed with hexanes. The resulting crude was found to be a mixture of SM4 and SM2, next step was proceeded without further purifications.

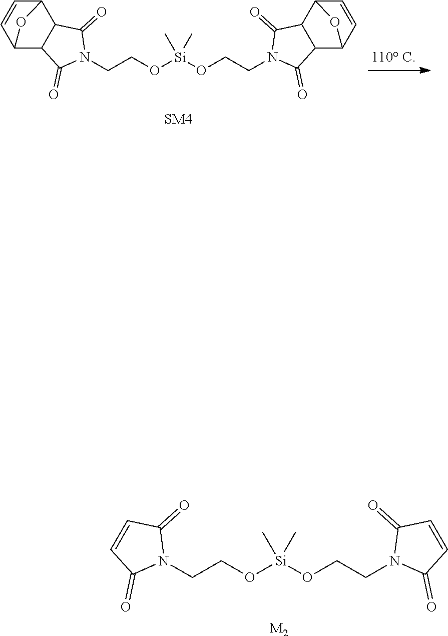 [SMILES: C[Si](C)(OCCN1C(=O)C2C3C=CC(O3)C2C1=O)OCCN1C(=O)C2C3C=CC(O3)C2C1=O ; C[Si](C)(OCCN1C(=O)C=CC1=O)OCCN1C(=O)C=CC1=O ; "M2"]

SM4 was heated at 110° C. for 8 hours under argon flow in toluene (500 ml) using a 2 necked round bottom flask. Reaction was continually monitored to refill with toluene. Subsequently the reaction mixture was initially cooled before removing the solvent under reduced pressure. The crude solid was redissolved in DCM and washed three times with brine to remove the deprotected maleimide alcohol from the unreacted alcohol in the initial step. The organic layer was dried with magnesium sulfate and the solvent was removed under reduced pressure to yield M2 as white solid (1.6 g, 35% yield). 1H-NMR (CDCl3, 400 MHz, ppm): δ 6.71 (s, 4H), 3.77 (t, J=5.8 Hz, 4H), 3.66 (t, J=5.8 Hz, 4H), 0.04 (s, 6H). 13C-NMR (CDCl3, 400 MHz, ppm): δ 170.84, 134.26, 59.46, 39.90, −3.32.

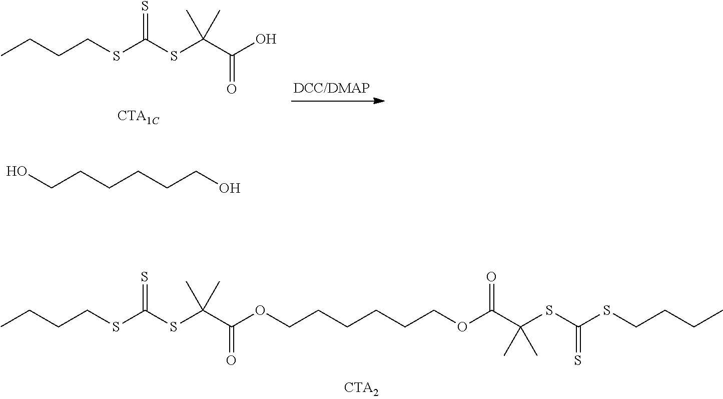 [SMILES: CCCCSC(=S)SC(C)(C)C(=O)O ; OCCCCCCO ; CCCCSC(=S)SC(C)(C)C(=O)OCCCCCCOC(=O)C(C)(C)SC(=S)SCCCC]

CTA_{1C} (7.2 g, 0.0287 mol) and hexanediol (1.53 g, 0.0129 mol) was charged into dry round bottom flask followed by anhydrous dichloromethane (100 ml) and stirrer bar. This was then cooled to −10° C. whilst purging under argon. 4-Dimethylaminopyridine (0.35 g, 1.29 mmol) was added and the reaction mixture was left for 10 minutes before adding N,N′-Dicyclohexylcarbodiimide (6.51 g, 0.032 mol). After 4 hours, the mixture was passed through a short flash column (SiO2, 200 g) with dichloromethane as the eluent, batch collecting only the first yellow fraction, yielded crude oil with unreacted DCC. This was then redissolved in DCM (50 ml) and treated with acetic acid (1 ml, 0.031 mol) overnight before passing through a second flash column (SiO2, 200 g) with DCM as the eluent to yield CTA2 as a yellow oil (3.36 g, 40%). 1H-NMR (CDCl3, 400 MHz, ppm): δ 4.07 (t, J=6.5 Hz, 4H), 3.27 (t, J=7.5 Hz, 4H), 1.68 (s, 12H) 1.62 (m, 8H), 1.41 (m, 4H), 1.33 (m, 4H) 0.92 (t, J=7.3 Hz, 6H). ¹³C-NMR (CDCl3, 400 MHz, ppm): δ 173.16, 66.08, 56.10, 36.69, 30.07, 28.41, 25.72, 25.51, 22.23, 13.79

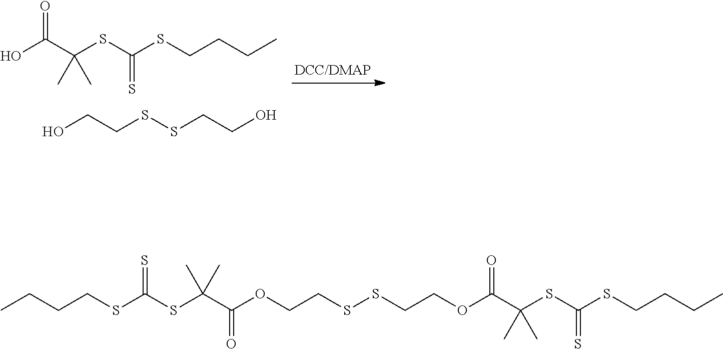

Procedure for Synthesis of CTA_{2SS}: 2-(((butylthio)carbonothioyl)thio)-2-methylpropanoic acid) (15.00 g, 0.0595 mol, 2.6 eq), 2-hydroxyethyl disulfide (3.525 g, 0.0229 mol. 1 eq), and anhydrous dichloromethane were charged into a round bottom flask equipped with a stir bar. 4-Dimethylaminopyridine (0.2793 g, 2.289 mmol, 0.1 eq) was added to the flask, followed by N,N′-dicyclohexylcarbodiimide (11.32 g, 0.05495 mol, 2.4 eq), and the reaction was left to stir overnight. The mixture was purified via flash column chromatography (SiO₂) using DCM as the eluent. The first yellow fraction was collected, and the solvent was removed by rotary evaporation, yielding orange oil (12.00 g, 84% yield).

General Backbone Polymerization: Bifunctional Monomer, M_{2A} (300 mg, 1.326 mmol) was first charged into the vial, followed by bifunctional CTA, CTA₂ (778.22 mg, 1.326 mmol), which was carefully added via 1 ml syringe with 21 gauge needle. Next, 782 μL of 1,4-dioxane and 544 μL of AIBN stock solution (20 mg/ml of AIBN in 1,4-dioxane) were added to the vial, targeting a molar concentration of [M_{2A}]₀:[CTA_{2A}]₀:[AIBN]₀=0.5:0.5:0.05 M. The solution was sealed with a rubber septum, degassed with argon for 10 minutes, and then placed on a heat block at 70° C. for 4 hours to react.

General Brush Polymerization Procedure: Polymer backbone, poly(M_{2A}-alt-CTA₂) (62.1 mg, 0.15 mmol of CTA repeat units) was first charged into the vial, followed by Butyl acrylate (750 mg, 5.82 mmol), which was carefully added via 1 ml syringe with 21 gauge needle. Next, 1078 μL of 1,4-dioxane and 30.03 μL of AIBN stock solution (20 mg/ml of AIBN in 1,4-dioxane) were added to the vial, targeting a molar concentration of [M]₀:[CTA]₀:[AIBN]₀=3:0.075:0.001875 M. The solution was sealed with a rubber septum, degassed with argon for 10 minutes, and then placed on a heat block at 70° C. for 4 hours to react.

### Example 1. AB RAFT Step-Growth

### Procedure 1:

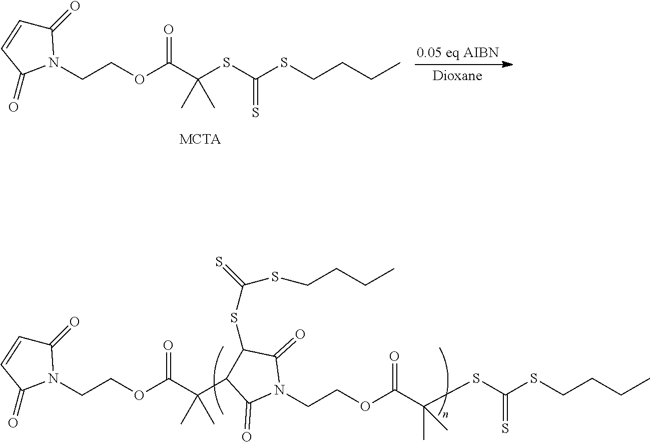

MCTA (500 mg, 1.331 mmol) was charged into a vial followed by 0.785 ml dioxane and 0.546 ml AIBN stock solution (20 mg/ml in dioxane) was added to target molar concentration of [MCTA]0:[AIBN]0=1 M:0.05 M. The vial was then equipped with a stirrer bar and rubber septum; the solution was then purged with argon for 10 minutes and then heated at 70° C. for 4 hours (FIG. 7). Monomer conversion was measured by integrating both unreacted monomer peak and upfield shifted macromonomer peak (FIG. 7).

TABLE S1
MCTA polymerization

| Time | | | | | | | |
|---|---|---|---|---|---|---|---|
| (hr) | p | rₜₕ | M_{w, th} | M_{w, th}(rₜₕ) | M_{w} | M_{w}/Mₙ | M_{z}/M_{w} |
| 0 | 0 | 1.00 | 380 | 380 | 250 | 1.02 | 1.03 |
| 0.5 | 0.53 | 0.992 | 1200 | 1200 | 770 | 1.55 | 1.48 |
| 1.0 | 0.81 | 0.984 | 3500 | 3400 | 1800 | 1.96 | 1.69 |
| 1.5 | 0.91 | 0.977 | 7600 | 6800 | 3200 | 2.49 | 1.89 |
| 2.0 | 0.94 | 0.970 | 13k | 10k | 5000 | 3.33 | 2.44 |
| 2.5 | 0.965 | 0.964 | 21k | 14k | 5900 | 3.55 | 2.15 |
| 3.0 | 0.973 | 0.959 | 28k | 16k | 6900 | 4.07 | 2.45 |
| 3.5 | 0.981 | 0.953 | 39k | 17.5k | 8300 | 4.62 | 2.38 |
| 4.0 | 0.985 | 0.949 | 49k | 18k | 9900 | 5.28 | 2.61 |

*Stochiometric imbalance overestimated with initiation efficiency, f = 0.65.
**Theoretical imbalanced stoichiometry (rₜₕ) after 4 hours (p ≈ 0.99) is used to calculate M_{w, th}(rₜₕ).

### Example 2. A₂+B₂ RAFT Step-Growth

### Procedure 2:

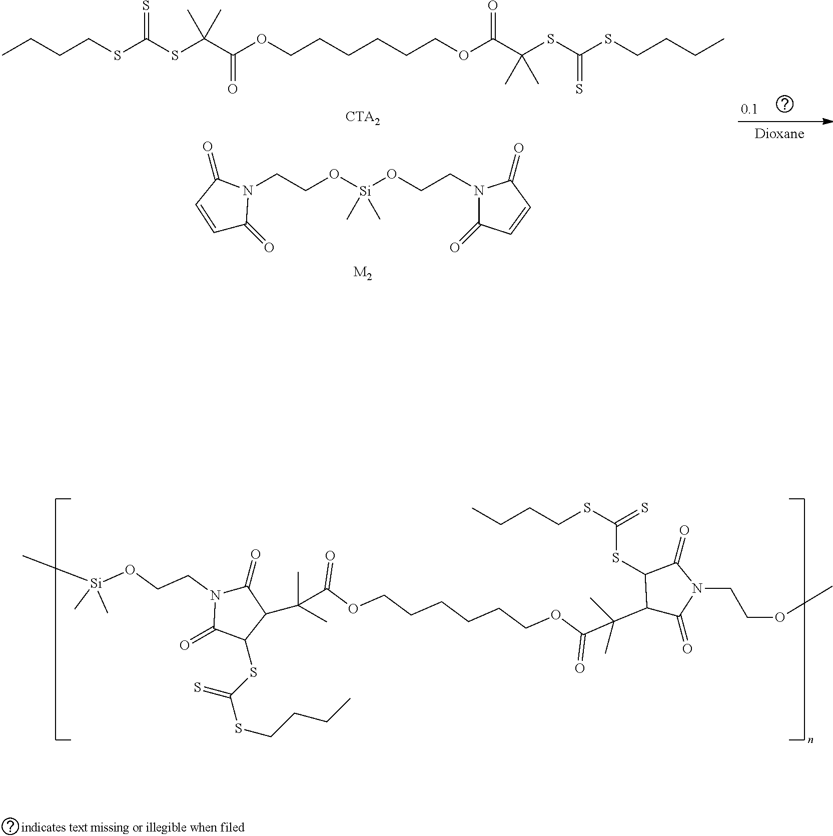

Bifunctional monomer, M₂ (350 mg, 0.103 mol) was first charged into the vial, followed by bifunctional CTA, CTA₂ (607.1 mg, 0.103 mmol) carefully added via 1 ml syringe with 21 g needle. Next, 1.219 ml dioxane and 0.849 ml AIBN stock solution (20 mg/ml in dioxane) to target molar concentration of [M₂]₀:[CTA₂]₀:[AIBN]₀=0.5:0.5:0.05 M. The vial was then equipped with a stirrer bar and rubber septum; the solution was then purged with argon for 10 minutes and then heated at 70° C. for 4 hours.

TABLE S2
M₂ + CTA₂ copolymerization with balanced stoichiometry

| | Time | | | | | | M_{w}/ | M_{z}/ |
|---|---|---|---|---|---|---|---|---|
| r | (hr) | p | rₜₕ | M_{w, th} | M_{w, th}(rₜₕ) | M_{w} | Mₙ | M_{w} |
| 1.00 | 0 | 0 | 1.000 | 460 | 460 | 510 | 1.04 | 1.03 |
| | 0.5 | 0.66 | 0.992 | 2300 | 2200 | 2200 | 1.75 | 1.65 |
| | 1.0 | 0.87 | 0.984 | 6700 | 6300 | 5600 | 2.48 | 1.75 |
| | 2.0 | 0.96 | 0.970 | 23k | 17k | 15k | 4.19 | 1.85 |
| | 3.0 | 0.979 | 0.959 | 42k | 21k | 23k | 5.95 | 2.03 |
| | 4.0 | 0.989 | 0.949 | 84k | 25k | 29k | 5.92 | 2.13 |

### Example 3. A₂+B₂ RAFT Step-Growth with Imbalanced Stoichiometry

We investigated copolymerization of M₂ and CTA₂ with varying comonomer ratios (r=[M₂]₀/[CTA₂]₀=1, 0.98, 0.96, 0.935, 0.818). Stoichiometric imbalance is introduced using excess of CTA₂, by keeping the combined concentration of the two bifunctional reagents concentration in procedure 2 constant ([M₂]₀+[CTA₂]₀=1 M) using the same intiator concentration ([AIBN]₀=50 mM).

### Procedure 3.1:

Procedure 2 was repeated with 500 mg of M₂, 888 mg of CTA₂, 24.8 mg of AIBN and 2.989 mL of dioxane, to target an imbalanced stoichiometric ratio: [M₂]₀/[CTA₂]₀=0.98

### Procedure 3.2:

Procedure 2 was carried out with 229.8 mg of M₂, 414.4 mg of CTA₂, 11.38 mg of AIBN and 1.386 mL of dioxane, to target an imbalanced stoichiometric ratio: [M₂]₀/[CTA₂]₀=0.96

### Procedure 3.3:

Procedure 2 was carried out with 80.9 mg of M₂, 150 mg of CTA₂, 4.06 mg AIBN and 0.495 mL dioxane, to target an imbalanced stoichiometric ratio: [M₂]₀/[CTA₂]₀=0.935

### Procedure 3.4:

Procedure 2 was carried out with 94.34 mg of M₂, 200 mg of CTA₂, 5.09 mg AIBN and 0.620 mL dioxane, to target imbalanced stoichiometric ratio: [M₂]₀/[CTA₂]₀=0.818

TABLE S3
M₂ + CTA₂ copolymerization with varying r = [M₂]₀/[CTA₂]₀

| | Time | | | | | | M_{w}/ | M_{z}/ |
|---|---|---|---|---|---|---|---|---|
| r | (hr) | p | rₜₕ | M_{w, th} | M_{w, th}(rₜₕ) | M_{w} | Mₙ | M_{w} |
| 0.98 | 0 | 0 | 0.980 | 460 | 460 | 490 | 1.04 | 1.04 |
| | 0.517 | 0.38 | 0.972 | 1000 | 1000 | 970 | 1.35 | 1.41 |
| | 1.1 | 0.65 | 0.963 | 2100 | 2100 | 1950 | 1.65 | 1.61 |
| | 2.1 | 0.88 | 0.950 | 6700 | 6100 | 5900 | 2.47 | 1.75 |
| | 4.1 | 0.975 | 0.929 | 26k | 15k | 12.4k | 3.66 | 1.83 |
| 0.96 | 0 | 0 | 0.960 | 460 | 460 | 410 | 1.05 | 1.03 |
| | 1.0 | 0.80 | 0.945 | 3900 | 3700 | 2600 | 1.89 | 1.66 |
| | 2.0 | 0.92 | 0.932 | 8700 | 7700 | 4500 | 2.32 | 1.72 |
| | 4.0 | 0.972 | 0.912 | 19k | 12.5k | 11.4k | 4.13 | 1.87 |
| 0.935 | 4.0 | 0.983 | 0.881 | 18.3k | 11.6k | 8k | 3.08 | 1.77 |
| 0.818 | 4.0 | 0.983 | 0.780 | 7950 | 6600 | 5200 | 2.67 | 1.75 |

### Example 4. Investigating Reaction Conditions for AB RAFT Step-Growth Polymerization

We investigated the effect of varying the initial MCTA concentration ([MCTA]₀=2, 0.5, 0.25 M) using either initiator equivalence of 0.05 ([MCTA]₀/[AIBN]₀=20) or initiator concentration of 0.05 M ([AIBN]₀=0.05 M).

### Procedure 4.1

300 mg of MCTA, 9.76 mg of AIBN and 0.594 mL of dioxane was charged into 3.7 ml scintillation vial to target [MCTA]₀=2 M, [MCTA]₀/[AIBN]₀=20, [AIBN]₀=0.1 M. This was gently heated at 40° C. to assist the dissolution of MCTA at high concentration. The reaction mixture was sealed with rubber septa and purged with argon for 10 minutes prior to placing the reaction mixture at 70° C. for 4 hours. Separate needle and syringe were used for both SEC and NMR characterization to ensure per enough reaction mixture was taken for sampling.

### Procedure 4.2

The procedure 4.1 was repeated with 4.88 mg of AIBN to target [MCTA]₀=2 M, [AIBN]₀=0.05 M, ([MCTA]₀/[AIBN]₀=40).

### Procedure 4.3

200 mg of MCTA, 6.51 mg of AIBN and 1.585 mL of dioxane was charged into 3.7 ml scintillation vial to target [MCTA]₀=0.5 M, [MCTA]₀/[AIBN]₀=20, [AIBN]₀=0.025 M. The reaction mixture was sealed with rubber septa and purged with argon for 10 minutes prior to placing the reaction mixture at 70° C. for 4 hours.

### Procedure 4.4:

The procedure 4.3 was carried out with 13.0 mg of AIBN to target [MCTA]₀=0.5 M, [AIBN]₀=0.05 M, [MCTA]₀/[AIBN]₀=40.

### Procedure 4.5:

100 mg of MCTA, 3.25 mg of AIBN and 1.585 mL of dioxane was charged into 3.7 ml scintillation vial to target [MCTA]₀=0.5 M, [MCTA]₀/[AIBN]₀=20, [AIBN]₀=0.0125 M. The reaction mixture was sealed with rubber septa and purged with argon for 10 minutes prior to placing the reaction mixture at 70° C. for 4 hours.

### Procedure 4.6:

The procedure 4.5 was carried out with 13.0 mg of AIBN to target [MCTA]₀=0.25 M, [AIBN]₀=0.05 M, ([MCTA]₀/[AIBN]₀=5).

TABLE S4
Characterization of the MCTA polymerization with [MCTA]₀ = 2M

| [AIBN]₀ | Time (hr) | p | rₜₕ | M_{w, th} | M_{w, th}(rₜₕ) | M_{w} | M_{w}/Mₙ | M_{z}/M_{w} |
|---|---|---|---|---|---|---|---|---|
| 0.1M | 0 | 0 | 1.00 | 380 | 380 | 240 | 1.03 | 1.03 |
| | 0.5 | 0.78 | 0.992 | 3000 | 3000 | 1900 | 1.94 | 1.63 |
| | 1.0 | 0.95 | 0.984 | 15k | 13k | 7200 | 3.30 | 1.83 |
| | 2.0 | 0.987 | 0.970 | 59k | 27k | 18.5k | 6.87 | 2.31 |
| | 4.0 | 0.997 | 0.949* | 238k | 26k | 32k | 11.8 | 3.04 |
| | | | 0.970** | | 42k** | | | |
| 0.05M | 0 | 0.000 | 1.000 | 376 | 376 | 260 | 1.01 | 1.02 |
| | 0.5 | 0.61 | 0.996 | 1600 | 1600 | 1200 | 1.72 | 1.56 |
| | 1.0 | 0.88 | 0.992 | 5800 | 5700 | 3600 | 2.33 | 1.71 |
| | 2.0 | 0.97 | 0.985 | 25K | 20k | 11k | 4.35 | 1.95 |
| | 4.0 | 0.990 | 0.974 | 75K | 32k | 26k | 8.74 | 2.58 |

*Stochiometric imbalance overestimated with initiation efficiency, f = 0.65.
**Theoretical imbalanced stoichiometry (rₜₕ) after 2 hours (p ≈ 0.99) is used to calculate M_{w, th}(rₜₕ).

TABLE S5
Characterization of the MCTA polymerization with [MCTA]₀ = 0.5M

| [AIBN]₀ | Time (hr) | p | rₜₕ | M_{w, th} | M_{w, th}(rₜₕ) | M_{w} | M_{w}/Mₙ | M_{z}/M_{w} |
|---|---|---|---|---|---|---|---|---|
| 0.025M | 0 | 0 | 1.000 | 380 | 380 | 240 | 1.02 | 1.03 |
| | 0.5 | 0.40 | 0.992 | 900 | 900 | 600 | 1.49 | 1.45 |
| | 1.0 | 0.62 | 0.984 | 1600 | 1600 | 1000 | 1.68 | 1.55 |
| | 2.0 | 0.83 | 0.970 | 4000 | 3700 | 1900 | 1.99 | 1.76 |
| | 4.0 | 0.95 | 0.949 | 14K | 9600 | 3700 | 2.97 | 2.12 |
| 0.05M | 0 | 0 | 1.000 | 376 | 376 | 250 | 1.01 | 1.02 |
| | 0.5 | 0.50 | 0.983 | 1100 | 1100 | 780 | 1.57 | 1.49 |
| | 1.0 | 0.76 | 0.968 | 2800 | 2600 | 1500 | 1.82 | 1.66 |
| | 2.0 | 0.91 | 0.942 | 7500 | 5800 | 3000 | 2.43 | 1.96 |
| | 4.0 | 0.97 | 0.902 | 27k | 9600 | 5600 | 4.17 | 2.50 |

TABLE S6
Characterization of the MCTA polymerization with [MCTA]₀ = 0.25M

| [AIBN]₀ | Time (hr) | p | rₜₕ | M_{w, th} | M_{w, th}(rₜₕ) | M_{w} | M_{w}/Mₙ | M_{z}/M_{w} |
|---|---|---|---|---|---|---|---|---|
| 0.0125M | 0 | 0.00 | 1.000 | 380 | 380 | 250 | 1.01 | 1.02 |
| | 0.5 | 0.27 | 0.992 | 660 | 660 | 440 | 1.34 | 1.39 |
| | 1.0 | 0.41 | 0.984 | 900 | 900 | 640 | 1.47 | 1.45 |
| | 2.0 | 0.57 | 0.970 | 1400 | 1300 | 850 | 1.59 | 1.53 |
| | 4.0 | 0.75 | 0.949 | 2600 | 2500 | 1400 | 1.88 | 1.79 |
| 0.05M | 0 | 0.00 | 1.000 | 380 | 380 | 240 | 1.02 | 1.03 |
| | 0.5 | 0.47 | 0.967 | 1000 | 1000 | 640 | 1.49 | 1.44 |
| | 1.0 | 0.71 | 0.939 | 2300 | 2100 | 1000 | 1.67 | 1.60 |
| | 2.0 | 0.87 | 0.891 | 5500 | 4000 | 1400 | 1.88 | 1.86 |
| | 4.0 | 0.95 | 0.822 | 13k | 5000 | 1900 | 2.19 | 2.19 |

We investigated the effect of varying the solvent for AB RAFT step-growth polymerization of MCTA concentration.

### Procedure 4.7

MCTA (500 mg, 1.331 mmol), 10.79 mg AIBN and 1.146 ml DMSO was charged into 3.7 ml scintillation vial to target [MCTA]₀=1.0 M, [MCTA]₀/[AIBN]₀=20, [AIBN]₀=0.05 M. The reaction mixture was sealed with rubber septa and purged with argon for 10 minutes prior to placing the reaction mixture at 70° C. for 4 hours.

### Procedure 4.8:

Procedure 4.7 was carried out using DMF as the solvent.

### Procedure 4.9:

Procedure 4.7 carried out using Toluene as the solvent. Due to the poor solubility of MCTA in Toluene, the reaction mixture was purged for 5 minutes (instead of 10 minutes) at 40° C. Separate needle and syringe was required for both SEC and NMR characterization per sampling due to the poor solubility of the polymer in toluene blocking the needle.

TABLE S7
MCTA polymerization in different solvents

| Sol- | Time | | | | | | M_{w}/ | M_{z}/ |
|---|---|---|---|---|---|---|---|---|
| vent | (hr) | p | rₜₕ | M_{w, th} | M_{w, th}(rₜₕ) | M_{w} | Mₙ | M_{w} |
| DMSO | 0 | 0 | 1.000 | 380 | 380 | 260 | 1.01 | 1.03 |
| | 0.5 | 0.69 | 0.992 | 1800 | 1800 | n/a* | n/a* | n/a* |
| | 1.0 | 0.88 | 0.984 | 6500 | 6000 | n/a* | n/a* | n/a* |
| | 2.0 | 0.96 | 0.970 | 25k | 17k | n/a* | n/a* | n/a* |
| | 4.0 | 0.987 | 0.949 | 94k | 22k | n/a* | n/a* | n/a* |
| DMF | 0 | 0 | 1.000 | 380 | 380 | 270 | 1.03 | 1.03 |
| | 0.5 | 0.61 | 0.992 | 1600 | 1500 | 1500 | 2.30 | 6.09 |
| | 1.0 | 0.83 | 0.984 | 4000 | 4000 | 3300 | 2.86 | 6.38 |
| | 2.0 | 0.95 | 0.970 | 15k | 11k | 9400 | 5.02 | 6.76 |
| | 4.0 | 0.988 | 0.949 | 62k | 20k | 22k | 9.49 | 7.67 |
| Tolu- | 0 | 0 | 1.000 | 380 | 380 | 270 | 1.07 | 1.08 |
| ene | 0.5 | 0.66 | 0.992 | 1800 | 1800 | 1200 | 1.69 | 1.57 |
| | 1.0 | 0.89 | 0.984 | 6500 | 6000 | 2750 | 2.50 | 1.86 |
| | 2.0 | 0.97 | 0.970 | 25k | 17k | 7000 | 3.73 | 2.09 |
| | 4.0 | 0.992 | 0.949 | 94k | 22k | 12k | 6.30 | 2.50 |
| | iso- | | | | | 22k | 1.70 | 1.59 |
| | late | | | | | | | |

### Example 5. RAFT Step-Growth Polymerization of Acrylic Monomers

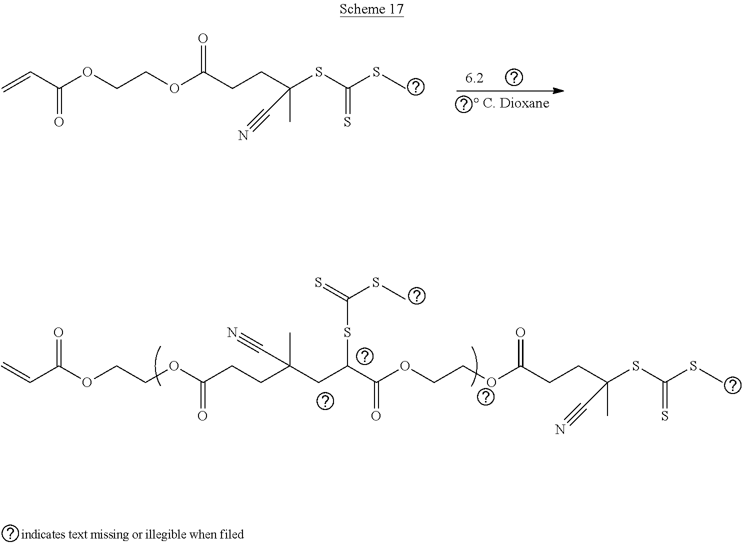

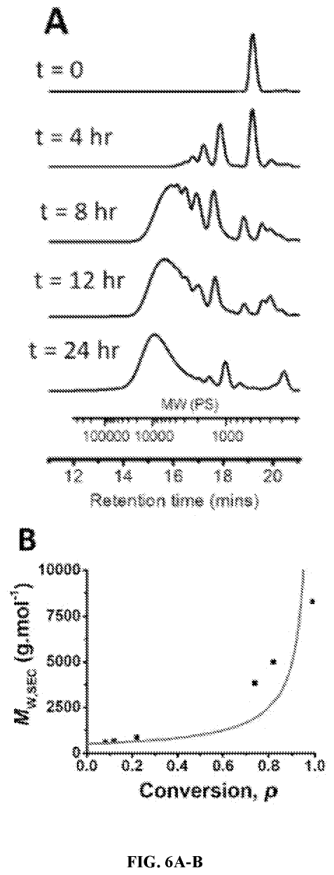

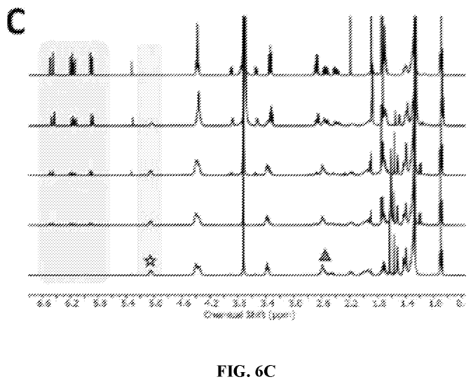

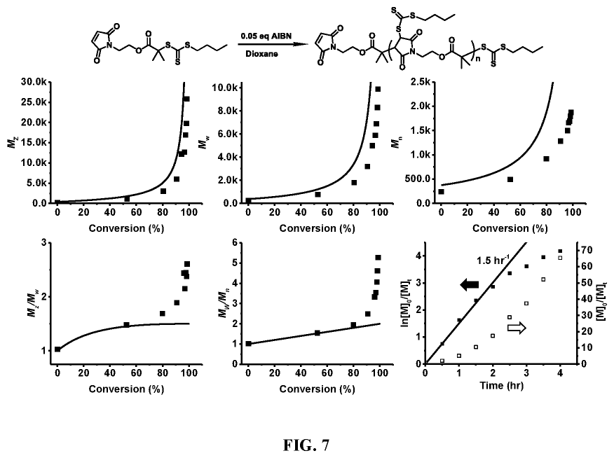

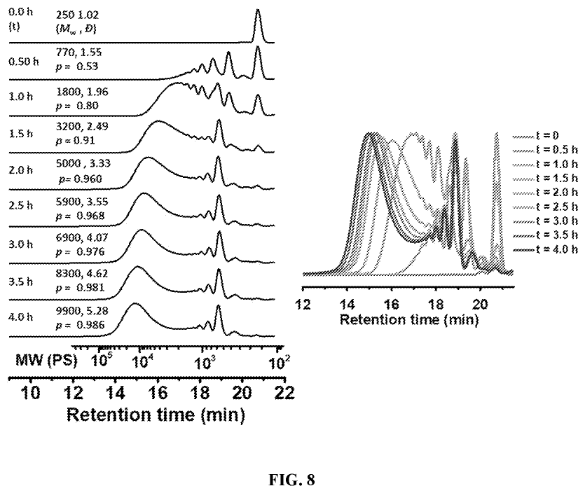

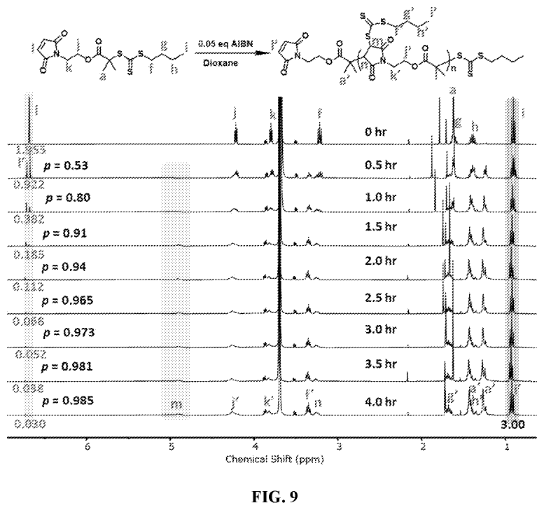

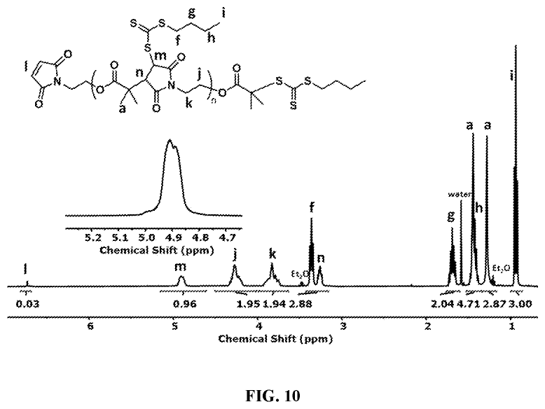

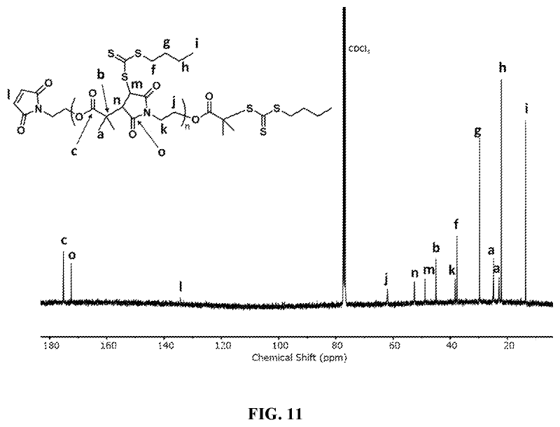

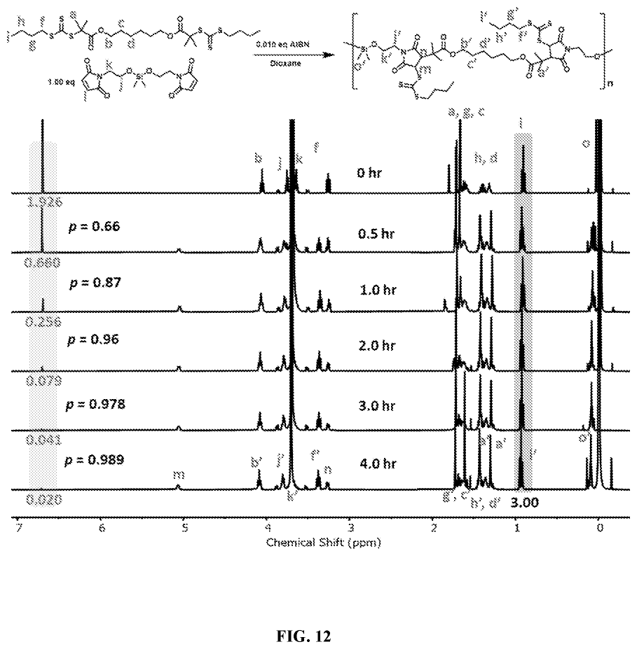

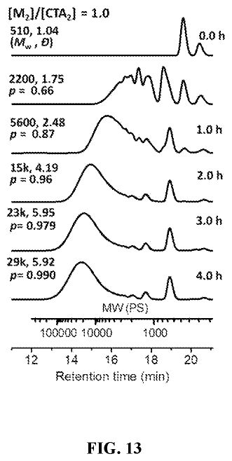

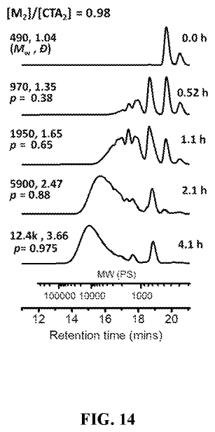

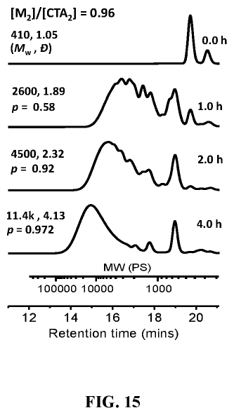

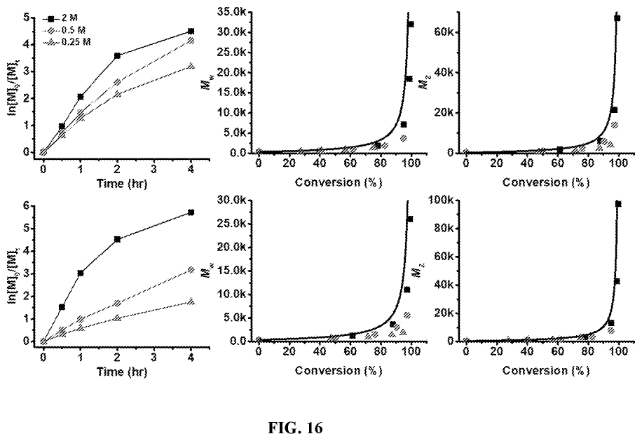

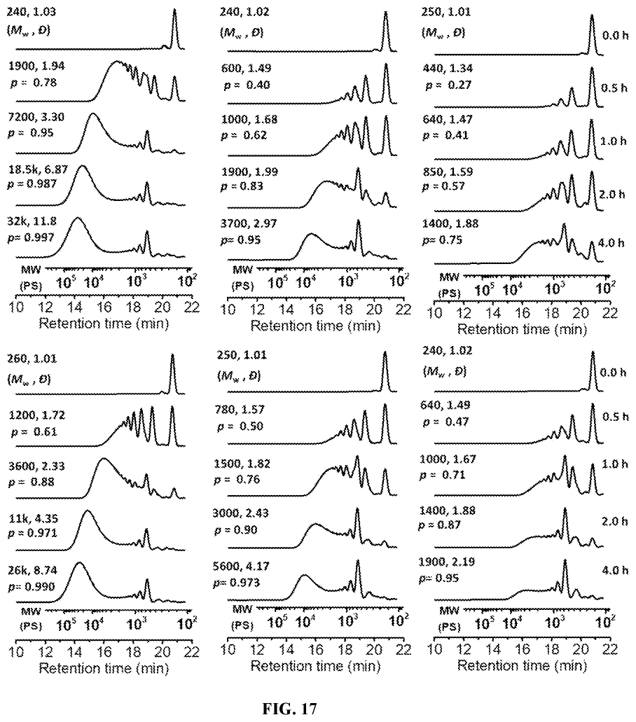

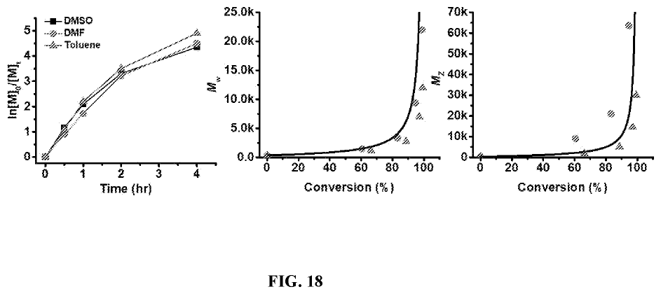

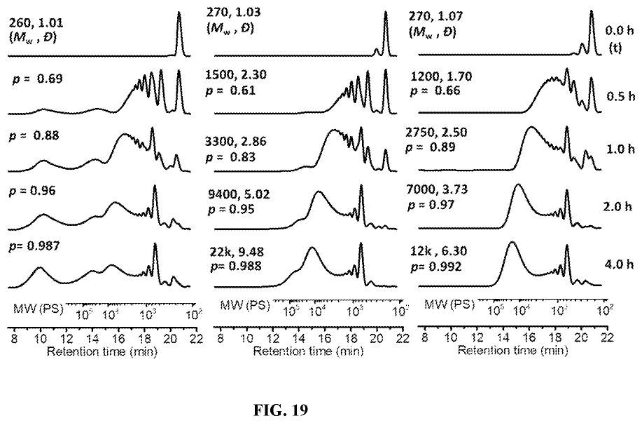

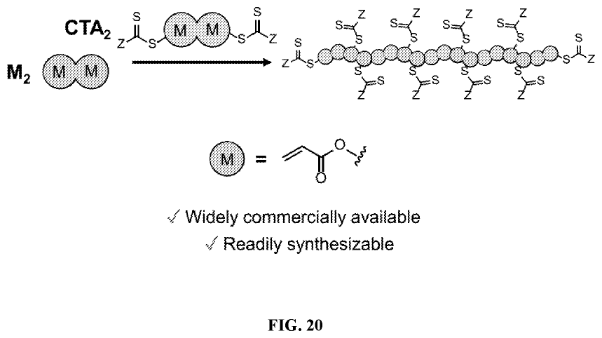

For RAFT step-growth polymerization, the choice of monomer and RAFT agent can be selected to limit monomer propagation to a single unit (DP=1). Described elsewhere herein, N-alkyl maleimides, known to have low homo-propagation rate (kₚ), are suitable for RAFT step-growth polymerization. AB RAFT step-growth polymerization of a new monomer-CTA pair that has acrylic monomer unit (known to be more readily homo-polymerizable (Keddie, D. J.; Moad, G.; Rizzardo, E.; Thang, S. H., RAFT Agent Design and Synthesis. Macromolecules 2012, 45 (13), 5321-5342; Keddie, D. J., A guide to the synthesis of block copolymers using reversible-addition fragmentation chain transfer (RAFT) polymerization. Chem. Soc. Rev. 2014, 43 (2), 496505), and trithiocarbonate based RAFT agent with cyano-stabilizing tertiary fragmentation as the R-group is described here. Based on our rationale of the monomer-CTA design (vide supra) the polymerization of this new monomer-CTA pair followed a step-growth molecular weight evolution with M_{w} following good agreement with Carothers equation by SEC analysis (FIG. 6B). The appearance of new peaks observed by ¹H-NMR spectroscopy at 5.02 ppm and 2.56 ppm was consistent with the expected bonds formed from the polymerization (FIG. 6C). The kinetics was found to proceed through pseudo-first order rate; however, despite using higher equivalence of initiator ([M-CTA]₀/[I]₀=5, [I]₀=200 mM), it was much slower (k_{p′pp}=0.126 hr⁻¹) when compared with the previous approach. After 24 hours, the polymerization reached 99.9% conversion; however, the molecular weight was limited by the sacrificial consumption of the monomer end groups by initiator, resulting in imbalanced stoichiometric ratio of the reactive ends according to the Carothers equation. Odian, G., (2004).

### Example 6. A₂+B₂ RAFT Step-Growth of Bis-Maleimides

Procedure for Poly(M_{2A}-alt-CTA₂) synthesis:

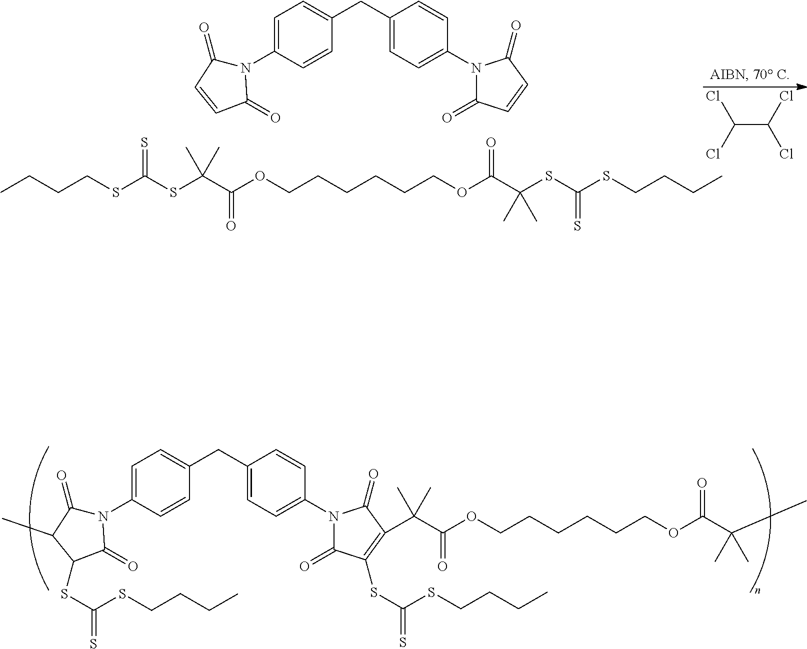

Bifunctional monomer, M_{2A} (175.5 mg, 0.490 mmol) was first charged into the vial, followed by bifunctional CTA, CTA₂ (287 mg, 0.490 mmol) was carefully added via 1 ml syringe with a 21 g needle. Next, 0.577 ml tetrachloroethane (TCE) and 0.402 ml AIBN stock solution (20 mg/ml in TCE) were added to target molar concentration of [M_{2A}]₀:[CTA₂]₀:[AIBN]₀=0.5:0.5:0.05 M. The vial was then equipped with a stir bar and rubber septum, which was left to stir at 40° C. until M_{2A} was completely solubilized. The solution was then purged with argon for 10 minutes and then heated at 70° C. for 4 hours. Monomer conversion (p) was determined by ¹H-NMR spectroscopy by integrating CH═CH maleimide ring proton(s) relative to CH₃ at 0.96 ppm on the Z-group of the CTA. For purification, the reaction mixture was diluted in approximately equal volume of chloroform and precipitated directly into 50 ml centrifuge tube with diethyl ether and collected with centrifugation. After discarding the supernatant, the polymers were redissolved in chloroform and then reprecipitated again in diethyl ether twice. Typical yields of 60% are obtained.

Procedure for Poly(M_{2B}-alt-CTA₂) synthesis:

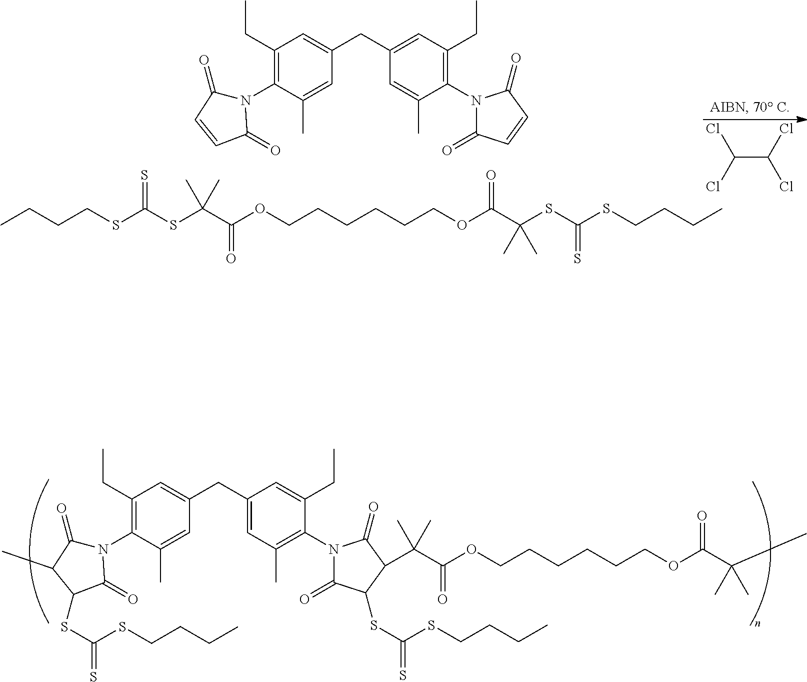

Bifunctional monomer, M_{2B} (187.5 mg, 0.424 mmol) was first charged into the vial, followed by bifunctional CTA, CTA₂ (248.3 mg, 0.424 mmol) was carefully added via 1 ml syringe with a 21 g needle. Next, 0.500 ml TCE and 0.348 ml AIBN stock solution (20 mg/ml in TCE) were added to target molar concentration of [M_{2B}]₀:[CTA₂]₀:[AIBN]₀=0.5:0.5:0.05 M. The vial was then equipped with a stir bar and rubber septum; the solution was then purged with argon for 10 minutes and then heated at 70° C. for 21 hours. Monomer conversion was determined by ¹H-NMR spectroscopy by integrating CH═CH maleimide ring proton(s) relative to CH₃ at 0.96 ppm on the Z-group of the CTA. For purification, the reaction mixture was diluted in approximately equal volume of chloroform and precipitated directly into 50 ml centrifuge tube with methanol and collected by centrifugation. After discarding the supernatant, the polymers were redissolved in chloroform and then reprecipitated again in methanol.

Procedure for Poly(M_{2C}-alt-CTA₂) synthesis:

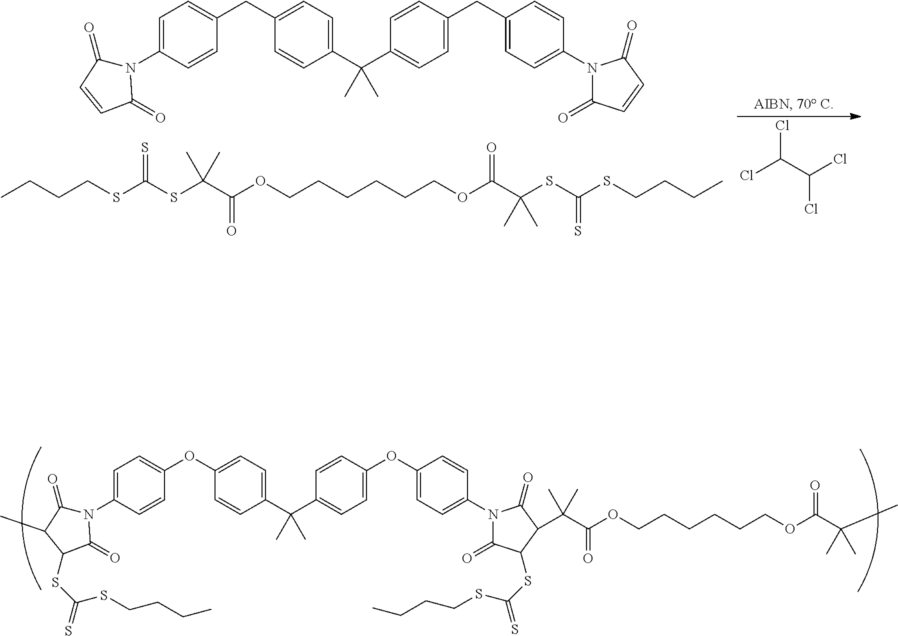

Bifunctional monomer, M_{2C} (143.1 mg, 0.250 mmol) was first charged into the vial, followed by bifunctional CTA, CTA₂ (147 mg, 0.250 mmol) was carefully added via 1 ml syringe with a 21 g needle. Next, 0.296 ml TCE and 0.206 ml AIBN stock solution (20 mg/ml in TCE) to target molar concentration of [M₂]₀:[CTA₂]₀:[AIBN]₀=0.5:0.5 0.05 M. The vial was then equipped with a stir bar and rubber septum; the solution was then purged with argon for 10 minutes and then heated at 70° C. for 4 hours. Monomer conversion was determined from ¹H-NMR spectroscopy by integrating CH═CH maleimide ring proton(s) relative to CH₃ at 0.96 ppm on the Z-group. For purification, the reaction mixture was diluted in approximately equal volume of chloroform and precipitated directly into 50 ml centrifuge tube with diethyl ether and collected by centrifugation. After discarding the supernatant, the polymers were redissolved in chloroform and then reprecipitated again in diethyl ether. Typical yields of 71% are obtained

Procedure for Poly(M_{2D}-alt-CTA₂) synthesis:

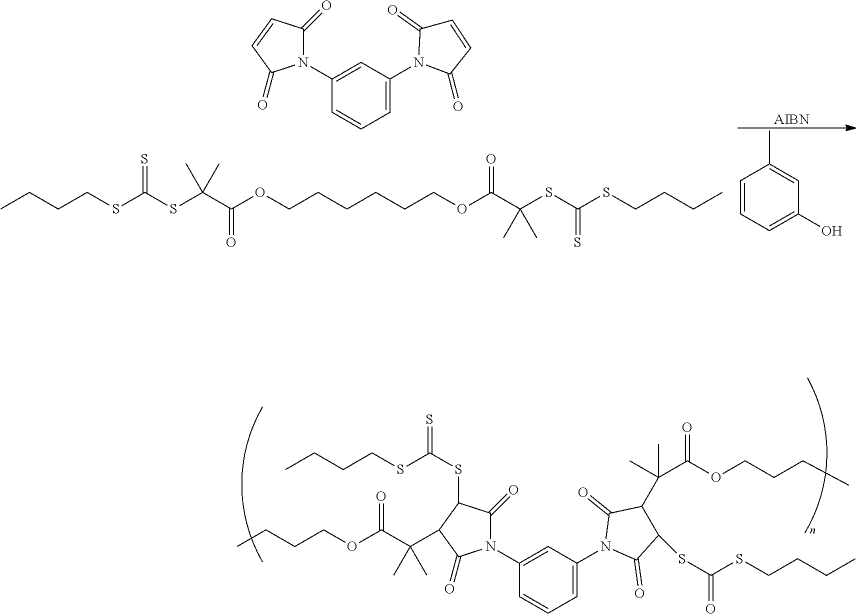

Bifunctional monomer, M₂D (200 mg, 0.746 mmol) was first charged into the vial, followed by bifunctional CTA, CTA₂ (437 mg, 0.746 mmol) was carefully added via 1 ml syringe with a 21 g needle. Next, 0.879 ml m-cresol and 0.612 ml AIBN stock solution (20 mg/ml in m-cresol) to target molar concentration of [M_{2D}]₀:[CTA₂]O:[AIBN]₀=0.5:0.5 0.05 M. The vial was then equipped with a stir bar and rubber septum; the solution was then purged with argon for 10 minutes and then heated at 70° C. for 4 hours. As the solvent signals overlapped with the CH═CH maleimide ring proton(s) by ¹H-NMR, the relative integrals at 6.54-6.91 ppm corresponding to the monomer and the solvent was measured with respect to the solvent signal at 7.07-7.27 ppm. This was compared with ¹H-NMR of m-cresol to determine monomer conversion. For purification, RAFT step-growth polymers were precipitated directly into 50 ml centrifuge tube with diethyl ether and collected by centrifugation. After discarding the supernatant, the polymers were redissolved in acetone and then reprecipitated again in diethyl ether.

Procedure for PNAM graft copolymer synthesis:

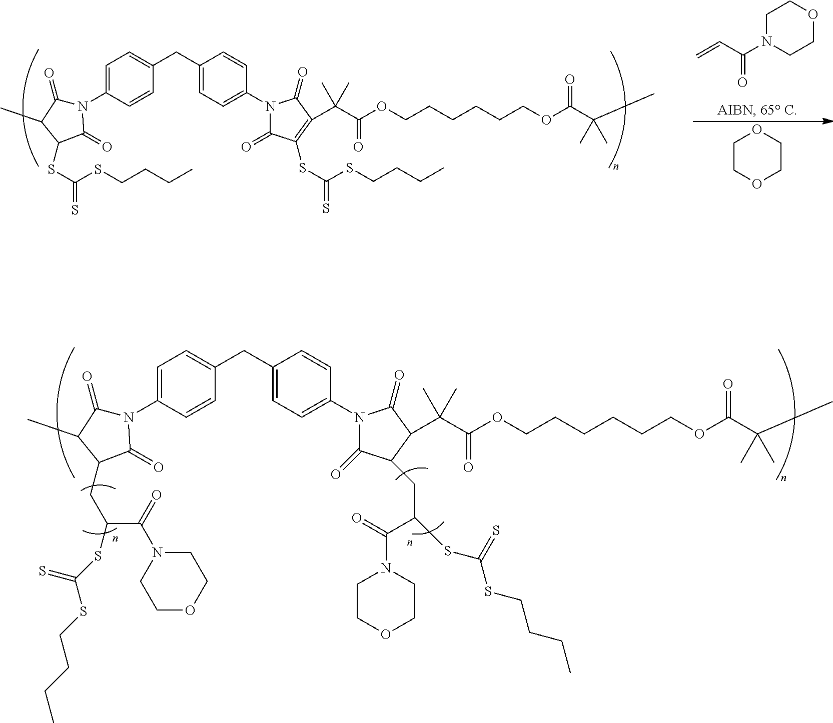

Isolated P(M_{2A}-alt-CTA₂) (1254 mg, 2.7 mmol) was charged into a 100 ml round bottom flask, followed by 4-acryloylmorpholine (15.0 g, 106 mmol). Next, 21.5 ml dioxane was added by weight (22.2 g) and then 545 μl AIBN stock solution (20 mg/ml in dioxane) was added using a micropipette, targeting molar concentrations of [NAM]₀: [CTA]₀:[I]₀=3 M:0.075 M:0.00188 M (taking into account volume of the monomer). The vial was then equipped with a magnetic stir bar and secured by rubber septum. The solution was purged with argon for 10 minutes, prior to placing the reaction mixture in an oil bath set to 65° C. After 2.5 hours the monomer conversion reached 99% and the polymer was isolated by precipitating into diethyl ether.

Procedure CTA end group removal on PNAM graft copolymer:

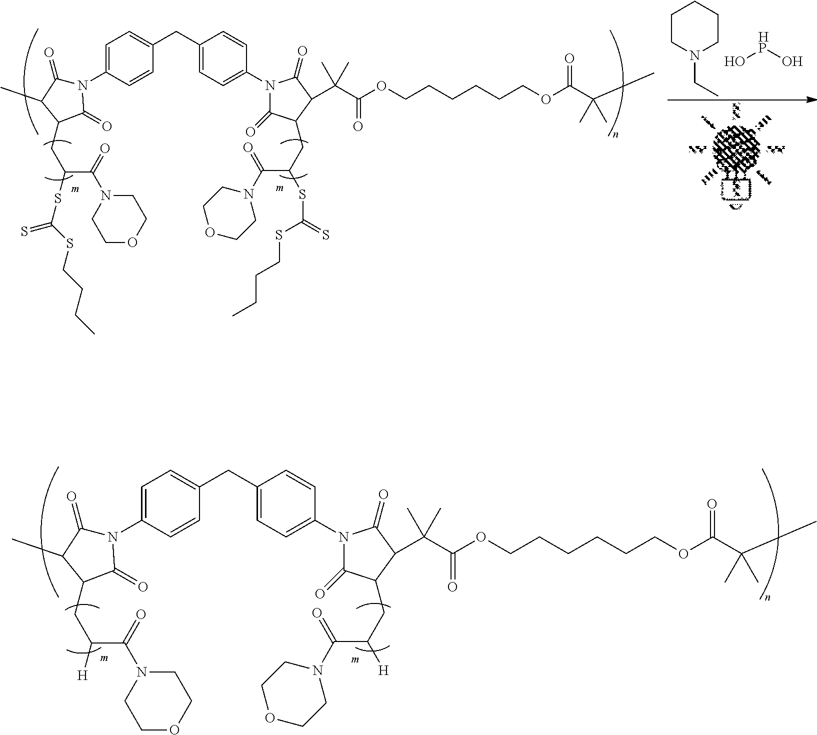

Removal of Z-group was carried out following a reported procedure:³ Briefly, isolated P(M_{2A}-alt-CTA₂)-g-PNAM (250 mg, 0.0408 mmol CTA, 1 equivalence) was charged into a 20 ml vial, followed by N-ethyl piperidine hypophosphate (109 mg, 0.612 mmol, 15 equivalence). Next, 2.5 ml dioxane was added. Following dissolution, the mixture was transferred to 3.7 ml vial. The vial was then equipped with a magnetic stir bar and secured by rubber septum. The solution was purged with argon for 10 minutes, prior to irradiation with blue LED light for 24 hours. The polymer (192 mg recovered) was isolated by precipitating into diethyl ether.

### Example 6. Diversity of G Group in CTA1-G-CTA2

A Bifunctional-Chain Transfer Agent (CTA1-G-CTA2) having a disulfide linkage was prepared. The CTA1-G-CTA2 containing a disulfide bond was used to prepare a RAFT step-growth polymer. The polymer was then cleaved at the disulfide bond, evidencing a means for tuning the backbone, for example, for size.

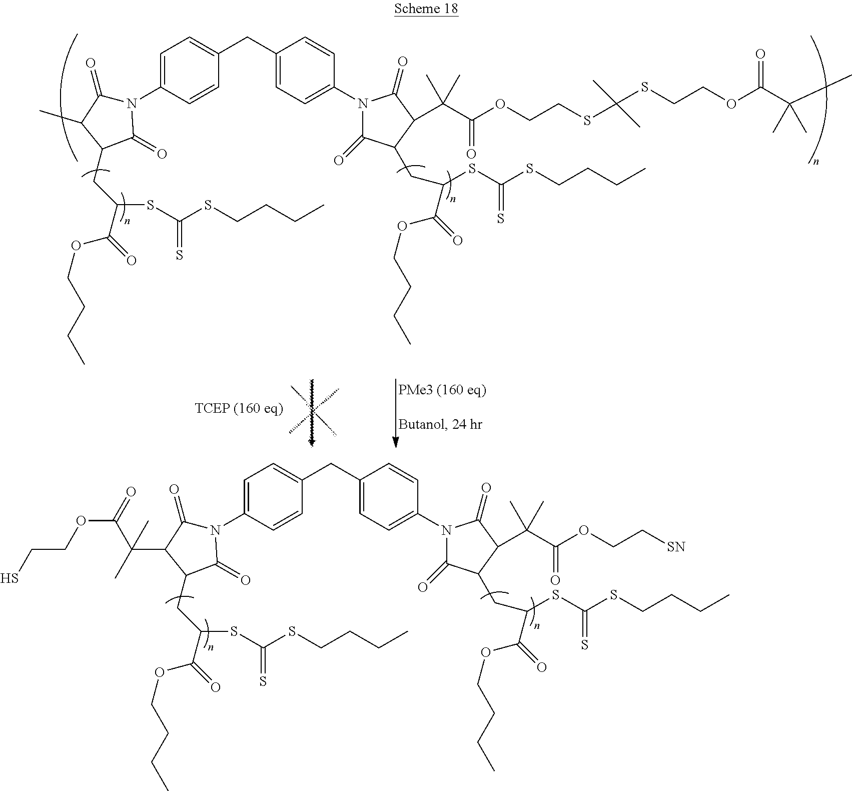

### Example 7. RAFT Step-Growth Polymerization with Acrylates and Diacrylates

A₂+B₂ RAFT step-growth with diacrylic monomers, which are a class of monomers that are not only synthetically easy to prepare, but also widely commercially available and often inexpensive. Below are exemplary monomers and CTA units employed in these experiments.

Incorporation of functional groups into the polymer backbone was demonstrated though the bifunctional monomer, such as incorporation of a degradable disulfide moiety through a bifunctional CTA unit shown above. RAFT step-growth polymers were used to prepare molecular brush polymers, and cleavage of the brush backbone was demonstrated, forming narrow molecular weight species of two linked polymer side chains.

It has been found that in certain embodiments, successful RAFT step-growth begins with identifying suitable pairing of a CTA functionality with the monomer (acrylate in this case). Various CTAs were screened that could yield selective SUMI-CTA adducts under stoichiometrically balanced conditions (r=[M]₀/[CTA]₀=1). See, for example, Scheme 19, which depicts a RAFT step-groth adduct described herein.

We decided to employ trithio-carbonate based CTAs to match the Z-group reactivity with monomer, to ensure rapid chain transfer while limiting the RAFT retardation. We used butyl acrylate (BA) as a model acrylic monomer at 2 M concentration ([BA]₀=2 M) in diox-ane, and initiated the RAFT SUMI process with AIBN as the initiator ([AIBN]₀=50 mM) at 70° C., leaving the reaction for 4 hours unless stated otherwise.

Initially, 4-cyano-4-(((dodecylthio)carbonothioyl)thio) pentanoic acid (CDTPA, CTA1A) was examined (Table 8). However, limited yields (35%, Table 8) were obtained after 8 hours. As the fragmentation of CTA1A generates cyano-stabilized tertiary radical (R•), the addition to acrylic monomer to form carbonyl ester stabilized secondary radical may be rate limiting. Interestingly, CTA1C was found to have the highest SUMI CTA adduct yields (86%) as well as equal consumption of monomer and CTA. CTA1B bears intermediate reactivity between CTA1A and CTA1C; however, it was found to generate even lower yields (7.6%) than the former two CTA's. Additionally, CTA1D with less stabilized radical after fragmentation resulted in a higher consumption of the monomer than the CTA, indicative of multiple monomer addition, as the products of fragmentation does not drive the chain transfer equilibrium. Lastly, CTA1E that bears primary radical upon fragmentation resulted in retarded homopolymerization of BA, as fragmentation is disfavored.

TABLE 8

| [symbol] = | 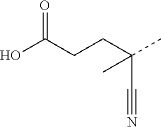 | 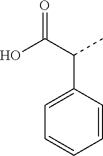 | 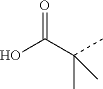 | 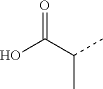 | 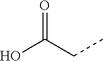 |
|---|---|---|---|---|---|
| | CTA_{1A} | CTA_{1B} | CTA_{1C} | CTA_{1D} | CTA_{1E} |
| | 35% | 8% | 86% | 34% | >1% |

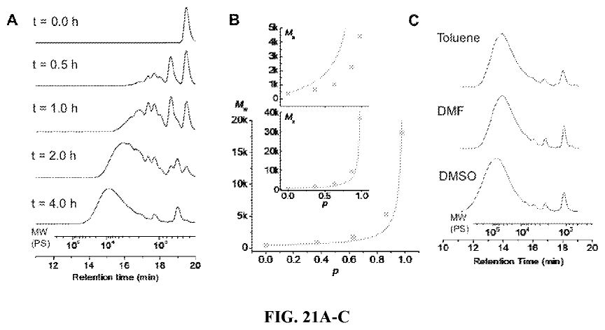

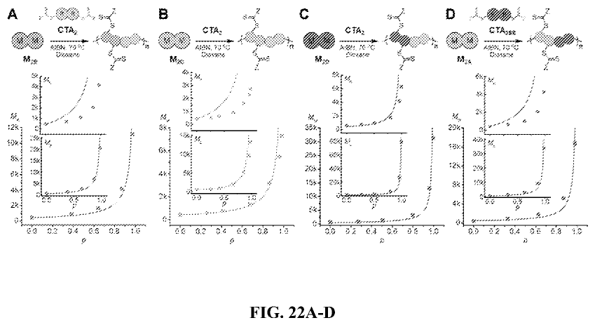

As CTA1C demonstrated high SUMI-CTA adduct yields with BA in our model RAFT SUMI study, CTA2 was prepared following our previous report.¹⁴⁻¹⁵ 1,6-hexanediol diacrylate (M2A) was chosen as our initial model diacrylate monomer to match the linker length with CTA2. RAFT step-growth polymerization was carried out in 2 M concentration of the monomer functional groups in 1,4-dioxane using stoichiometrically equivalent CTA2 and initiated using AIBN at 70° C. (FIG. 21). The monomer conversion (p) reached 98% after 4 hours, which was determined from ¹H-NMR by tracking the disappearance of acrylate peaks (peak m) relative to OCH₂ protons on the Z-group (peaks p and c). Concurrently, the appearance of CH peak next to trithiocarbonate at 4.89 ppm (peak n) and diastereotopic CH₂ peaks at 2.38/2.13 ppm (peaks r/r′) is consistent with the bond formation during the polymerization.

Conventional SEC analysis disclosed that the number-average (Mₙ), weight-average (M_{w}), and Z-average (M_{z}) molecular weight with conversion (p) tracked well with the theoretical molecular weight averages (FIG. 21B),²³ indicating polymerization to follow step-growth molecular weight evolution. It is important to note that the Mₙ is expected to be lower than predicted as cyclization is not considered in the theoretical equation.²³

We next investigated the effect of changing the concentration of the polymerization ([CTA]₀=1, 0.5, 0.25 M) with constant initiator concentration ([AIBN]₀=50 mM) or equivalence with respect to the CTA ([CTA]₀/[AIBN]₀=40). It should be noted that, in traditional RAFT kinetics, the rate is often dependent on the ratio of CTA to initiator due to retardation which is typically observed for highly active Z-groups. Here, we found the rate was maintained by keeping the initiator concentration constant, while changing this to keep the equivalence of the initiator constant resulted in a dramatic effect in rate, similar to our early work with maleimidic monomers. Lower concentrations of [CTA]leads to an increased formation of cyclic species resulting in much lower Mₙ, which is consistent with step-growth polymerization.

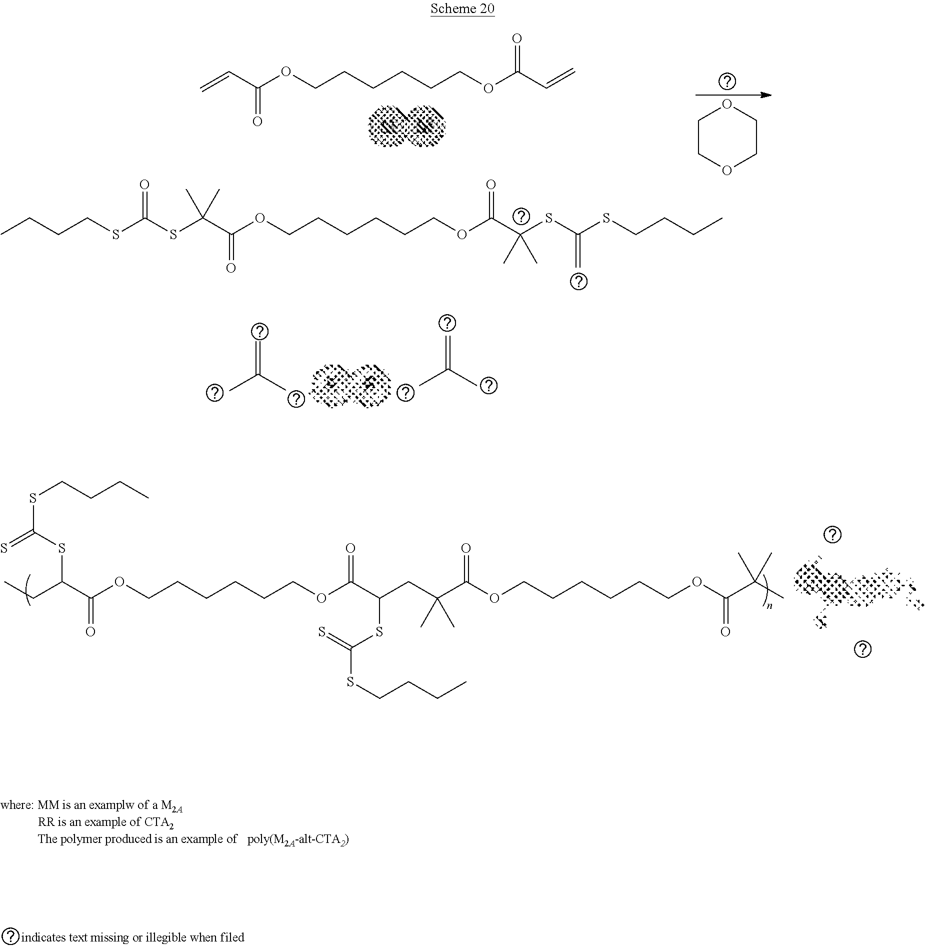

One advantage in traditional RAFT polymerization is the robustness in the use of different solvents. Previously in the case of maleimidic monomers, significant high molecular weight shouldering can occur when RAFT step-growth polymerization was carried out in DMF or DMSO, which could be due to occurrence of side reactions with maleimides in polar solvents. Pleasingly, RAFT step-growth polymerization of acrylates (M_{2A} and CTA2) using the same conditions above ([M]₀=2 M, [AIBN]₀=0.05 M, [M]₀/[CTA]₀=1, at 70° C. for 4 h) in toluene, DMF and DMSO all successfully proceeded, with experimental molecular weight averages tracking well with theoretical values. Interestingly, macro-phase separation had occurred during the polymerization in DMSO, which resulted in apparent auto-acceleration in rate.

### Example 8. Preparation of a Polymer Backbone Library

Various commercially available diacrylate monomers were screened (M, shown above) to prepare a library of polymer backbones (FIG. 22). Pleasingly, each reaction reached high p (Schemes 21-24, showing NMR analyses of: polymerization of M_{2B} with CTA2 in Scheme 21, polymerization of M_{2C} with CTA2 in Scheme 22, polymerization of M_{2D} with CTA₂ in Scheme 23, polymerization of M_{2A} with CTA_{2SS} in Scheme 24) under the same reaction conditions and maintained step-growth molecular weight evolution (FIG. 22).

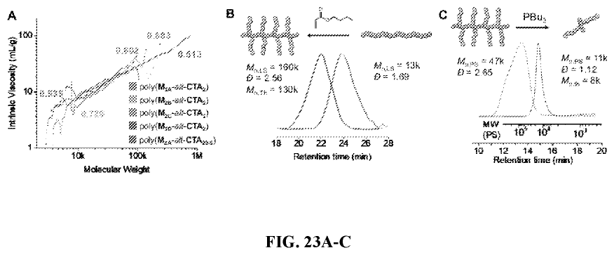

In all cases, low molecular weight cyclic species were removed upon precipitation, yielding the desired polymer structures. Furthermore, Mark-Houwink analysis was carried out by logarithmic plots of intrinsic viscosity as a function of molecular weight (FIG. 23A). Typically, the exponent parameter, α, which describes conformation of polymers in dilute solution, is between 0 to 0.5 and 0.5 to 0.7 for branched and linear polymers, respectively. Indeed, our RAFT step-growth polymers reveal exponent parameters of 0.5 to 0.72 (FIG. 23A), consistent for linear polymers.

An advantageous aspect of step-growth polymerization is the ability to incorporate functionality into the polymer backbone. Here we show an alternative entry of inserting functionality through the bifunctional CTA. This was successfully demonstrated using disulfide tethered bifunctional CTA (CTA_{2SS′}, shown above) (FIG. 22D). Indeed, RAFT step-growth polymerization with M_{2A} and CTA_{2SS} proceeded with desired molecular weight evolution (FIG. 22D).

### Example 9. Preparation of A₂+B₂ RAFT

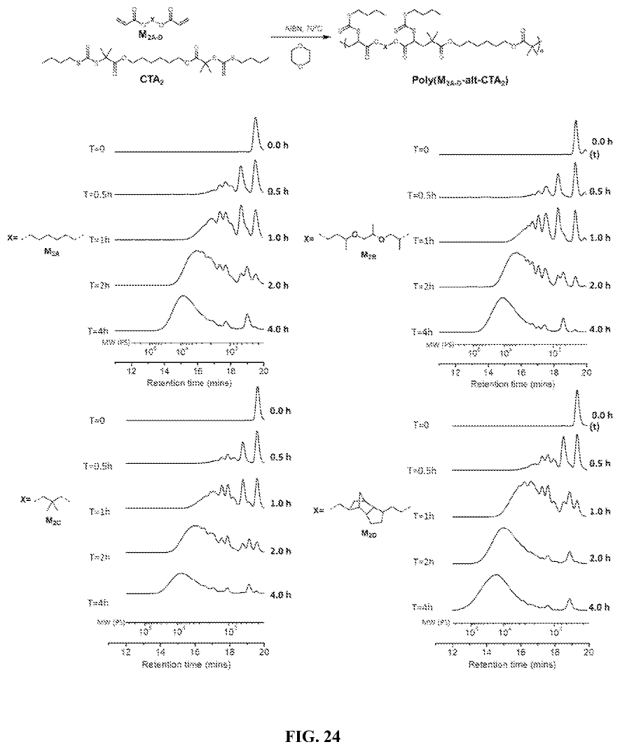

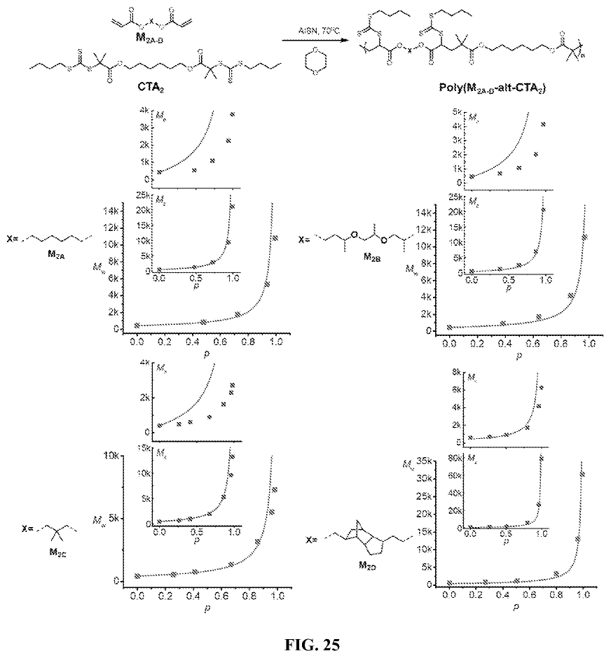

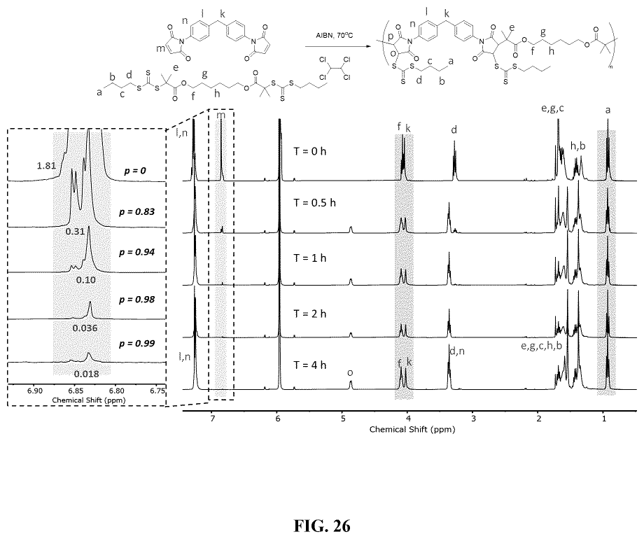

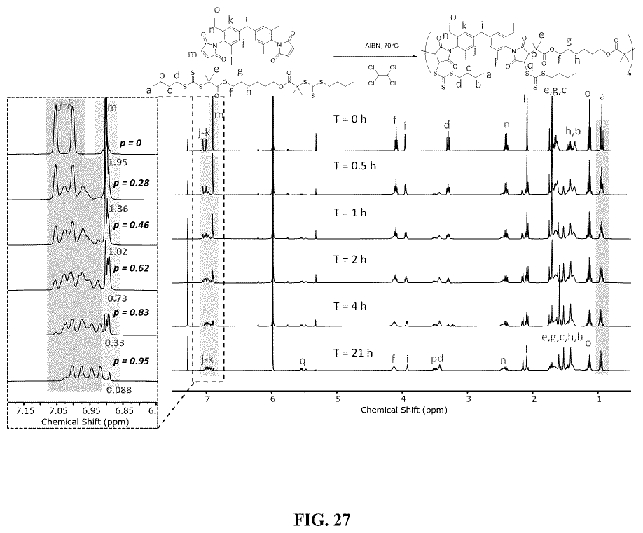

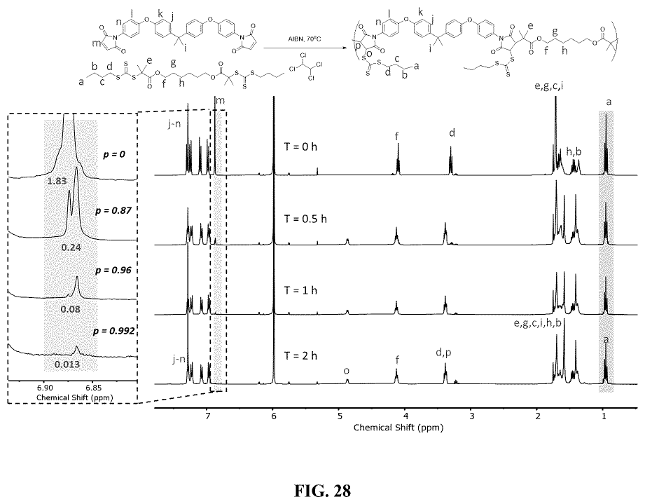

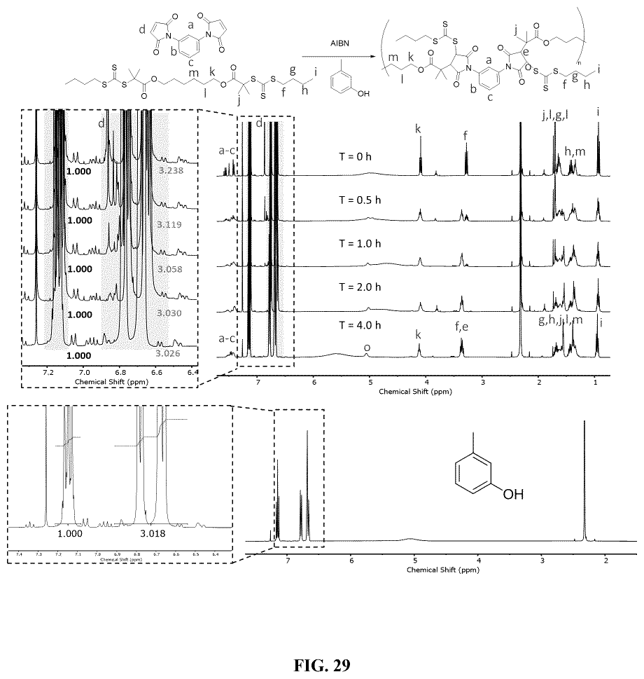

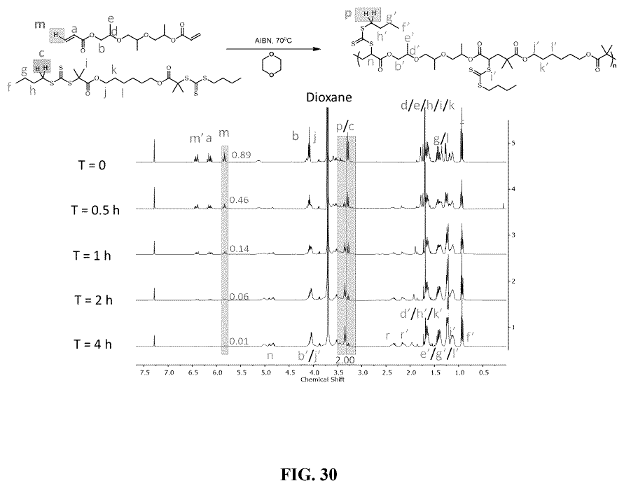

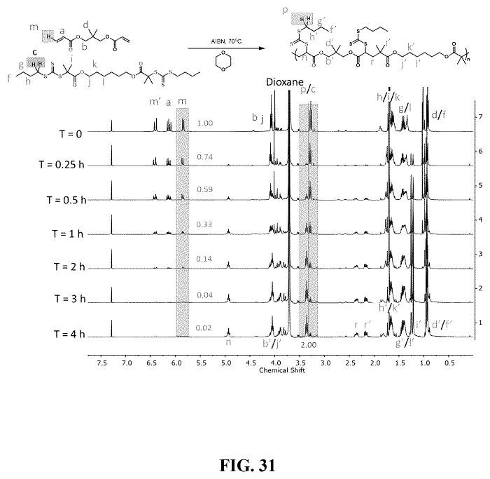

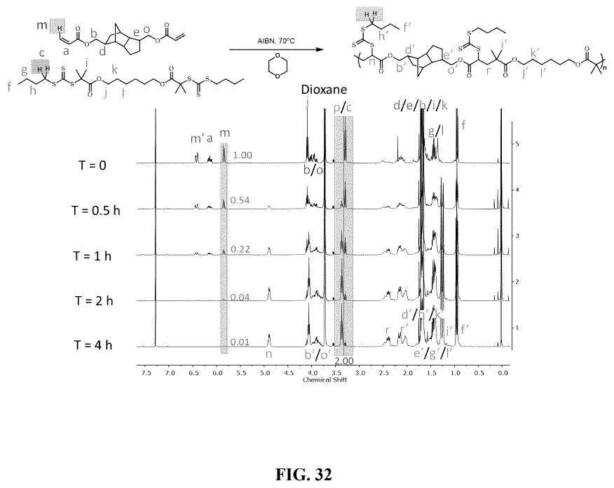

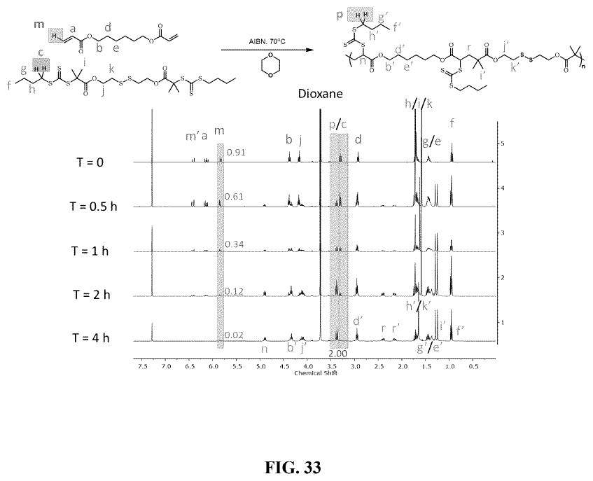

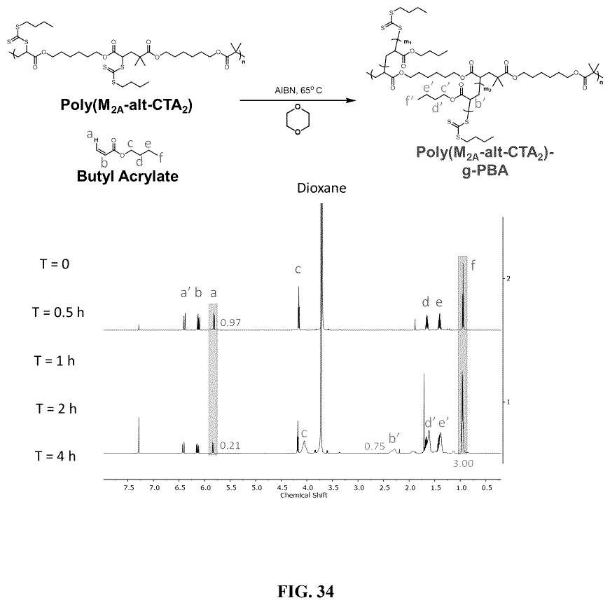

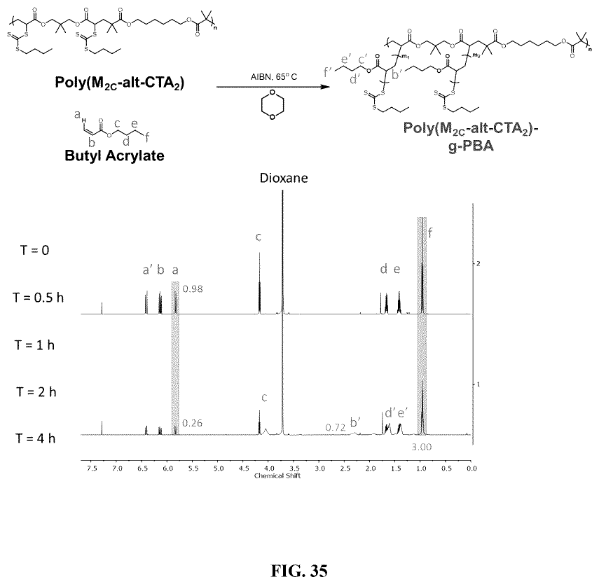

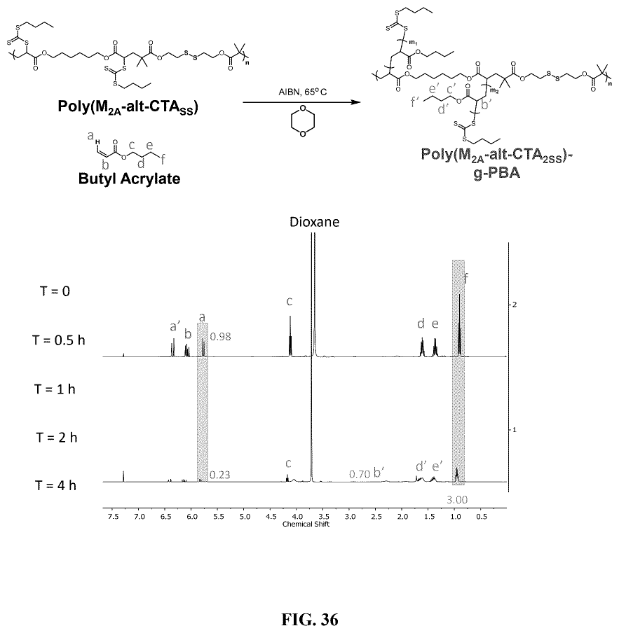

FIGS. 24 and 25 show the results of syntheses using the methods described herein to prepare RAFT polymers from various diacrylates.

### Example 10. Preparation of Molecular Brush Polymers

One advantage of RAFT step-growth polymers is facile preparation of molecular brush polymers by directly grafting from the backbone. Molecular brush synthesis proceeded with the disclosed acrylic step-growth backbone, using BA as a model monomer to graft side chains (FIG. 23B). The conversion of BA was determined by ¹H-NMR analysis, by following the disappearance vinyl protons at 5.70 ppm with respect to CH3 at 0.93 ppm (Schemes 25, 26 and 27).

Indeed, the absolute Mn of the brush polymer, determined by SEC with light scattering, is consistent with the calculated value from the absolute Mₙ of the linear backbone (FIG. 23B). Additionally, Mark-Houwink plots of the resulting brushes confirms changes in chain confirmation, as the a value dramatically decreases, suggesting a transition from linear to denser branched conformation in solution.

### Example 11. Cleavage of Disuldie Bonds on Brush Polymers

To demonstrate the versatility of the polymer backbone made with our methodology, we demonstrate cleavage of the disulfide units along the molecular brush polymers made with poly(M-alt-CTA). Using butanol as the protic solvent, we introduced stoichiometric equivalence of tributyl phosphine with respect to disulfide (FIG. 23C). Remarkably, after 1 hour of introducing the reducing agent, SEC analysis revealed unimolecular species with narrow molecular weight distribution that is close to the expected molecular weight of 2 polymeric side chains (FIG. 5C). Such ease of incorporation of degradable functionalities into the polymer backbone opens up RAFT step-growth to applications where degradability is desired such as drug delivery and tissue engineering.

Efforts have been made to ensure accuracy with respect to numbers used (e.g. amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Unless defined otherwise, technical and scientific terms used herein have the same meaning as commonly understood by one of ordinary skill in the art to which this subject matter belongs, and are generally consistent with the Compendium of Chemical Terminology, IUPAC Recommendations, 2^{nd} Ed. 2019, available at https.//goldbook.iupac.org.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A RAFT step-growth polymerization process, comprising
allowing a RAFT step-growth adduct to polymerize in a step-growth process in the presence of a solvent and one or more of the following: an initiator, visible light and a photocatalyst,
wherein a RAFT step-growth polymer comprising one or more inserted backbone functional units and a RAFT agent residue in each repeat unit in the backbone of the polymer is prepared.

2. The RAFT step-growth polymerization process of claim 1, wherein the allowing a RAFT step-growth adduct to polymerize causes a cyclic process of chain transfer (kₜᵣ), to form a chain end radical; monomer addition (kᵢ) to the radical to form a mid-chain radical; and chain transfer (kₜᵣ), wherein the polymer forms by step-growth molecular weight evolution.

3. The RAFT step-growth polymerization process of claim 1, wherein the RAFT step-growth polymer comprises one or more repeat units selected from the group consisting of: 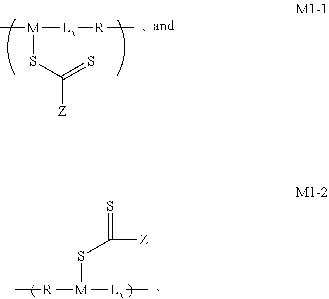
wherein,
M, in each instance, is independently a residue of a monomer;
R, in each instance, is independently a residue of a first backbone functional unit;
L_{X}, in each instance, is independently a covalent bond or a linker covalently bound to M and/or to R;
Z, in each instance, is independently selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl.

4. The RAFT step-growth polymerization process of claim 1, wherein the RAFT step-growth adduct is a Monomer-Chain Transfer Agent (M_{A}-CTA).

5. The RAFT step-growth polymerization process of claim 4, wherein the M_{A}-CTA has the following structure: 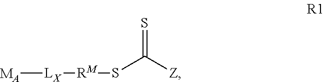
wherein,
M_{A} is a residue of a monomer M;
R^{M} is a residue of a first backbone functional unit;
L_{X}, in each instance, is independently a covalent bond or a linker covalently bound to M_{A} and to R^{M};
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl.

6-8. (canceled)

9. The RAFT step-growth polymerization process of claim 5, wherein the M_{A}-CTA has the structure:

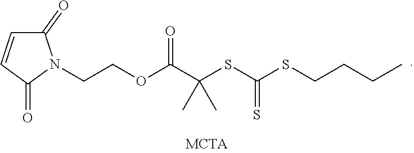 [SMILES: CCCCSC(=S)SC(C)(C)C(=O)OCCN1C(=O)C=CC1=O]

10. The RAFT step-growth polymerization process of claim 1, wherein the polymer has the formula: 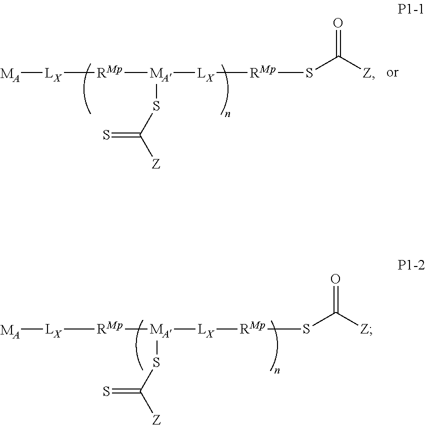
wherein,
M_{A} and M_{A′} in each instance, is independently a residue of a monomer;
L_{X}, in each instance, is independently a covalent bond or a linker covalently bound to M_{A} and to R^{Mp};
R^{Mp}, in each instance, is independently a residue of a first backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl;
and,
n is an integer from 1 to 1,000.

11-13. (canceled)

14. The RAFT step-growth polymerization process of claim 10, wherein the polymer has the structure: 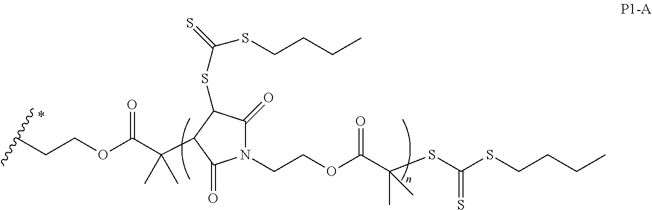
wherein [symbol] denotes attachment to a terminal group selected from the group consisting of:

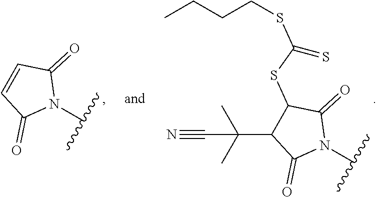 [SMILES: *N1C(=O)C=CC1=O ; *N1C(=O)C(SC(=S)SCCCC)C(C(C)(C)C#N)C1=O]

15. The RAFT step-growth polymerization process of claim 1, wherein the RAFT step-growth adduct is a Bifunctional-Chain Transfer Agent (CTA1-G-CTA2), and the process further comprises contacting the CTA1-G-CTA1 with a bifunctional monomer pair M₁-L_{Y}-M₂, wherein L_{Y} is a linker covalently bound to M₁ and to M₂, and each of M₁ and M₂ is a monomer.

16. The RAFT step-growth polymerization process of claim 15, wherein M₁ and M₂ are each independently selected from the group consisting of acrylate monomers, methacrylate monomers, maleimidic monomers, acrylic monomers, acrylamidic monomers, methacrylic monomers, methacrylamidic monomers, styrenic monomers, vinyl ester monomers, vinyl thiophenic monomers, N-vinyl imide monomers, N-vinyl amide monomers, N-vinyl lactam monomers, vinyl-halide monomers, and alkene monomers.

17. The RAFT step-growth polymerization process of claim 16, wherein M₁ and M₂ are each, independently selected from the group consisting of: 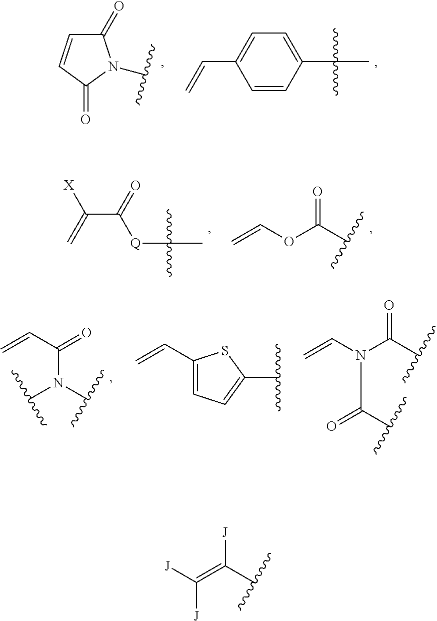
wherein,
X is CH₃ or H, Q is O or N—H;
J is Br, Cl, F or H; and, [symbol]
denotes the attachment to L_{Y}.

18. The RAFT step-growth polymerization process of claim 17, wherein M₁ and M₂ are each a residue of: 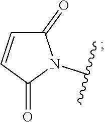 [SMILES: *N1C(=O)C=CC1=O]
or are each a residue of

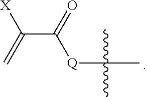

19-20. (canceled)

21. The RAFT step-growth polymerization process of claim 15, wherein L_{Y} is selected from the group consisting of: 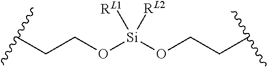
wherein, R^{L1} and R^{L2} are each independently selected from the group consisting of C₁₋₆ alkyl and phenyl; 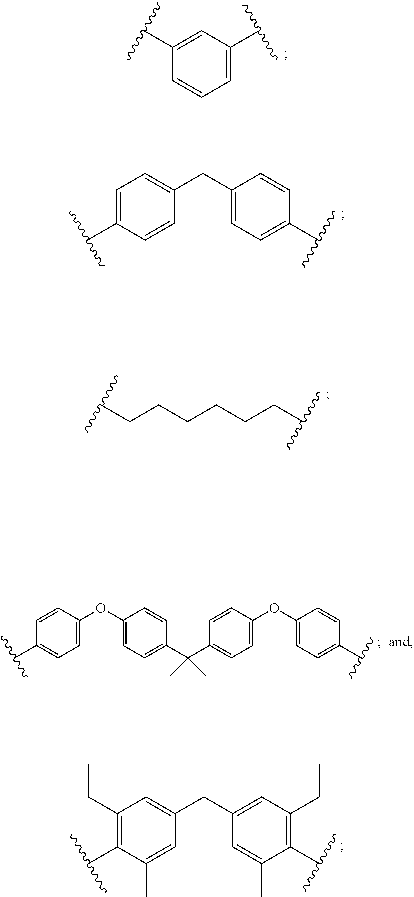 [SMILES: *c1cccc(*)c1 ; *c1ccc(Cc2ccc(*)cc2)cc1 ; *CCCCCC* ; *c1ccc(Oc2ccc(C(C)(C)c3ccc(Oc4ccc(*)cc4)cc3)cc2)cc1 ; *c1c(C)cc(Cc2cc(C)c(*)c(CC)c2)cc1CC]
or, L_{Y} is selected from the group consisting of: 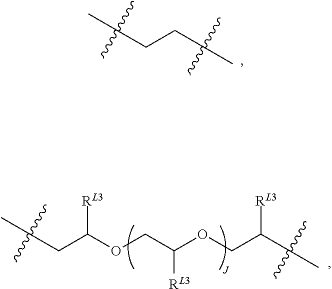
wherein, J is an integer from 1 to 100, or 1 to 90, or 1 to 80, or 1 to 70, or 1 to 60, or 1 to 50, or 1 to 40, or 1 to 30, or 1 to 20 or 1 to 10 and any integer within these ranges; and R^{L3} in each instance is independently selected from the group consisting of hydrogen and C₁₋₆ alkyl, such as methyl; 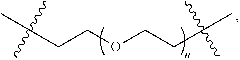
wherein, n is an integer from 1 to 100 or 1 to 90, or 1 to 80, or 1 to 70, or 1 to 60, or 1 to 50, or 1 to 40, or 1 to 30, or 1 to 20 or 1 to 10 and any integer within these ranges; 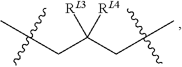
wherein, R^{L3} and R^{L4} in each instance is independently selected from the group consisting of hydrogen, halo and C₁₋₆ alkyl, such as methyl; and 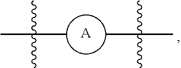
wherein, A is a C₅₋₁₀ cycloalkyl, such as a bridged, bicyclic C₁₀ cycloalkyl:

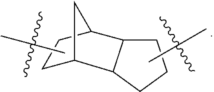

22. The RAFT step-growth polymerization process of claim 15, wherein the bifunctional monomer pair M₁-L_{Y}-M₂ is:

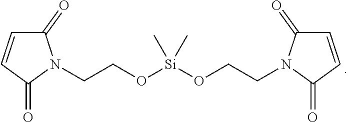 [SMILES: C[Si](C)(OCCN1C(=O)C=CC1=O)OCCN1C(=O)C=CC1=O]

23. The RAFT step-growth polymerization process of claim 15, wherein CTA1-G-CTA2 has the formula: 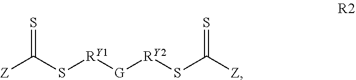
wherein,
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl.

24-25. (canceled)

26. The RAFT step-growth polymerization process of claim 23, wherein G is —(C₁₋₁₂ alkyl)- or —(C₁₋₆ alkyl)-S—S—(C₁₋₆ alkyl)-.

27. (canceled)

28. The RAFT step-growth polymerization process of claim 23, wherein R^{Y1} and R^{Y2} are each independently selected from the group consisting of: 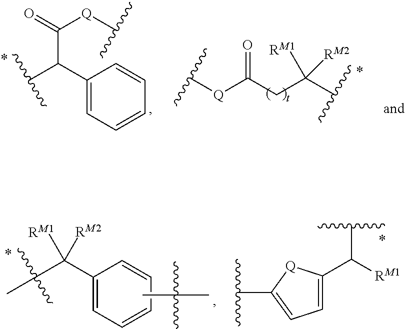
wherein,
* indicates attachment to S;
R^{M1} and R^{M2} are each independently selected from the group consisting of hydrogen, cyano and C₁₋₆ alkyl;
t is 0, 1 or 2; and,
Q is CR^{Q}₂, S, O or NR^{Q},
wherein R^{Q} in each instance is independently hydrogen or C₁₋₆ alkyl.

29. (canceled)

30. The RAFT step-growth polymerization process of claim 15, wherein the polymer comprises one or more repeat units having the formula: 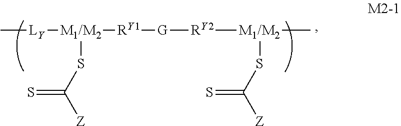
wherein,
M₁ and M₂, in each instance, is independently a residue of a monomer;
L_{Y} is a linker covalently bound to M₁ and/or M₂;
R^{Y1} and R^{Y2} are each independently a residue of a first backbone functional unit;
G is a residue of a second backbone functional unit; and,
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl.

31. The RAFT step-growth polymerization process of claim 30, wherein the polymer has the structure: 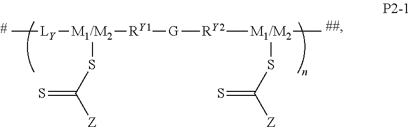
wherein, # and ## each independently denotes attachment to a terminal group selected from the group consisting of: 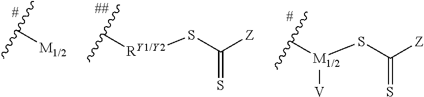
wherein,
M₁ and M₂, in each instance, is independently a residue of a monomer;
V, in each instance, is independently absent or is a residue of an initiator;
L_{Y} is a linker covalently bound to M₁ and/or M₂;
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{Y};
wherein, R^{x} and R^{y} are each independently selected from the group consisting of C₁₋₂₀ alkyl and pyridinyl; and,
n is an integer from 1 to 1,000.

32-35. (canceled)

36. The RAFT step-growth polymerization process of claim 15, wherein the one or more RAFT residues comprises a thiocarbonylthio moiety.

37. The RAFT step-growth polymerization process of claim 36, further comprising,
contacting one or more thiocarbonylthio residues of the polymer with a monomer M_{B} to prepare a brush polymer.

38. The RAFT step-growth polymerization process of claim 37, wherein the brush polymer has the structure: 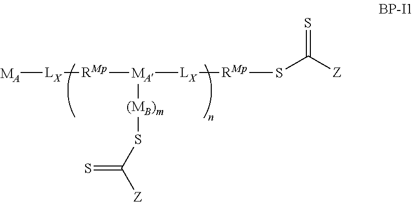
wherein,
M_{A} and M_{A′} in each instance, is independently a residue of a monomer;
L_{X}, in each instance, is independently a covalent bond or a linker covalently bound to M_{A} and to R^{Mp};
R^{Mp}, in each instance, is independently a residue of a first backbone functional unit;
M_{B} is a residue of a monomer;
m is an integer from 1 to 1,000;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl;
and,
n is an integer from 1 to 1,000.

39. The RAFT step-growth polymerization process of claim 37, wherein the brush polymer has the structure: 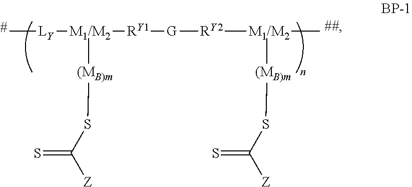
wherein, # and ## each independently denotes attachment to a terminal group selected from the group consisting of: 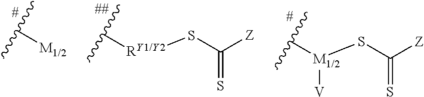
wherein,
M₁ and M₂, in each instance, is independently a residue of a monomer;
V, in each instance, is independently absent or is a residue of an initiator;
M_{B} is residue of a monomer;
m is an integer from 1 to 1,000
L_{Y} is a linker covalently bound to M₁ and/or M₂;
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl; and,
n is an integer from 1 to 1,000.

40-41. (canceled)

42. The RAFT step-growth polymerization process of claim 37, wherein the brush polymer comprises one or more monomers having the formula: 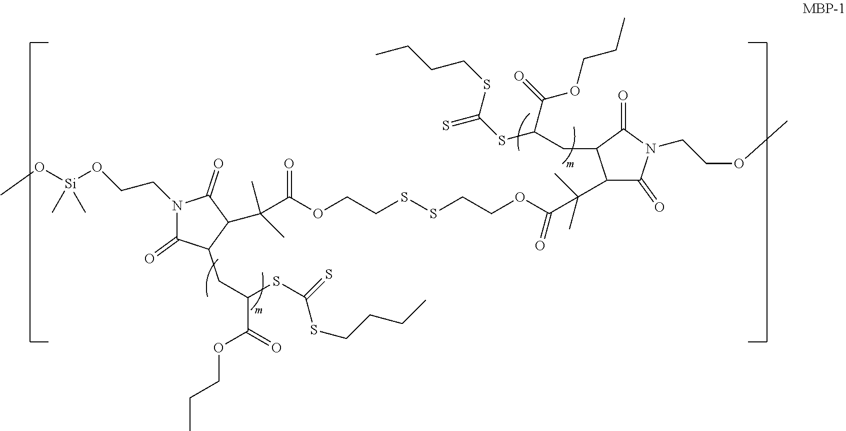
wherein, m is an integer from 1 to 1,000.

43. (canceled)

44. The RAFT step-growth polymerization process of claim 42, wherein the brush polymer has the structure: 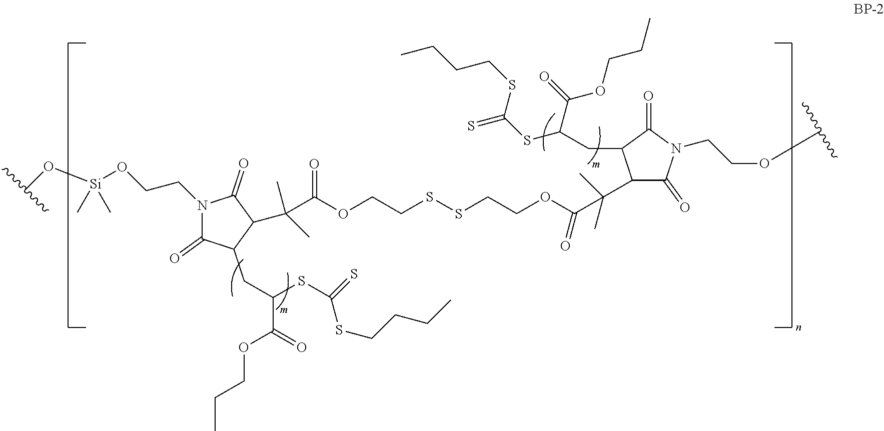
wherein,
n is an integer from 1 to 1,000; and [symbol]
in each instance independently denotes attachment to a terminal group selected from the group consisting of:

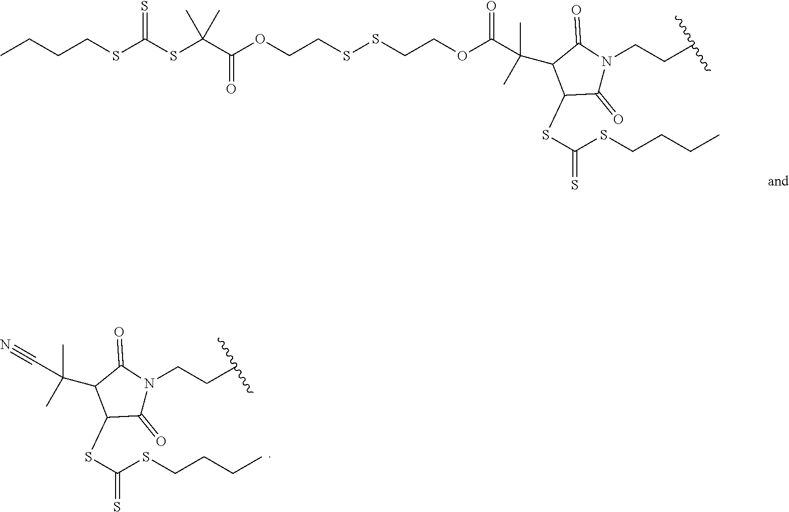 [SMILES: *CCN1C(=O)C(SC(=S)SCCCC)C(C(C)(C)C(=O)OCCSSCCOC(=O)C(C)(C)SC(=S)SCCCC)C1=O ; *CCN1C(=O)C(SC(=S)SCCCC)C(C(C)(C)C#N)C1=O]

45-48. (canceled)

49. A polymer comprising a functional backbone, wherein the polymer has the formula: 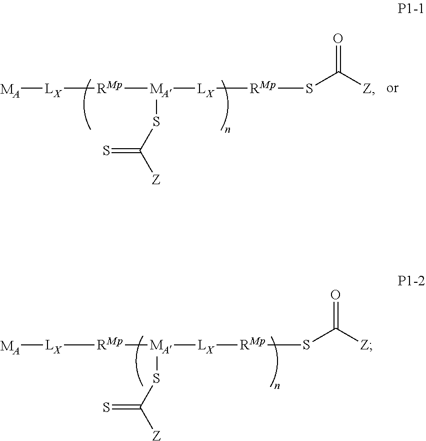
wherein,
M_{A} and M_{A′} in each instance, is independently a residue of a monomer;
L_{X}, in each instance, is independently a covalent bond or a linker covalently bound to M_{A} and to R^{Mp};
R^{Mp}, in each instance, is independently a residue of a first backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl;
and,
n is an integer from 1 to 1,000.

50. (canceled)

51. A polymer comprising a functional backbone, wherein the polymer has the formula: 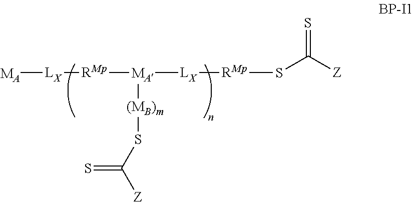
wherein,
M_{A} and M_{A′} in each instance, is independently a residue of a monomer;
L_{X}, in each instance, is independently a covalent bond or a linker covalently bound to M_{A} and to R^{Mp};
R^{Mp}, in each instance, is independently a residue of a first backbone functional unit;
M_{B} is a residue of a monomer;
m is an integer from 1 to 1,000;
Z is selected from the group consisting of —S—C₁₋₂₀ alkyl, —O—C₁₋₂₀ alkyl, phenyl, —O-phenyl, pyrrolyl and NR^{x}R^{y}; wherein, R^{x} and R^{y} are each independently selected from the group consisting of C₁₋₂₀ alkyl and pyridinyl;
and,
n is an integer from 1 to 1,000.

52. (canceled)

53. A polymer comprising a functional backbone, wherein the polymer has the structure: 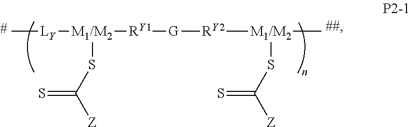
wherein, # and ## each independently denotes attachment to a terminal group selected from the group consisting of: 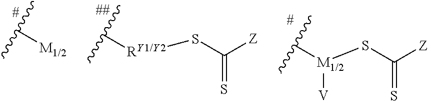
wherein,
M₁ and M₂, in each instance, is independently a residue of a monomer;
V is a residue of an initiator;
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl; and,
n is an integer from 1 to 1,000.

54. (canceled)

55. A polymer comprising a functional backbone, wherein the polymer has the structure: 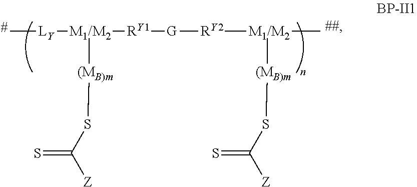
wherein, # and ## each independently denotes attachment to a terminal group selected from the group consisting of: 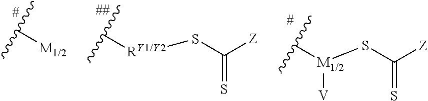
wherein,
M₁ and M₂, in each instance, is independently a residue of a monomer;
V is a residue of an initiator;
M_{B} is residue of a monomer;
m is an integer from 1 to 1,000;
L_{Y} is a linker covalently bound to M₁ and/or M₂;
R^{Y1} and R^{Y2} are each independently a residue of a first backbone functional unit;
G is a residue of a second backbone functional unit;
Z is selected from the group consisting of —S—C₁₋₂₀ alkyl, —O—C₁₋₂₀ alkyl, phenyl, —O-phenyl, pyrrolyl and NR^{x}R^{y};
wherein, R^{x} and R^{y} are each independently selected from the group consisting of C₁₋₂₀ alkyl and pyridinyl; and,
n is an integer from 1 to 1,000.

56. (canceled)
